(19) United States
(12) Patent Application Publication
(10) Pub. No.: US 2017/0300655 A1
(43) Pub. Date: Oct. 19, 2017

(54) APPARATUS AND METHODOLOGIES FOR PERSONAL HEALTH ANALYSIS

(71) Applicant: Vivametrica Ltd., Calgary (CA)

(72) Inventors: Christina Lane, Calgary (CA); Aliakbar Mohsenipour, Newmarket (CA); Lee Vernich, Toronto (CA); Matt Smuck, Portola Valley, CA (US); Richard Hu, Calgary (CA)

(21) Appl. No.: 15/491,553

(22) Filed: Apr. 19, 2017

Related U.S. Application Data
(60) Provisional application No. 62/324,746, filed on Apr. 19, 2016.

(51) Int. Cl. G06F 19/00

(52) U.S. Cl. CPC G06F 19/3431; G06F 19/324

(57) ABSTRACT

Apparatus and methodologies are provided for receiving and analyzing physical, behavioral, emotional, social, demographic and/or environmental information about an individual or a group to generate subscores indicative of the information, and utilizing the subscores to estimate or predict the overall wellness of the individual or group. More specifically, the present application relates to the use of physical, behavioral and environmental information about an individual or a group, at least some of the information being obtained and adapted from wearable devices, to measure, monitor and manage the individual's or group's health.

### CROSS-REFERENCE TO RELATED APPLICATIONS

This Application claims the benefit of claim of U.S. provisional application 62/324,746, filed Apr. 19, 2016, the entirety of which is incorporated herein by reference.

### TECHNICAL FIELD

Apparatus and methodologies are provided for receiving and analyzing physical, behavioral, emotional, social, demographic and/or environmental information about an individual or a group to generate subscores indicative of the information, and utilizing the subscores to estimate or predict the overall wellness of the individual or group. More specifically, the present application relates to the use of physical, behavioral and environmental information about an individual or a group, at least some of the information being obtained and adapted from wearable devices, to measure, monitor and manage the individual's or group's health.

### BACKGROUND

Methods and systems for monitoring the health of individuals are known and can be used by individuals and health care providers to manage disease, improve healthcare quality, reduce health-care costs, and to optimize the delivery of healthcare services. For instance, by individualizing information about clients, health care providers can offer customized care, proactively improve health, and perhaps even enable individuals to take control of their own healthcare. Employers may also have effective tools for managing and preventing the onset of computer and sedentary work-related fatigue, stress and illness, reducing absenteeism, short and long-term disability costs. Further, the recent access to, and popularity of, wearable health-tracking devices, having improved sensors for obtaining health-related biometric information, provide the opportunity to significantly increase the efficacy and ease of individualized healthcare systems and the interaction between an individual and the healthcare provider.

Current methods of monitoring health are limited to obtaining or measuring an individual's health information, such as heart rate, average steps taken per day, family history of disease, etc. However, such methods merely provide raw information which must be further processed or manipulated in order to arrive at meaningful conclusions regarding the individual's health and disease risk.

Moreover, although mobile devices (e.g. wearable devices) have enabled individuals to measure and obtain information regarding their personal health easily and on demand, the devices themselves are limited to presenting relatively simple information such as steps taken, minutes of physical activity in a given time frame, heart rate, etc. without more sophisticated information such as the client's disease risk or healthiness.

As such, current methods of obtaining and analyzing data regarding only the individual's personal health information and biometrics provides a limited view into the actual health and disease risk of the individual.

There is a need for improved methodologies of obtaining, measuring, and monitoring an individual's biometric and health information, and for accurately processing such information into valuable indicators of the individual's wellness, disease risk predictors, and other actionable information. Additionally, there is a need for improved methodologies of providing such wellness and disease risk indicators in comparison to health data from the general population to provide a contextualized assessment of an individual's health. It is desirable that such a system be operable without requiring the identification of pre-determined conditions or pre-identified risk factors. Further, there is a need for improved methodologies of providing such wellness indicators, disease predictors, and actionable information to clients on demand on a variety of devices.

### SUMMARY

Apparatus and methodologies for estimating or predicting the overall wellness of an individual or group of individuals is provided, providing customizable and personalized risk assessments of various health-related conditions, including the costs and/or financial impacts of the various health-related conditions. The present system may be adapted to receive incoming wellness information from a variety of sources, such information including, without limitation, physical, behavioural, social, demographic, and environmental information. The system may be automated and may be operative to analyze the incoming wellness information, and to benchmark the information against data representative of a corresponding distribution of the general population, to generate output information representing the individual or group of individual's wellness information.

In some embodiments, computer-implemented methods for determining wellness in an individual or group of individuals is provided, the method comprising providing a processor, in electronic communication with at least one or more device adapted to receive and transmit specific incoming wellness information about the individual or group of individuals, providing a general population information database, in electronic communication with the processor, for receiving and transmitting general population information to the processor, and receiving, at the processor, the specific incoming wellness information and the general population information, and processing same to generate at least one digital biomarker subscore (e.g. “Health Subscore(s)”) indicative of the individual's wellness according to the specific wellness information, as compared against the general population information, and generating at least one output (e.g. graphical representation) of the at least one digital subscore and transmitting the output to the at least one or more devices. Preferably, some or all of the information may be sourced and adapted from at least one wearable device.

In some embodiments, the incoming wellness information may comprise various types of information including, but not limited to, physical, behavioral, emotional, social, demographic and/or environmental information about the individual or group of individuals. The specific incoming wellness information may comprise information selected from age, gender, height and weight, waist circumference, physical activity, minutes of moderate/vigorous activity, sleep patterns, smoking habits, drug and alcohol consumption, nutrition, family history, pain, stress and happiness levels, resting heart rate, exercise heart rate, heart rate variability, presence of pre-existing disease, job type, geo-location, EEG, voice data, breathing data, blood biometrics, body composition (DXA), and aerobic fitness (VO2max).

Preferably, in some embodiments, the digital biomarkers generated herein may be indicative of, at least, health behaviors, chronic disease risk, mental health, or mortality. The health behaviors may comprise information about, at least, steps taken per day, moderate to vigorous activity levels, sleep patterns, body mass index, waist circumference, smoking habits, drinking habits, nutritional habits, and aerobic fitness. Disease risk may comprise information about, at least, cardiovascular disease, diabetes, arthritis, lung disease, and pain. The mental health may comprise information about, at least, stress levels, happiness levels, depression, and model-based happiness. The mortality subscore may comprise information about, at least, mortality rates associated with one or more of the health behaviors, disease risk, and/or mental health subscores such as, at least, age, risk of cardiovascular disease, and risk of diabetes. In some embodiments, the digital biomarker subscores may be generated in an interactive manner, wherein the individual or group of individuals may predict or estimate how various changes to the biomarker subscores changes their overall wellness (e.g. “What If” Tool). In some other embodiments, the digital biomarker subscores may be generated in an interactive manner, wherein the individual or group of individuals may observe the digital biomarker subscores of other individuals or groups of individuals for interaction therewith (e.g. “People Like Me” Tool).

In some embodiments, the present computer-implemented methods may further comprise processing at least one or more of the digital biomarker subscores against further general population information to generate an overall wellness score (e.g. “VivaMe Score”) for the individual or group of individuals. Preferably, the present systems are operative to simultaneously and continuously generate both digital biomarker subscores and overall wellness scores, and to update each according to feedback and machine learning systems, such updating further incorporating information from the general population database and updating said database.

In some embodiments, a computer-implemented system for determining the wellness of an individual is provided, the system comprising at least one device adapted to receive and transmit incoming wellness information about the individual, at least one general population database, operative to receive and transmit incoming wellness information from the at least one device an at least one processor, and at least one processor, in electronic communication with the at least one device and the general population database, the processor operative to receive the incoming wellness information from the at least one device and the general population information from the database, and to process the information to generate at least one digital biomarker subscore indicative of the individual's wellness according to the specific incoming wellness information as compared against the general population information, and to generate at least one output indicative of the at least one digital biomarker subscore and transmitting the output to the at least one device.

In some embodiments, the incoming wellness information and the general population information are transmitted via wired or wireless signaling. The incoming wellness information may be received and transmitted by the at least one device automatically, manually, or a combination thereof. The incoming wellness information may be received and transmitted by the at least one device intermittently, continuously, or a combination thereof. In some embodiments, the at least one device may comprise, at least, any device having a user interface, cloud computing, or application program interfaces. Preferably, the at least one device may comprise one or more wearable devices.

### BRIEF DESCRIPTION OF THE DRAWINGS

FIG. 1 illustrates a diagram of the present system according to embodiments herein;

FIG. 2 is an illustrative flowchart further demonstrating the present system according to embodiments herein;

FIG. 3 provides an example of overall wellness information (e.g. a VivaMe Score) generated by the present computer-implemented systems, as such information may be displayed to a user;

FIG. 4A illustrates exemplary options available to a user where a Health Subscore or VivaMe score is found to be within a healthy, or optimal range, according to embodiments herein;

FIG. 4B illustrates exemplary options available to a user where, according to some embodiments, it is desirable to set a target overall wellness score, and possible behavioral modifications that could be made in an attempt of achieving the target;

FIG. 5 shows an example plot of values estimating where a user's average daily steps ranks among the average daily steps of a corresponding general population;

FIG. 6 shows an example plot of values estimating where a user's Step Subscore (Sstp) ranks according to the general population, the Step Subscore relating to the value of the steps contributor indicator, which determines whether the Steps Subscore may or may not be used to determine the user's overall wellness score;

FIGS. 7A, 7B, and 7C each show an example plots of curve functions relating to a user's time spent sleeping and their sleep score where users are less than or 65 years of age (FIG. 7A), a user's time spent sleeping and their sleep score where users are over 65 (FIG. 7B), and the user's BMI (FIG. 7C);

FIG. 8 provides a Table summarizing some factors relative to the Smoking Health Subscore, according to embodiments herein;

FIG. 9 provides a Table summarizing exemplary distribution data relating to smokers in the general population, according to embodiments herein;

FIG. 10 provides a Table summarizing some factors relative to the Drinking (Alcohol) Health Subscore, according to embodiments herein;

FIG. 11 provides a Table summarizing exemplary distribution data relating to estimated VO2max of a general population of age groups and genders, according to embodiments herein;

FIG. 12 provides a Table summarizing exemplary distribution data relating to resting heart rate in a general population, according to embodiments herein;

FIG. 13 provides a Table summarizing exemplary distribution data relating to predicted VO2max of a general population, according to embodiments herein;

FIG. 14 provides a Table summarizing some example estimated parameters relating to the VO2Max, according to embodiments herein;

FIG. 15 provides a Table summarizing some example incoming wellness information used to generate Disease Risk Subscores (Cardiovascular Disease), according to embodiments herein;

FIG. 16 shows an example pattern of the curve function to be applied to the average risk of cardiovascular diseases to obtain a cardiovascular disease Health Subscore according to embodiments herein;

FIG. 17 provides a Table summarizing some example incoming wellness information used to generate Disease Risk Subscores (Diabetes), according to embodiments herein;

FIG. 18 shows an example pattern of the curve function to be applied to the average risk of diabetes disease to obtain a diabetes Health Subscore according to embodiments herein;

FIG. 19 provides a Table summarizing some example incoming wellness information used to generate Stress Subscores, according to embodiments herein;

FIG. 20 provides a Table summarizing some example incoming wellness information used to generate Happiness Level Subscores, according to embodiments herein;

FIG. 21 provides a Table summarizing some example happiness levels of the general population given various values of average daily steps, average daily MV, and BMI;

FIG. 22 provides a Table summarizing some example general population information regarding life expectancy, according to embodiments herein;

FIG. 23 provides a Table summarizing some example general population information regarding mortality rates, according to embodiments herein; and

FIG. 24 provides a Table summarizing some example general population information relating to the probabilities of dying for various age ranges.

### DESCRIPTION OF THE EMBODIMENTS

Apparatus and methodologies for estimating or predicting the overall wellness of an individual or a group of individuals is provided, providing customizable and personalized risk assessments of various health-related conditions. Various types of wellness information about the individual or group may be sourced including, without limitation, physical, behavioral, social, demographic, and environmental information, whereby the information is standardized and benchmarked against data representative of relevant distribution of the general population. Some or all of the information may be sourced from at least one device operative to collect and transmit the wellness information such as, for example, mobile devices and/or wearable devices.

As will be described in more detail, the present computer-implemented systems may collect and analyze wellness information about the user(s) to determine the user's wellness according to specific health-related metrics (e.g. “Health Subscores”), as such specific metrics compare to the general population, and then utilizes some or all of the specific metrics to determine the user's overall wellness (e.g. “VivaMe Score”). As such, the present system may simultaneously generate both at least one specific Health Subscore as well as an overall wellness VivaMe score, each being automatically and continuously compared to similar information about a corresponding distribution of the general population. Once generated, each Health Subscore(s) and VivaMe Score may be processed into at least one form of output information displayed to the user at their at least one device(s), the output information being, for example, a graphical representation indicative of the Health Subscore(s) and VivaMe Scores, respectively.

As will also be described in more detail, in some embodiments, the present computer-implemented systems may further provide an interactive goal-setting “What If” tool, operative to generate predictive information about how an individual may impact their own wellness. In some other embodiments, the present systems may further be operative to enable users to view the overall wellness information of other users, and to communicate and interact with such users, pursuant to a “People Like Me” tool. The present apparatus and methodologies will now be described in more detail having regard to the FIGS., Tables, and Examples provided.

Herein, the terms “individual”, “group”, “user” or “client” may be used interchangeably to describe at least one end-user of the present systems, and may be used to refer to those whose overall wellness is being assessed. The present apparatus and methodologies may be utilized by an individual or by a group of individuals. The users need not suffer from any pre-determined or pre-existing condition, nor be categorized into any pre-identified risk factor group. Indeed, such individuals may be healthy individuals desiring to maintain or increase their overall wellness. The users may also be individuals or groups that have been diagnosed with one or more pre-existing health conditions/health-related factors. It should further be understood that the present systems may be utilized on individuals or groups of individuals of any age, including, for example, children, adolescents, adults, and senior citizens.

The term “wellness information” may be used to collectively refer to various forms of information about an individual or group of individuals that can be collected from a variety of sources and analyzed, as described in more detail herein. Without limitation, wellness information may include, at least, physical, behavioral, emotional, social, demographic, environmental information, or any combination thereof, about the individual or the group. It is contemplated that at least some of the wellness information may be obtained, directly or indirectly, from one or more wearable devices.

The term “Health Subscore” may be used to describe, in part, the user's wellness according to specific health-related metrics, as compared to a corresponding cohort of the general population. Health Subscore(s), also referred to herein as digital biomarker score(s), may be generated by the present system utilizing some or all of incoming wellness information collected including, without limitation, individualized information about, at least, the individual's age, gender, height and weight (BMI), waist circumference, physical activity, sleep patterns, smoking habits, drug and alcohol consumption, nutrition, family history, pain, stress and happiness levels, resting heart rate, exercise heart rate, heart rate variability, presence of pre-existing disease, job type, geo-location, electroencephalogram (EEG), voice data, breathing data, blood biometrics, body composition (DXA), aerobic fitness (VO2max) and other variables defined by the individual or health care provider, etc. As will be described, the individualized information may be standardized and compared to a distribution of general population information corresponding to the user. The generated Health Subscores may be divided into three broad categories, namely, health behaviors, disease risk, and mental health, and presented to the users in a manner representative of their wellness in specific health-related categories (e.g. numerical value). As will be described, one or more of the generated Health Scores may be used to further process the user's overall wellness (e.g. “VivaMe Scores”).

The terms “overall wellness”, “overall health”, “VivaMe Score” may be used interchangeably to describe, at least, the user's overall wellness, as compared to a corresponding cohort of the general population. VivaMe Scores may be generated by the present system utilizing some or all of the generated Health Subscores(s) to determine, at least, the user's physical or mental health or wellbeing, overall risk of physical or mental disease, and/or mortality. By way of example, the present VivaMe Scores may provide information (prediction or estimations) about, without limitation, risk of heart disease (e.g. congestive heart failure, heart attack, coronary heart disease, angina), Diabetes (e.g. adult onset, Type 2), arthritis or osteoarthritis (inflamed joints), lung disease (including asthma, chronic bronchitis, emphysema), bodily pain (e.g. lower back pain) and mortality, overall mental wellbeing (e.g. risk of depression, overall happiness), VO2max and aerobic fitness levels. As will be described, the generated Health Subscores may be processed and compared to a distribution of general population information corresponding to the user (e.g. age, gender, etc). For example, as will be described, overall VivaMe or VivaHealth Scores, denoted as S, may be generated from the weighted average of one or more of the at least one Health Subscore(s). Once generated, the one or more VivaMe Scores may be presented to the users in a manner representative of their overall wellness (e.g. graphical representation, numerical value, or other appropriate indication).

Herein the term “general population information” or “general distribution data” may refer to general population information obtained from a database of corresponding information about the general population, such information serving as a standardized baseline for comparative purposes. General population information varies depending upon the individual or group utilizing the present systems, and/or the specific health subscore or overall wellness score being generated for the individual or group.

Herein the term “devices” may generally be used to refer any appropriate devices, processors, or network paradigms operative to collect, transmit and/or receive information such as, in this case, wellness information, and to customizably (and interactively) display the system-generated wellness results back to the user. By way of example, “devices” may be any appropriate technologies known in the art including, without limitation, devices operative to transmit or receive information via wired or wireless signaling, via a plurality of user interfaces (e.g. desktop computers, notebook computers, laptop computers, mobile devices such as cellphones and tablets), via cloud computing, via application program interfaces (“API”), or via wearable devices, or the like. Herein the term “wearable devices” may refer to wearable technology, commonly referred to “wearables”, including electronic technologies or computers that can be incorporated into items of clothing or accessories that can comfortably be worn on the body (e.g. heart rate monitors, smart watches, Fitbits™, Garmins™, API, medical devices, etc.). It should be understood that wearables are operative to perform many of the same computing tasks as mobile phones, laptops or other portable electronic devices (e.g. sensory and scanning features, such as biofeedback and tracking of physiological function). It should also be understood that the present wearable devices further comprise some form of data-input capability, data-storage capability, and data communication capability, operative to transmit information in real time. Wearables may include, without limitation, watches, glasses, contact lenses, e-fabrics, smart fabrics, headbands, head gear (scarves, caps, beanies), jewelry, etc.

As above, the present apparatus and methodologies will now be described in more detail having regard to the Figures, Tables, and Examples provided.

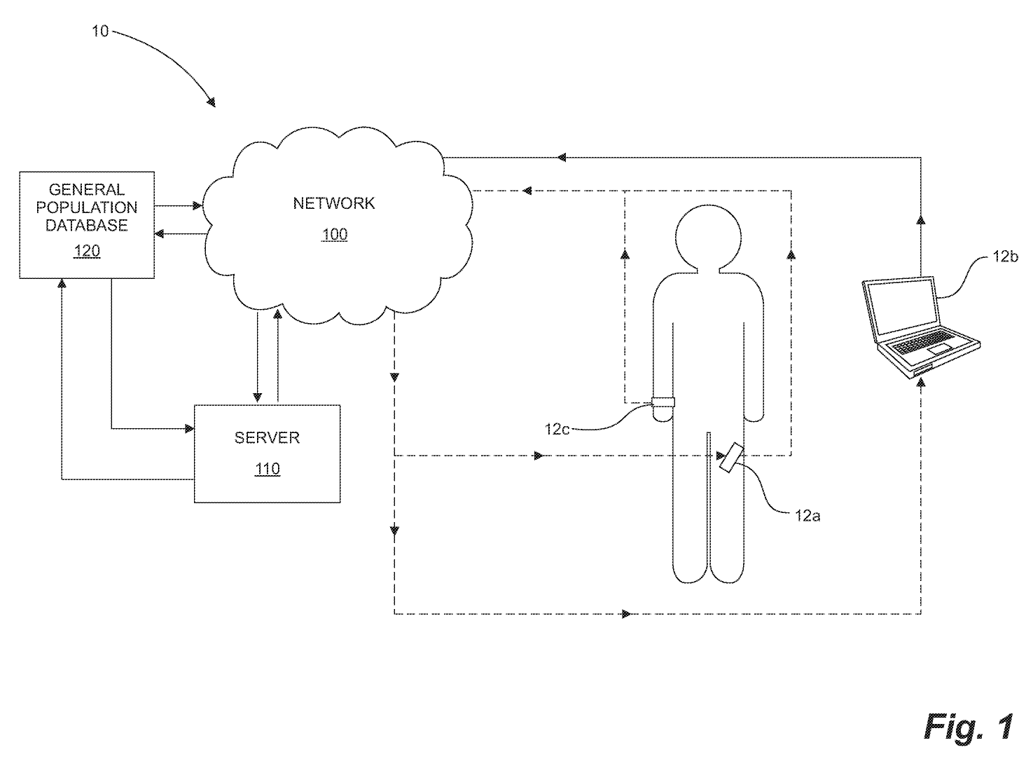

Generally, having regard to FIG. 1, the present computer-implemented system 10 can be used to collect wellness information about an individual or group to determine, predict or estimate wellness. According to embodiments herein, the wellness information may include, at least, one form of physical, behavioral, emotional, social, demographic, and/or environmental information about the individual or group. Incoming wellness information may be collected and received by the system automatically, manually (i.e. such as input by the individual or a health care provider), or a combination thereof. Incoming wellness information may be collected and received intermittently, continuously, or a combination thereof. Incoming wellness information may be received passively or actively, and may be collected over short or long durations of time (e.g., over a 7-day period or longer).

As shown, the present system 10 may collect the wellness information from at least one device 12a, 12b, . . . 12n, the devices being programmed to automatically and/manually measure and receive wellness information, and to transmit the incoming information to the present system for processing. Such transmission may be via any appropriate means known it the art including, without limitation, via wired or wireless signaling, or via a plurality of user interfaces including, without limitation, desktop computers, notebook computers, laptop computers, mobile devices such as cellphones and tablets, or wearable devices such as heart rate monitors, smart watches, Fitbits™, Garmins™, medical devices, API, etc. In some embodiments, the one or more devices 12n may comprise wearables having at least one sensor operative to measure and record wellness information about the user(s). Wellness information may be collected using software programs through any appropriate means including, without limitation, apps for Android™ and iOS™, executable files for Windows™ or OSX™, or through an internet webpage, etc.

By way of example, incoming wellness information may include information relating to general health-related conditions or metrics such as, without limitation, age, gender, height and weight (Body Mass Index; i.e., height/cm and weight/kg), waist circumference, physical activity (e.g., daily or average step-count, bouts of activity in various intensity ranges, changes in activity patterns over time, types of activity, frequency of activity, sitting time, standing time, sedentary time etc), minutes of moderate/vigorous activity, sleep patterns (total sleep time, time spent in each sleep stage, number of sleep interruptions), smoking habits, drug and alcohol consumption (e.g., frequency/quantity), general nutrition, family history, pain, stress and happiness levels, resting heart rate, exercise heart rate, heart rate variability, presence of pre-existing disease, job type, geo-location, EEG, voice data, breathing data, blood biometrics, body composition (DXA), aerobic fitness (VO2max) and other variables defined by the individual or health care provider, etc.

Incoming wellness information may be transmitted from the devices 12n via a network 100, such as the Internet, to at least one server (or processor) 110 for processing. Servers 110, in electronic communication with devices 12n are operative to collect, analyze and store the incoming wellness information. Servers 110, in further electronic communication with at least one general information database 120, may further be operative to collect, analyze and store general population information from the general information database 120. As above, Servers 110 may be programmed to receive wellness information and general population information, and to process the information using a suite of algorithms to simultaneously generate at least one Health Subscore and VivaMe score(s). Once generated, each of the Health Subscores and VivaMe scores may be transmitted back to the user at their at least one device 12n.

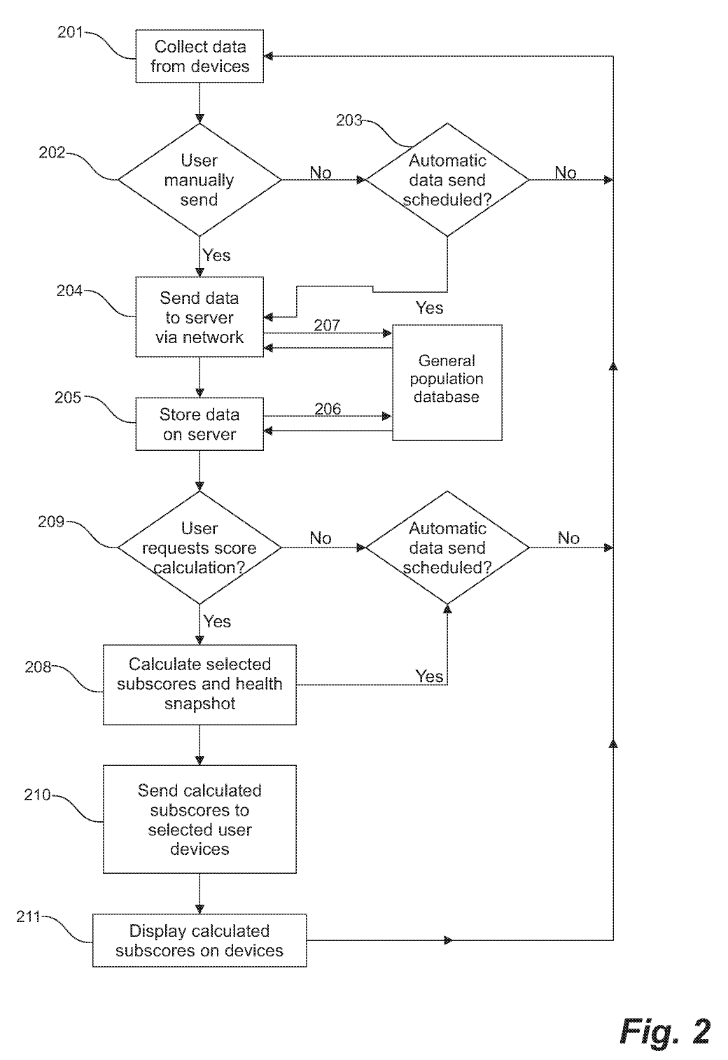

More specifically, having regard to FIG. 2, an exemplary flowchart of the present system is provided. As described, wellness information may be collected from least one or more devices adapted to measure and transmit wellness information about an individual or a group of individuals. Wellness information may be transmitted from the at least one device(s) (Step 201), and/or by the user(s) (Step 202). Some or all of the wellness information may be received from the devices and/or individuals manually, and/or some or all of the wellness information may be received automatically as, for example, according to a schedule (e.g. continuously, or intermittently over a predetermined segments of time; Step 203).

Incoming wellness information may be transmitted to the present one or more servers via a network (Step 204), the servers being operative to receive and store the information (Step 205) for processing. The one or more servers also being operative collect, analyze, and store health data about the general population from a general population database (Step 206). The database may, in turn, be operative to collect, analyze, and store health data regarding the general population from the network, such as the Internet (Step 207). As above, the present server may be programmed to update the wellness information using the general population information, and vice versa, so as to maintain continuously updated wellness information and database of general population information used to generate the present wellness scores. Once the wellness information and the general population information is received, the servers may process the information (as described in more detail below) using a suite of algorithms to simultaneously generate at least one Health Subscore and VivaMe score(s) (Step 208). Each of the Health Subscores and VivaMe Scores may be calculated continuously, periodically, or upon receipt of a request, from time to time, by the user(s) (Step 209). Once calculated, the generated Health Subscores and VivaMe scores can then be transmitted via the network back to the user(s) (Step 210) such as, for example, to the users' at least one device 12n. Each generated Health Subscore and VivaMe score may be converted into at least one form of output information such as, a graphical representation indicative of the Health Subscore and VivaMe Score, respectively, for display on the one or more device(s) (Step 211). The network used to transmit the Health Subscore and VivaMe Score to the user can be the same network used to send the wellness information and general health information to the present systems, or a different network. Wellness information collected and analyzed by the present system may be deleted or stored on the server and/or one or more device(s).

In some embodiments, the present systems receive, at the server or processor, wellness information about the individual user or group user, and general population information, and process the information to general at least one digital biomarker subscore indicative of the user's specific wellness information (e.g. “Health Subscore”). The at least one Health Subscore being generated may depend the information being requested, and upon the demographic, biometric and behavioral information being used. The at least one digital biomarker subscores may be generated in a manner that can be interpreted by the user as being high, low, or within a healthy range, as compared to corresponding wellness information about a predetermined cohort of the general population. In some embodiments, digital biomarker subscores may be generated in a manner that suggests the individual or group of individuals could take certain actions to modify their behavior (e.g. increasing daily steps or reducing their alcohol/cigarette consumption), improving their subscores.

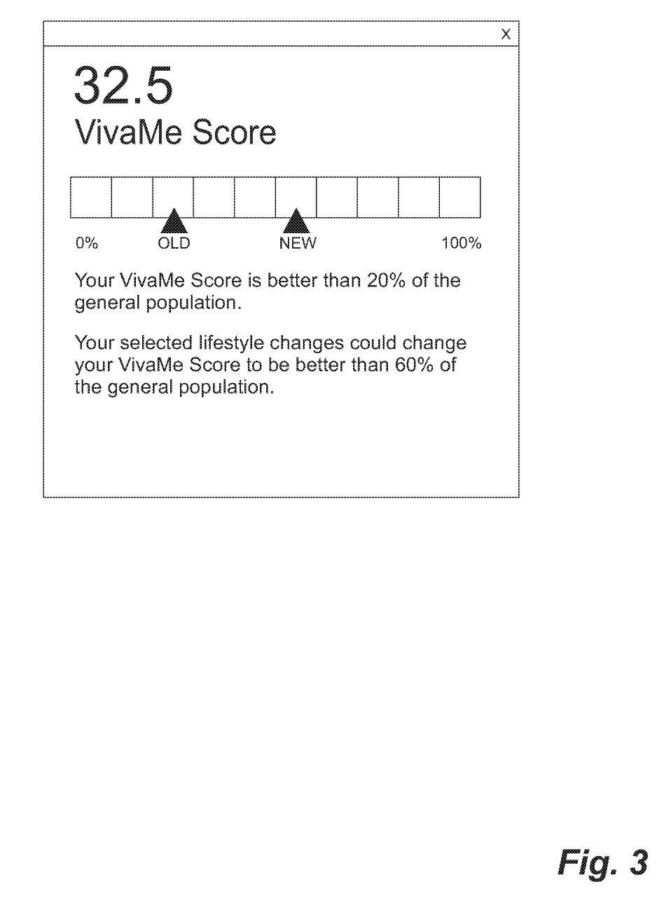

Having regard to FIG. 3, the present computer-implemented systems may, at the server or processor, further process one or more of the at least one Health Subscores to generate an overall wellness score, or “VivaMe Score”, as compared to further corresponding wellness information about the predetermined cohort of the general population. The VivaMe Score being generated may depend the information being requested, and upon the at least one Health Subscore being used. As above, the VivaMe Score may be automatically generated and/or manually requested, from time to time, by the user. The VivaMe Score may be generated in a manner that can be interpreted by the user as being high, low, or within a healthy range, as compared to corresponding wellness information about a predetermined cohort of the general population. It should be understood that the general population information collected and analyzed to determine the one or more digital biomarker scores may or may not be the same general population information collected and analyzed to determine the overall wellness VivaMe Score.

It is an advantage of the present system that, according to embodiments herein, general population information has been collected and processed, and is accessible for analysis purposes. General information data may be automatically and continuously updated. In some embodiments, general population data can be obtained from a variety of resources including, without limitation, from publicly or privately available databases, international, national, or regional reports on health statistics, etc. (e.g. National Youth Fitness Survey Treadmill Examination Manual). In some embodiments, general population data regarding the population of the client's current country of residence is used. Alternatively, population data of other countries or a combination of countries can be used.

Such general population data may be stored on a server, data cloud, or other centralized location, in a manner that enables multiple end-users of the present system to access the general population information. The present system thus avoids need to store general information data locally on the end-user's device. The present system further conveniently provides a feedback component where the general population information database 120 may be continuously and dynamically updated with wellness information collected from the end-users and their devices. Various methods of data storage and access can be used to create, update, and maintain the database of general population health information, such as SQL, JPQL, Microsoft Excel™, and the like. According to embodiments herein, the general population data (i.e. population distribution information) accessed by the present processor may be organized, manipulated, and updated in any appropriate manner known in the art without departing from the scope of the present invention. The general population database may be automatically (continuously or intermittently) updated as new population data becomes available. Preferably, individual or group Health Subscores and/or VivaMe Scores can be fed back to the database, thereby periodically or continuously updating the general population with individual's or group of individual's data.

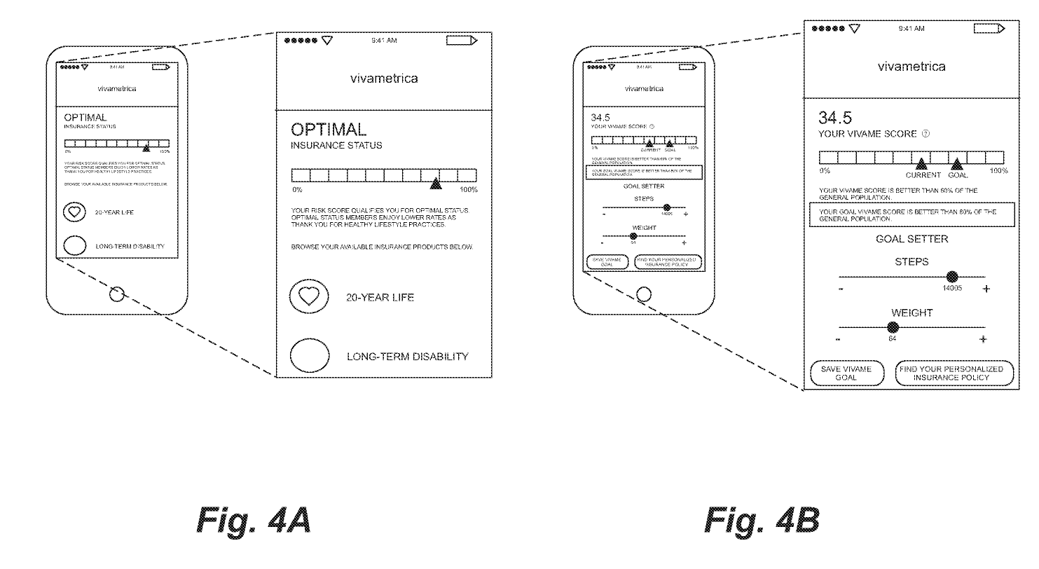

Having regard to FIGS. 4A and 4B, it is an advantage that the present system may simultaneously generate both a specific Health Subscore and an overall wellness VivaMe Score, each being generated by standardizing the information and comparing the information to similar information about a corresponding distribution of the general population. It is a further advantage that, once generated, each of the Health Subscore(s) and VivaMe Scores may be processed into at least one form of output information displayed to the user, the output information being, for example, a graphical representation indicative of the Health Subscore and VivaMe Score, respectively. In some embodiments, the resulting output information may be attributed to an individual or group of individual's user's login ID, where applicable and available. Preferably, the present system enables users to create a user-specific profile linked to information that can be stored on the one or more devices (e.g. the user's personal devices and/or a server). The information contained in the client profile can comprise, for example, a unique login ID for the client, a password, the client's age, gender, occupation, weight, height, family disease history, diagnosis of various diseases, average daily steps, average daily activity (moderate to vigorous, “MV”), and previously calculated subscores and overall wellness scores, if available. As such, the client's average daily steps, average daily MV activity, and other biometric data linked to the profile can periodically be updated automatically continuously or periodically by the wearable or mobile device, and/or manually updated by the client. A copy of the calculated scores, along with a date stamp, can be stored on the server and/or the one or more devices, and linked to the client's login ID, such that the client can view the subscore, and the date it was calculated, at a later time.

Accordingly, the user, their employer, insurance company, or health-care provider may obtain simple, personalized information about the user's wellness, and where the user ranks according the general population. The information may be used to motivate the user to improve their overall wellness, or to enable the user or health care provider to customize the health or wellness plan for the user (FIG. 4A). Indeed, in some embodiments, the present system is operative to provide an interactive goal-setting “What If” Tool (see FIG. 4B), operative to estimate or predict how changes in behavior, personal characteristics, or specific subscores could impact their overall health, personal risk of disease, mortality, etc. Where it is desirable to change one or more individual Health Subscores (e.g. increasing daily steps or daily activity), a corresponding positive change in the overall VivaMe Scores may also be achieved. Accordingly, users or their health-care providers may experiment, set personal goals, or pose questions about how varying combinations of health behavior changes or changes in personal health subscores could impact their overall wellness score. For example, a user could determine whether increasing their steps per day by 500 has more impact on the risk for diabetes than losing 5 lbs, or whether a combination of the two changes has the greatest overall positive impact. In other embodiments, the present system is operative to provide interactive communication to other users via, for example, a “People Like Me” Tool, enabling users similar in age, gender, job type, health condition, etc. to share their results and goals. The present system, therefore, may be utilized by an individual or a group of individuals to obtain optimized, accurate results about their overall health and wellbeing. In some embodiments, user(s) can also change incoming wellness information to determine how their overall scores may be affected. In such a manner, the present system may provide customizable, on-demand, actionable health information to user(s).

The present systems may further be utilized to estimate or predict the costs of various diseases and savings that could be associated with various behavioral changes or changes in personal characteristics, such as increased physical activity or decreases in weight, providing the advantage that the costs or financial implications of an individual's or group's overall wellness can be estimated or predicted, and improved. For example, the present system may be used by third parties other than the individual user, such as an employer evaluating a group of employees, a health-care provider, or an insurance provider or actuary evaluating optimal insurance coverage, enabling the identification and prevention of risk factors or health-related concerns (e.g. underwriting insurance programs) of an individual or within an entire group. For example, the present systems may be utilized to determine health risks, mortality, etc. and to more effectively assign or alter insurance programs or premiums, or to reward individuals based upon the generated Health Subscores and/or VivaMe Scores. The present system may further be used to evaluate the outcomes of health and/or wellness programs, enabling the creation and optimization of health-related programs and products, insurance programs and products, and wellness support programs and products. The present system may be operative to identify and address issues such as sedentary workers, absenteeism, and risk of short- and long-term disability (e.g., including mental health claims and inability to cope with increased productivity demands). It is contemplated that the present system may be used alone or in combination with other known social engagement services. Without limitation, the present apparatus and methodologies provide repeatable and valid output information to the user, using personalized feedback to enable practical goal setting, and interactive wellness planning based upon health and/or financially-driven goals.

As such, without limitation, the present computer-implemented system may be programmed to utilize various modeling techniques (e.g., Prediction, Estimation, etc.). In one embodiment, a Prediction Model may be used where the user provides self-reported demographic information, without taking into account personalized heart rate data. Such a method may be practical for large populations, or cases where heart rate is not monitored. In other embodiments, an Estimation Model (resting heart rate) may be used where both demographic and heart rate information are provided. Resting heart rate may be self-reported or measured by the at least one device. Such a VO2max estimate could be passively calculated using heart rate data collected from at least one device. In yet another embodiment, an Estimation Model (heart rate and perceived exertion) may be used to take into account heart rate and an accompanying rating of perceived exertion from the user. In this case, the user could indicate the rate of perceived exertion when prompted during exercise, or following a workout. Such a model may only require one pair of heart rate and exertion to be accurate, but could increase in accuracy with the addition or incorporation of more data. In yet another embodiment, an Estimation Model (treadmill test) may be used to take into account heart rate recorded during a simply two-stage treadmill test, the test being customized for each user. In this case, the user may be prompted with instructions for the test, and heart rate during the test is used to calculate VO2max.

As stated above, Health Subscores and an overall VivaMe health scores for individuals or groups are generated using a suite of algorithms. The inputs, functions, and outputs of the algorithms vary depending on the wellness category for which the subscore or overall wellness score is being generated. Below are Examples of the algorithms used, although it would be understood that the algorithms described below are for exemplary purposes only, and modifications can be made thereto to refine and/optimize the present systems.

### Health Subscores

By way example, specific wellness information, along with general population information, can be processed to generate at least one digital biomarker subscore indicative of the specific wellness information. Herein, specific wellness information, or Health Subscores, can be divided into three categories: Health Behaviors, Disease Risk, and Mental Health (VivaMind subscores).

Health Behaviors

Health Behavior scores may be calculated utilizing the client's demographic information, biometric data, and data regarding a client's health behaviors, as well as similar data of the general population or segments thereof to which the client's data is compared.

Steps

By way of example, a steps subscore Sstp may be generated to indicate the individual or group's wellness with respect to the average number of steps taken per day, based on how the individual or group ranks compared with the general population information. Input information for generating the steps subscore may comprise age (Clientage), gender (ClientGender), brand of fitness device (Device, if applicable), average number of steps taken per day (StepDaily), the amount of daily steps the client wishes to increase (IncrSteps), and a steps contribution indicator (D594), which is a yes/no value that determines whether the steps subscore contributes to the calculation of the client's overall wellness score.

Age may be determined by the age of the client, or average age of the group. Gender may be selectable between unknown, male, and female. The brand of fitness device is the brand of the device used by the client to track his/her steps and may be selectable as between, for example, Garmin™, Fitbit™, Misfit™, Actigraph™, Actical™, or others. The brand of fitness device can be used to select an adjustment factor (Adjust) to apply to the client's average daily step count in order to account for discrepancies between the measured steps across the various possible devices used by the users. The daily average steps taken per day is the number of steps taken by the client over several days, averaged across the number of days measured. Alternatively, the client can input a subjective number for daily steps to be used by the algorithm. Distribution data of average daily steps taken by the general population is provided to serve as a standardized baseline. The steps distribution data can be grouped into age brackets 20-29, 30-39, 40-49, 50-59, 60-69, and 70+. For each age bracket and each value of gender (unknown, male, or female), 9 levels of deciles can be created (10%, 20%, 30%, 40%, 50%, 60%, 70%, 80%, and 90%). A curve function to be applied to the ranking among the general population to calculate the Steps subscore, in this embodiment a piecewise linear function, can be made by connecting a sequence of 2-D points: (0,0), (16,25), (31,50), (50,62), (69,74), (84,86), (100,100). First, the average daily step count “ClientStepAvgActi” is calculated as follows:

ClientStepAvgActi=StepDaily+IncrSteps+Adjust

where “StepDaily” is the average daily steps measured by the client's fitness device or reported by the client, “IncrSteps” is the number of steps the client wishes to increase his/her daily steps by, and “Adjust” is the adjustment factor to account for the brand of the client's fitness device. While the adjustment factor is added to the steps in this calculation, the method of adjustment can be changed as desired, for example by multiplying StepDaily by a weighting factor instead of addition, or not used at all.

The Steps Rank is then estimated based on the client's average daily steps ClientStepAvgActi and the general population distribution data. The appropriate distribution data set is selected based on the client's age and gender. Where the distribution data is only divided into 9 levels of deciles (for each age/gender bracket), an additional two levels can be created. For 0%, the quartile is simply set to zero, as no one can have a negative step count. The 100% quartile can be created by extending the 90% quartile by the average step difference between the successive deciles in the distribution data.

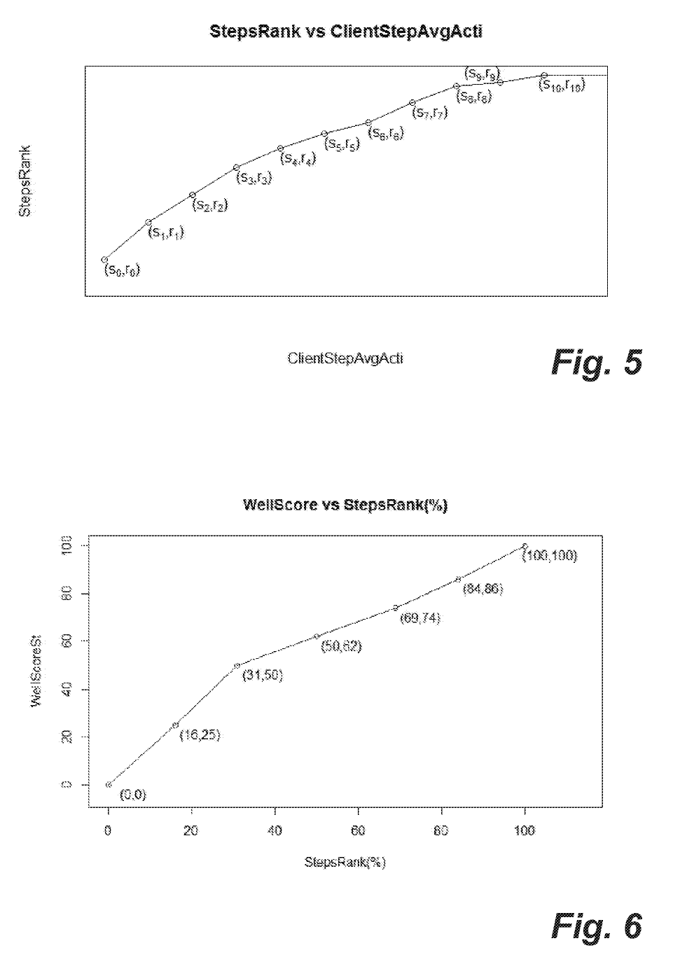

Presuming that the distribution of steps between the deciles is as follows:

| | Cumulative percent (%) | | | | | | | | | | |
|---|---|---|---|---|---|---|---|---|---|---|---|
| | 0 | 10 | 20 | 30 | 40 | 50 | 60 | 70 | 80 | 90 | 100 |
| Steps quartile | s₀ | s₁ | s₂ | s₃ | s₄ | s₅ | s₆ | s₇ | s₈ | s₉ | s₁₀ |

where s₀ . . . s₁₀ are the average daily steps of each quartile, s₀=0, and s₁₀=s₉+Σᵢ₌₁⁸(sᵢ₊₁−sᵢ)/8. The rank of the client among the population StepsRank can then be estimated using the following formula:

$$StepsRank = \{ \begin{matrix}{r}_{0} + 10 \times ( \frac{ClientStepAvgActi - {s}_{0}}{{s}_{1} - {s}_{0}} ) & if {s}_{0} \leq ClientStepAvgActi < {s}_{1} \\ {r}_{1} + 10 \times ( \frac{ClientStepAvgActi - {s}_{1}}{{s}_{2} - {s}_{1}} ) & if {s}_{1} \leq ClientStepAvgActi < {s}_{2} \\ {r}_{2} + 10 \times ( \frac{ClientStepAvgActi - {s}_{2}}{{s}_{3} - {s}_{2}} ) & if {s}_{2} \leq ClientStepAvgActi < {s}_{3} \\ {r}_{3} + 10 \times ( \frac{ClientStepAvgActi - {s}_{3}}{{s}_{4} - {s}_{3}} ) & if {s}_{3} \leq ClientStepAvgActi < {s}_{4} \\ {r}_{4} + 10 \times ( \frac{ClientStepAvgActi - {s}_{4}}{{s}_{5} - {s}_{4}} ) & if {s}_{4} \leq ClientStepAvgActi < {s}_{5} \\ {r}_{5} + 10 \times ( \frac{ClientStepAvgActi - {s}_{5}}{{s}_{6} - {s}_{5}} ) & if {s}_{5} \leq ClientStepAvgActi < {s}_{6} \\ {r}_{6} + 10 \times ( \frac{ClientStepAvgActi - {s}_{6}}{{s}_{7} - {s}_{6}} ) & if {s}_{6} \leq ClientStepAvgActi < {s}_{7} \\ {r}_{7} + 10 \times ( \frac{ClientStepAvgActi - {s}_{7}}{{s}_{8} - {s}_{7}} ) & if {s}_{7} \leq ClientStepAvgActi < {s}_{8} \\ {r}_{8} + 10 \times ( \frac{ClientStepAvgActi - {s}_{8}}{{s}_{9} - {s}_{8}} ) & if {s}_{8} \leq ClientStepAvgActi < {s}_{9} \\ {r}_{9} + 10 \times ( \frac{ClientStepAvgActi - {s}_{9}}{{s}_{10} - {s}_{9}} ) & if {s}_{9} \leq ClientStepAvgActi < {s}_{10} \\ {r}_{10} & if {x}_{c} \geq {s}_{10}\end{matrix} .$$

where r₀, r₁, r₂, . . . , r₁₀ are 0, 10, 20, . . . , 100, respectively. The formula can be plotted on as shown in FIG. 5. For convenience, a notation for the piecewise linear function, f_{c}(. ; .) is used, with RS={(s₀,r₀), (s₁,r₁), (s₂,r₂), . . . , (s₁₀,r₁₀)}. Then StepsRank above can be written as:

$$StepsRank = \{ \begin{matrix}{f}_{c} ( ClientStepAvgActi ; RS ) & if ClientStepAvgActi \leq {s}_{10} ; \\ 100 & if ClientStepAvgActi > {s}_{10} ;\end{matrix}$$

In general, suppose A={(x₀,y₀), (x₁,y₁). (x₂,y₂), . . . , (xₙ,yₙ)}, where x₀<x₁<x₂< . . . <xₙ, then f_{c}(x; A) is defined as:

$${f}_{c} ( x ; A ) = \{ \begin{matrix}{y}_{0} + ( {y}_{1} - {y}_{0} ) \times ( x - {x}_{0} ) / ( {x}_{1} - {x}_{0} ) & if {x}_{0} \leq x < {x}_{1} ; \\ {y}_{1} + ( {y}_{2} - {y}_{1} ) \times ( x - {x}_{1} ) / ( {x}_{2} - {x}_{1} ) & if {x}_{1} \leq x < {x}_{2} ; \\ & ⋮ \\ {y}_{i} + ( {y}_{i + 1} - {y}_{i} ) \times ( x - {x}_{i} ) / ( {x}_{i + 1} - {x}_{i} ) & if {x}_{i} \leq x < {x}_{i + 1} ; \\ & ⋮ \\ {y}_{n - 1} + ( {y}_{n} - {y}_{n - 1} ) \times ( x - {x}_{n - 1} ) / ( {x}_{n} - {x}_{n - 1} ) & if {x}_{n - 1} \leq x < {x}_{n} ; \\ {y}_{n} & if x = {x}_{n} .\end{matrix}$$

Once StepsRank is determined, a curve function can be applied to StepsRank to obtain the Steps subscore Sₛₜₚ. In an embodiment, the curve function can be a piecewise linear function, defined by: where SC={(0,0),

$${S}_{stp} = \{ \begin{matrix}{f}_{e} ( StepsRank ; SC ) if D 594 \leq YES ; \\ NULL if D 594 > NO ,\end{matrix}$$

(16,25), (31,50), (50,62), (69,74), (84,86), (100,100)} and D594 is the value of the steps contribution indicator, which determines whether the Steps subscore contributes to the calculation of the client's overall wellness score. A graphical representation of the Sstp as a function of StepsRank when D594 =YES is shown in FIG. 6.

In some embodiments, the curve function may be defined by Sstp above, however, it would be appreciated that the curve function may be defined in any way desired. For example, Sₛₜₚ can be equal to the StepsRank for simplicity. Additionally, the curve can be changed to make most clients' scores look better by setting the curve function to be a concave function. Preferably, the two conditions of the curve function that should be satisfied are that first, it must be a non-decreasing function (assuming that the higher step count results in better health) and second, it must include the two points (0,0),(100,100).

The present systems are operative to discern the appropriate general population distribution data that should be selected given the client's gender and age bracket in order to obtain the most accurate results regarding the client's steps subscore.

If D594=YES, the formula of S_{stp(AG)} is given by:

$${S}_{stp ( AG )} = \{ \begin{matrix}66 & if ClientGender = NA and Clientage < 30 ; \\ 66 & if ClientGender = NA and 30 \leq Clientage < 40 ; \\ 65 & if ClientGender = NA and 40 \leq Clientage < 50 ; \\ 67 & if ClientGender = NA and 50 \leq Clientage < 60 ; \\ 67 & if ClientGender = NA and 60 \leq Clientage < 70 ; \\ 66 & if ClientGender = NA and Clientage \geq 70 ; \\ 68 & if ClientGender = M and Clientage < 30 ; \\ 67 & if ClientGender = M and 30 \leq Clientage < 40 ; \\ 65 & if ClientGender = M and 40 \leq Clientage < 50 ; \\ 66 & if ClientGender = M and 50 \leq Clientage < 60 ; \\ 67 & if ClientGender = M and 60 \leq Clientage < 70 ; \\ 66 & if ClientGender = M and Clientage \geq 70 ; \\ 64 & if ClientGender = F and Clientage < 30 ; \\ 65 & if ClientGender = F and 30 \leq Clientage < 40 ; \\ 65 & if ClientGender = F and 40 \leq Clientage < 50 ; \\ 67 & if ClientGender = F and 50 \leq Clientage < 60 ; \\ 68 & if ClientGender = F and 60 \leq Clientage < 70 ; \\ 66 & if ClientGender = F and Clientage \geq 70 ,\end{matrix}$$

Otherwise, S_{stp(AG)}=NULL. The above data are provided as an example of average scores of a Canadian population in various age and gender brackets.

The steps subscore Sₛₜₚ can be compared with the average score S_{stp(AG)} of the general population in the client's age and gender category to determine whether the client's subscore is better than, equal to, or worse than others in the same age and gender category. A qualitative scale can be used to indicate whether the client's steps subscore Sₛₜₚ is excellent, very good, good, fair, or poor. In some embodiments, the subscores for each rating may be provided in a range such as, for example: Excellent: 86-100; Very good: 74-85; Good: 62-73; Fair: 50-61; and Poor: 0-50. It should be appreciated that any other score may be utilized.

Moderate to Vigorous Activity (MV)

As another example, a level of moderate to vigorous activity subscore Sₘᵥ may be generated to indicate the individual or group's wellness with respect to the average amount of time spent performing moderate to vigorous activity (i.e. MV) per day, based upon how the individual or group ranks compared to the general population. Input information for generating the MV subscore may comprise age (Clientage), gender (ClientGender), average number of minutes of moderate to vigorous activity performed per day or, if the measured average daily MV is not available, the reported average daily MV from the client (MVDaily), the amount of daily MV the client wishes to increase (IncrMV), and a MV contribution indicator (D595), which is ayes/no value that determines whether the MV subscore contributes to the calculation of the client's overall wellness score.

First, the client's average daily MV “ClientMVAvgActi” is calculated as follows:

ClientMVAvgActi=MVDaily+IncrMV

where MVDaily is the average daily MV measured by the client's fitness device or reported by the client, and IncrMV is the amount of daily MV the client wishes to increase.

In some embodiments, the MV Rank can then be estimated based on the average daily MV and the appropriate distribution data of the average daily MV of the general population can be selected based on age and gender. As with the Steps subscore, general population distribution data of MV can be provided to act as a baseline for the average daily MV of the general population. The MV distribution data can be grouped into the same age/gender brackets as for the steps distribution data, each bracket having 9 levels of deciles. Two additional levels of deciles can once again be added to the existing 9levels of deciles in the distribution data, such that the distribution of MV between deciles is as follows:

| | Cumulative percent (%) | | | | | | | | | | |
|---|---|---|---|---|---|---|---|---|---|---|---|
| | 0 | 10 | 20 | 30 | 40 | 50 | 60 | 70 | 80 | 90 | 100 |
| MV quartile | m₀ | m₁ | m₂ | m₃ | m₄ | m₅ | m₆ | m₇ | m₈ | m₉ | m₁₀ |

where m₀ . . . m₁₀ are the average daily MV of each quartile, and m₀=0, m₁₀=m₉+Σᵢ₌₁⁸(mᵢ₊₁−,ᵢ)/8. The MVRank among the population can then be estimated using the same formula used above for steps. As with the steps subscore above, the client's MV subscore Sₘᵥ can be compared with the average score S_{mv(AG)} of the general population in the client's age and gender category to determine whether the client's subscore is better than, equal to, or worse than others in the same age and gender category. A qualitative scale can be used to indicate whether the client's MV subscore Sₘᵥ is excellent, very good, good, fair, or poor. In some embodiments, the subscores for each rating may be provided in a range such as, for example: Excellent: 86-100; Very good: 74-85; Good: 62-73; Fair: 50-61; and Poor: 0-50. It should be appreciated that any other score may be utilized.

Sleep

As another example, a sleep subscore Sₛₗₚ may be generated to indicate the individual or group's sleep wellness with respect to the average number of hours of sleep per day, based upon a comparison to the sleep patterns of the general population distribution information. As above, input information may be age (Clientage), gender (ClientGender), and average number of hours of sleep per day (SleepDaily), either measured by the client's own device or as reported by the client, the amount of daily sleeping time the client wishes to increase (IncrSleep), and a sleep contribution indicator (D596), which is a yes/no value that determines whether the sleep subscore contributes to the calculation of the client's overall wellness score.

First, the client's average daily sleeping time (in hours) “NewClientSleep” is calculated as follows:

NewClientSleep=SleepDaily+IncrSleep/60

where SleepDaily is the average daily hours of sleep of the client measured by the client's fitness device or reported by the client, and IncrSleep is the amount of daily hours of sleep the client wishes to increase.

If the sleep contribution indicator D596= YES, then the client's Sleep subscore Sₛₗₚ can then be calculated by applying the curve function f_{c} as shown by the following formula:

$${S}_{slp} = \{ \begin{matrix}{f}_{c} ( NewClientSleep ; {SCS}_{1} ) & \begin{matrix}if Clientage \leq 65 and \\ 0 \leq NewClientSleep \leq 14 ;\end{matrix} \\ 0 & \begin{matrix}if Clientage \leq 65 and \\ NewClientSleep > 14 ;\end{matrix} \\ {f}_{c} ( NewClientSleep ; {SCS}_{2} ) & \begin{matrix}if Clientage > 65 and \\ 0 \leq NewClientSleep \leq 14 ;\end{matrix} \\ 0 & \begin{matrix}if Clientage > 65 and \\ NewClientSleep > 14 ,\end{matrix}\end{matrix}$$

where SCS₁-{(0,0), (6,62), (7,86), (7.5,100), (8.5,100), (9,86), (10,62), (14,0)}; and SCS₂={(0,0), (5,62), (7,100), (8,100), (9,62), (14,0)}.

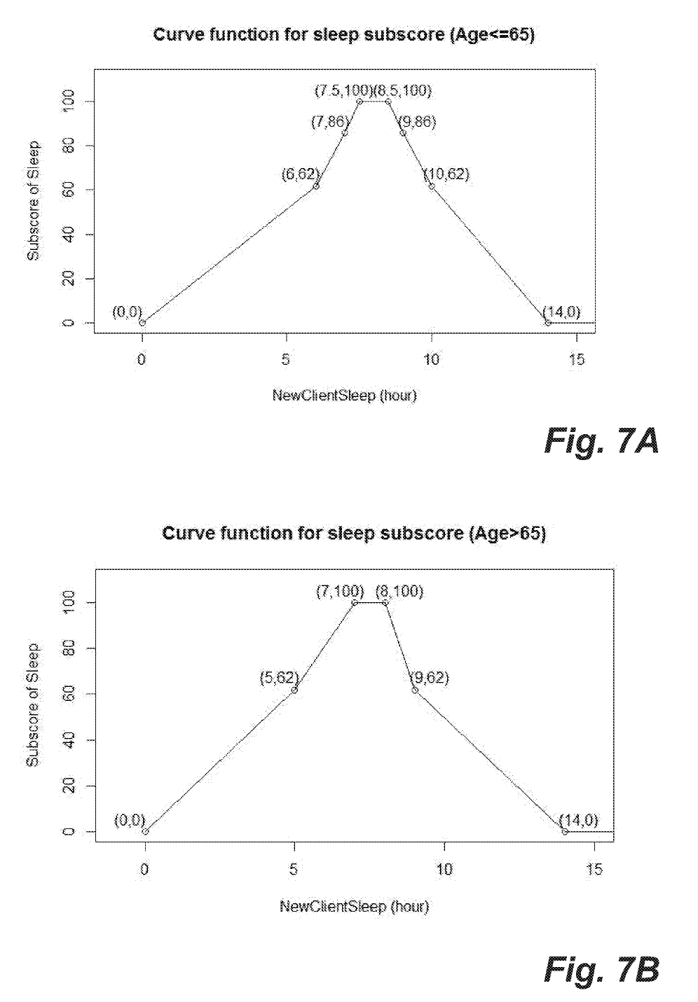

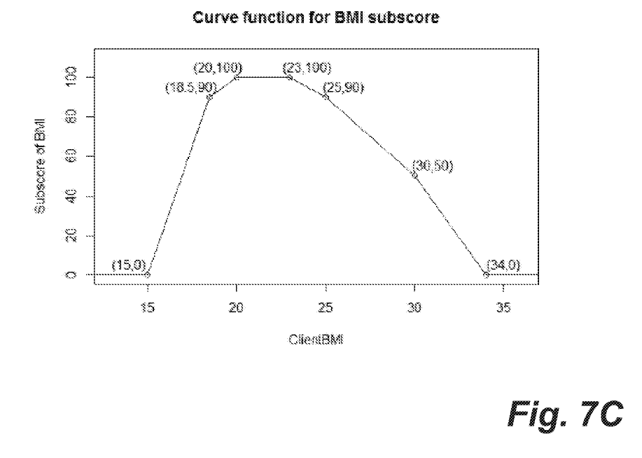

If D596= NO, then a NULL value is returned for Sₛₗₚ. FIGS. 7A and 7B depict a graphical representation between sleeping time and sleeping score is shown for individuals less than or 65 years of age (FIG. 7A) and over 65 (FIG. 7B).

If D596=YES, the formula of S_{slp(AG)} is given by:

$${S}_{slp ( AG )} = \{ \begin{matrix}96 & if ClientGender = NA and Clientage < 30 ; \\ 90 & if ClientGender = NA and 30 \leq Clientage < 40 ; \\ 85 & if ClientGender = NA and 40 \leq Clientage < 50 ; \\ 84 & if ClientGender = NA and 50 \leq Clientage < 60 ; \\ 89 & if ClientGender = NA and 60 \leq Clientage < 70 ; \\ 100 & if ClientGender = NA and Clientage \geq 70 ; \\ 83 & if ClientGender = M and Clientage < 30 ; \\ 86 & if ClientGender = M and 30 \leq Clientage < 40 ; \\ 82 & if ClientGender = M and 40 \leq Clientage < 50 ; \\ 85 & if ClientGender = M and 50 \leq Clientage < 60 ; \\ 100 & if ClientGender = M and 60 \leq Clientage < 70 ; \\ 100 & if ClientGender = M and Clientage \geq 70 ; \\ 99 & if ClientGender = F and Clientage < 30 ; \\ 95 & if ClientGender = F and 30 \leq Clientage < 40 ; \\ 88 & if ClientGender = F and 40 \leq Clientage < 50 ; \\ 84 & if ClientGender = F and 50 \leq Clientage < 60 ; \\ 88 & if ClientGender = F and 60 \leq Clientage < 70 ; \\ 100 & if ClientGender = F and Clientage \geq 70 ,\end{matrix}$$

Otherwise, S_{slp(AG)}=NULL. The above example data are average scores of a Canadian population in various age and gender brackets.

The sleep health subscore Sₛₗₚ can be compared with the average score S_{slp(AG)} of the general population in the same age and gender category to determine whether the client's subscore is better than, equal to, or worse than others in the same age and gender category. A qualitative scale can be used to indicate whether the client's sleep subscore Sₛₗₚ is excellent, very good, good, fair, or poor. In some embodiments, the subscores for each rating may be provided in a range such as, for example: Excellent: 86-100; Very good: 74-85; Good: 62-73; Fair: 50-61; and Poor: 0-50. It should be appreciated that any other score may be utilized.

BMI

As another example, Body Mass Index or “BMI” health subscore S_{bmi} may be generated to indicate the individual or group's wellness with respect to BMI, based on how the individual or group ranks compared with the general population information. The inputs are the client's age (Clientage), gender (ClientGender), height (ClientHeight—in cm or inches), weight (ClientWeight—in kg or lbs), the weight that client intends to change in kg (IncrWeight), a BMI/weight contribution indicator (D597), which is a yes/no value that determines whether BMI/weight is taken into the calculation of the client's overall wellness score, and a weight/BMI selector (B597) which is selectable between “weight” or “BMI” and indicates which one of BMI and weight is chosen. A BMI contribution indicator (IBMI) is “YES” if the BMI/weight indicator is “YES” and the weight/BMI selector is “BMI”. Additionally, ClientScaleHeight is chosen between values of “cm” or “inc”, depending on whether ClientHeight is given in cm or inches, respectively, and ClientScale is chosen between values of “kg” or “lbs” depending on whether ClientWeight is given in kilograms or pounds, respectively.

The target BMI for the client (ClientBMI) can then be calculated as follows:

$$ClientBMI = \{ \begin{matrix}\frac{ClientWeight + IncrWeight}{{( ClientHeight / 100 )}^{2}} & \begin{matrix}if ClientScale = kg \\ and ClientScaleHeight = cm ;\end{matrix} \\ \frac{ClientWeight + IncrWeight}{{( 2.54 \times ClientHeight / 100 )}^{2}} & \begin{matrix}if ClientScale = kg \\ and ClientScaleHeight = Inc ;\end{matrix} \\ \frac{0.453592 \times ClientWeight + IncrWeight}{{( ClientHeight / 100 )}^{2}} & \begin{matrix}if ClientScale = lbs \\ and ClientScaleHeight = cm ;\end{matrix} \\ \frac{0.453592 \times ClientWeight + IncrWeight}{{( 2.54 \times ClientHeight / 100 )}^{2}} & \begin{matrix}if ClientScale = lbs \\ and ClientScaleHeight = Inc ;\end{matrix}\end{matrix}$$

After which the curve function can be applied to the ClientBMI to obtain the BMI subscore S_{bmi}. The formula of the curve function is:

$${S}_{bmi} = \{ \begin{matrix}0 & if IBMI = YES and ClientBMI < 15 ; \\ {f}_{c} ( ClientBMI ; SCB ) & if IBMI = YES and 15 \leq ClientBMI \leq 34 ; \\ 0 & if IBMI = YES and ClientBMI > 34 ; \\ NULL & if IBMI = NO ,\end{matrix}$$

where SCB={(15,0), (18.5,90), (20,100), (23,100), (25,90), (30,50), (34,0)} and IBMI is the BMI contribution indicator. FIG. 7C shows a graphical representation of the BMI curve function.

If IBMI=YES, the formula of S_{bmi(AG)} is given by:

$${S}_{bmi ( AG )} = \{ \begin{matrix}78 & if ClientGender = NA and Clientage < 30 ; \\ 66 & if ClientGender = NA and 30 \leq Clientage < 40 ; \\ 69 & if ClientGender = NA and 40 \leq Clientage < 50 ; \\ 66 & if ClientGender = NA and 50 \leq Clientage < 60 ; \\ 65 & if ClientGender = NA and 60 \leq Clientage < 70 ; \\ 69 & if ClientGender = NA and Clientage \geq 70 ; \\ 87 & if ClientGender = M and Clientage < 30 ; \\ 70 & if ClientGender = M and 30 \leq Clientage < 40 ; \\ 67 & if ClientGender = M and 40 \leq Clientage < 50 ; \\ 60 & if ClientGender = M and 50 \leq Clientage < 60 ; \\ 63 & if ClientGender = M and 60 \leq Clientage < 70 ; \\ 68 & if ClientGender = M and Clientage \geq 70 ; \\ 69 & if ClientGender = F and Clientage < 30 ; \\ 61 & if ClientGender = F and 30 \leq Clientage < 40 ; \\ 56 & if ClientGender = F and 40 \leq Clientage < 50 ; \\ 72 & if ClientGender = F and 50 \leq Clientage < 60 ; \\ 67 & if ClientGender = F and 60 \leq Clientage < 70 ; \\ 71 & if ClientGender = F and Clientage \geq 70 ,\end{matrix}$$

Otherwise, S_{bmi(AG)}=NULL. The above example data are average scores of a Canadian population in various age and gender brackets.

The BMI health subscore S_{BMI} can be compared with the average score S_{BMI(AG)} of the general population in the client's age and gender category to determine whether the client's subscore is better than, equal to, or worse than others in the same age and gender category. A qualitative scale can be used to indicate whether the client's BMI subscore S_{bmi} is excellent, very good, good, fair, or poor. In some embodiments, the subscores for each rating may be provided in a range such as, for example: Excellent: 86-100; Very good: 74-85; Good: 62-73; Fair: 50-61; and Poor: 0-50. It should be appreciated that any other score may be utilized.

Weight

As another example, a weight health subscore S_{wei} may be generated to indicate the individual or group's wellness with respect to weight, as ranked in comparison to general population distribution information. The inputs may be age (Clientage), gender (ClientGender), height (ClientHeight—in cm or inches), ClientScaleHeight (indicating whether height is in cm or inches), weight (ClientWeight), ClientScale (indicating whether weight is in kg or lbs), the weight that client intends to change in kg (IncrWeight), and the contribution indicator IWei. IWei is “YES” if the BMI/weight indicator is “YES” and the weight/BMI selector is “weight”.

The weight subscore can be determined by first defining function f_{w}( ):

$${f}_{w} ( x ) = \{ \begin{matrix}{( \frac{ClientHeight}{100} )}^{2} \times x & \begin{matrix}if ClientScale = kg and \\ ClientScaleHeight = cm ;\end{matrix} \\ {( \frac{2.54 \times ClientHeight}{100} )}^{2} \times x & \begin{matrix}if ClientScale = kg and \\ ClientScaleHeight = Inc ;\end{matrix} \\ ( \frac{{ClientHeight}^{2}}{{100}^{2} \times 0.453592} ) \times x & \begin{matrix}if ClientScale = lbs and \\ ClientScaleHeight = cm ;\end{matrix} \\ ( \frac{{( 2.54 / ClientHeight )}^{2}}{{100}^{2} / 0.453592} ) \times x & \begin{matrix}if ClientScale = lbs and \\ ClientScaleHeight = Inc .\end{matrix}\end{matrix}$$

and defining:

$$NPClientWeight = \{ \begin{matrix}ClientWeight + IncrWeight if ClientScale = kg \\ ClientWeight + \frac{IncrWeight}{0.453592} if ClientScale = lbs\end{matrix} \}$$

Then, the weight subscore S_{wei} is given by:

$${S}_{wei} = \{ \begin{matrix}NULL & if IWei = NO ; \\ 0 & if NPClientWeight < {f}_{w} ( 15 ) ; \\ {f}_{c} ( NPClientWeight ; SCW ) & if {f}_{w} ( 15 ) \leq NPClientWeight \leq {f}_{w} ( 34 ) ; \\ 0 & if NPClientWeight > {f}_{w} ( 34 ) ;\end{matrix}$$

where SCW={(f_{w}(15),0), (f_{w}(18.5),90), (f_{w}(20),100), (f_{w}(23),100, (f_{w}(25),90), (f_{w}(30), 50), (f_{w}(34), 0)}

If IWei=YES, the calculation of S_{Wei(AG)} is the same as S_{bmi(AG)}:

$${S}_{wei ( AG )} = \{ \begin{matrix}78 & if ClientGender = NA and Clientage < 30 ; \\ 66 & if ClientGender = NA and 30 \leq Clientage < 40 ; \\ 69 & if ClientGender = NA and 40 \leq Clientage < 50 ; \\ 66 & if ClientGender = NA and 50 \leq Clientage < 60 ; \\ 65 & if ClientGender = NA and 60 \leq Clientage < 70 ; \\ 69 & if ClientGender = NA and Clientage \geq 70 ; \\ 87 & if ClientGender = M and Clientage < 30 ; \\ 70 & if ClientGender = M and 30 \leq Clientage < 40 ; \\ 67 & if ClientGender = M and 40 \leq Clientage < 50 ; \\ 60 & if ClientGender = M and 50 \leq Clientage < 60 ; \\ 63 & if ClientGender = M and 60 \leq Clientage < 70 ; \\ 68 & if ClientGender = M and Clientage \geq 70 ; \\ 69 & if ClientGender = F and Clientage < 30 ; \\ 61 & if ClientGender = F and 30 \leq Clientage < 40 ; \\ 56 & if ClientGender = F and 40 \leq Clientage < 50 ; \\ 72 & if ClientGender = F and 50 \leq Clientage < 60 ; \\ 67 & if ClientGender = F and 60 \leq Clientage < 70 ; \\ 71 & if ClientGender = F and Clientage \geq 70 ,\end{matrix}$$

If IWei=NO, S_{Wei(AG)}=NULL. The above example data are average scores of a Canadian population in various age and gender brackets.

The client's weight subscore S_{wei} can be compared with the average score S_{wei(AG)} of the general population in the client's age and gender category to determine whether the client's subscore is better than, equal to, or worse than others in the same age and gender category.

Waist Circumference

As another example, a waist circumference health subscore S_{wst} can be generated to indicate the individual or group's wellness with respect to waist circumference, as ranked in comparison to waist circumference in the general population distribution information. The inputs may be age (Clientage), gender (ClienGender), current waist circumference (ClientWaist0), length of waist in cm that client intends to change (IncrWaist), with negative values meaning a decrease in waist circumference, and a waist contribution indicator (D598), which is a yes/no value that determines whether the waist subscore contributes to the calculation of the client's overall wellness score. Additionally, ClientScale Waist is chosen between the values of “cm” or “inc” depending on whether ClientWaist0 is given in cm or inches, respectively.

A distribution of data of waist circumferences is provided, and can be grouped into the same age and gender brackets as above.

To obtain the client's waist subscore S_{wst}, the client's target waist circumference is first determined, for example by the following formula:

$$ClientWaist = \{ \begin{matrix}max ( 0 , 2.5 \times ClientWaist 0 + IncrWaist ) & if ClientScaleWaist = Inc \\ max ( 0 , ClientWaist 0 + IncrWaist ) & if ClientScaleWaist = cm\end{matrix}$$

The client's rank among the general population WaistRank can then be calculated based on ClientWaist and the distribution data of waist circumference, as was done to calculate StepsRank. The waist distribution data can be divided into eleven deciles as follows:

| | Cumulative percent (%) | | | | | | | | | | |
|---|---|---|---|---|---|---|---|---|---|---|---|
| | 0 | 10 | 20 | 30 | 40 | 50 | 60 | 70 | 80 | 90 | 100 |
| Waist quartile | w₀ | w₁ | w₂ | w₃ | w₄ | w₅ | w₆ | w₇ | w₈ | w₉ | w₁₀ |

where w₀=w₁−[Σᵢ₌₁⁸(wᵢ₊₁−wᵢ)]/8, w₁₀=w₉+[Σᵢ₌₁⁸(wᵢ₊₁−wᵢ)]/8, which differs from the deciles for steps and MV activity time.

The rank of the client's waist relative to the general population can then be estimated by the formula:

$$WaistRank = \{ \begin{matrix}0 & if ClientWaist < {w}_{0} \\ {f}_{c} ( ClientWaist ; RW ) & if {w}_{0} \leq ClientWaist \leq {w}_{10} \\ 100 & if ClientWaist > {w}_{10}\end{matrix} ,$$

where RW={(w₀,0), (w₁,10), (w₂,20), (w₃,30), . . . , (w₉,90), (w₉,100)}. After obtaining WaistRank, the curve function can be applied to obtain the waist subscore S_{wst}. The client's waist subscore S_{wst} can be compared with the average score S_{wst(AG)} of the general population in the client's age and gender category to determine whether the client's subscore is better than, equal to, or worse than others in the same age and gender category. A qualitative scale can be used to indicate whether the waist circumference health subscore S_{wst} is excellent, very good, good, fair, or poor. In some embodiments, the subscores for each rating may be provided in a range such as, for example: Excellent: 86-100; Very good: 74-85; Good: 62-73; Fair: 50-61; and Poor: 0-50. It should be appreciated that any other score may be utilized.

Smoking

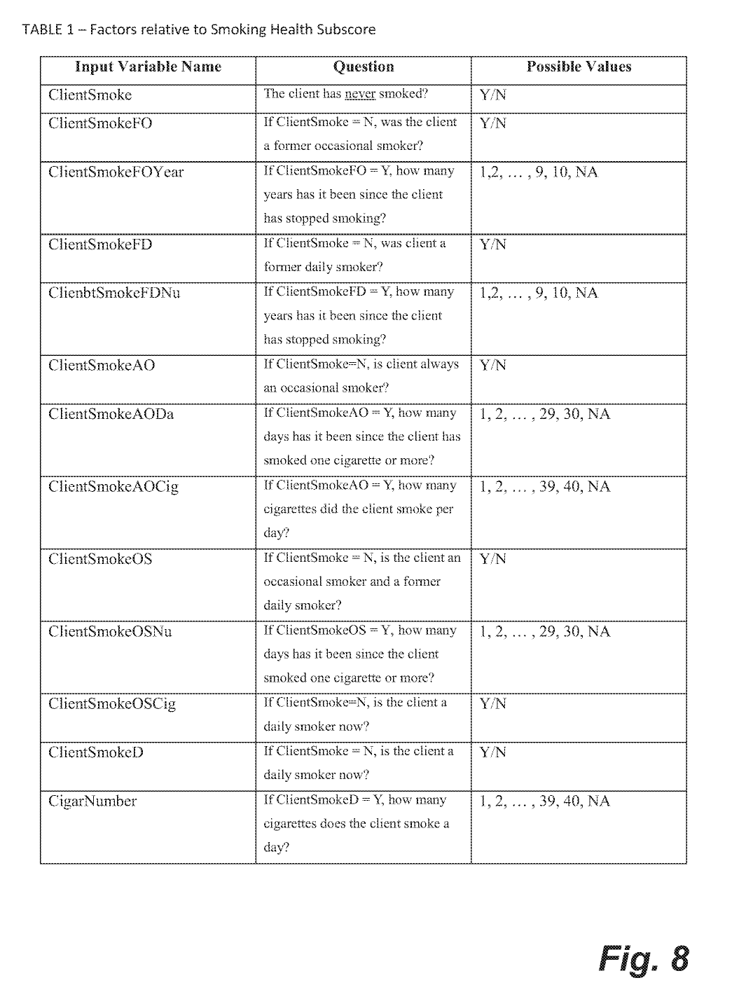

As another example, a smoking health subscore Sₛₘₖ can be generated to indicate the individual or group's wellness with respect to smoking habits, based upon how the individual or group ranks compared to the general population information. The inputs for the smoking subscore may include age (Clientage), gender (ClientGender), a smoking contribution indicator (D599), which is a yes/no value that determines whether the drinking subscore contributes to the calculation of the client's overall wellness score, as well as the variable shown in FIG. 8. Additionally, distribution data of the general population can be obtained for each of the following smoking levels for various age brackets and genders: Never Smoked, Former Occasional Smoker, Former Daily Smoker, Always an Occasional Smoker, Occasional Smoker and Former Daily Smoker, and Daily Smoker.

The smoking subscore is given by the following formula:

$${S}_{smk} = \{ \begin{matrix}100 & if ClientSmoke = Y \\ 85 + ( ClientSmokeF OYear - 1 ) \times \frac{100 - 85}{9 - 0} & \begin{matrix}if ClientSmoke = N and \\ ClientSmokeFO = Y\end{matrix} \\ 70 + ( ClientSmokeFDNu - 1 ) \times \frac{100 - 70}{14 - 0} & \begin{matrix}if ClientSmoke = N and \\ ClientSmokeFD = Y\end{matrix} \\ 70 - ( ClientSmokeAODa - 1 ) \times \frac{70 - 0}{29 - 0} & \begin{matrix}if ClientSmoke = N and \\ ClientSmokeAO = Y\end{matrix} \\ 60 + ( ClientSmokeOSNu - 1 ) \times \frac{60 - 0}{29 - 0} & \begin{matrix}if ClientSmoke = N and \\ ClientSmokeOS = Y\end{matrix} \\ 20 + ( CigarNumber - 1 ) \times \frac{20 - 0}{39 - 0} & \begin{matrix}if ClientSmoke = N and \\ ClientSmokeD = Y\end{matrix}\end{matrix}$$

If smoking contribution indicator D599=NO, then Sₛₘₖ=NULL.

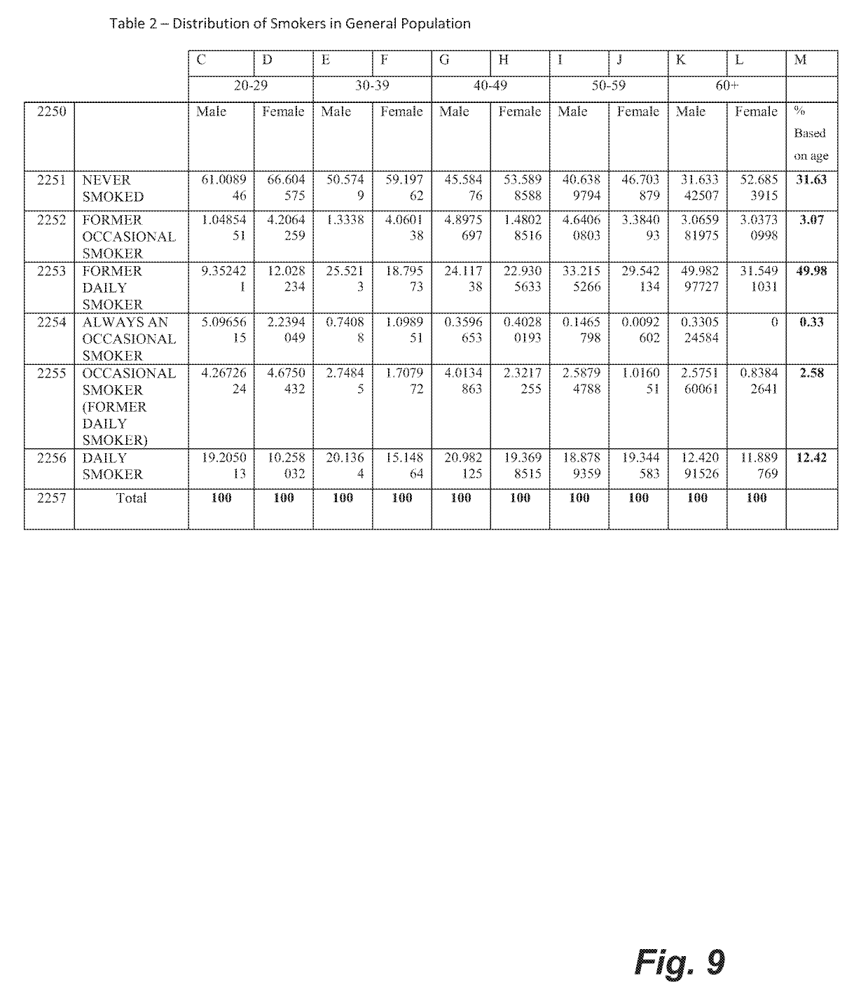

If D599=YES, the formula of S_{smk(AG)} is given by:

$${S}_{wei ( AG )} = \{ \begin{matrix}\begin{matrix}100 \times C 2250 + 92 \times C 2251 + 85 \times C 2252 \\ + 50 \times C 2253 + 43 \times C 2254 + 12 \times C 2255\end{matrix} & \begin{matrix}if ClientGender = M \\ and 20 \leq Clientage < 30 ;\end{matrix} \\ \begin{matrix}100 \times D 2250 + 92 \times D 2251 + 85 \times D 2252 \\ + 50 \times D 2253 + 43 \times D 2254 + 12 \times D 2255\end{matrix} & \begin{matrix}if ClientGender = F \\ and 20 \leq Clientage < 30 ;\end{matrix} \\ \begin{matrix}100 \times E 2250 + 92 \times E 2251 + 85 \times E 2252 \\ + 50 \times E 2253 + 43 \times E 2254 + 12 \times E 2255\end{matrix} & \begin{matrix}if ClientGender = M \\ and 30 \leq Clientage < 40 ;\end{matrix} \\ 100 \times F 2250 + 92 \times F 2251 + 85 \times F 2252 & if ClientGender = F \\ + 50 \times F 2253 + 43 \times F 2254 + 12 \times F 2255 & and 30 \leq Clientage < 40 ; \\ 100 \times G 2250 + 92 \times G 2251 + 85 \times G 2252 & if ClientGender = M \\ + 50 \times G 2253 + 43 \times G 2254 + 12 \times G 2255 & and 40 \leq Clientage < 50 ; \\ 100 \times H 2250 + 92 \times H 2251 + 85 \times H 2252 & if ClientGender = F \\ + 50 \times H 2253 + 43 \times H 2254 + 12 \times H 2255 & and 40 \leq Clientage < 50 ; \\ 100 \times I 2250 + 92 \times I 2251 + 85 \times I 2252 & if ClientGender = M \\ + 50 \times I 2253 + 43 \times I 2254 + 12 \times I 2255 & and 50 \leq Clientage < 60 ; \\ 100 \times J 2250 + 92 \times J 2251 + 85 \times J 2252 & if ClientGender = F \\ + 50 \times J 2253 + 43 \times J 2254 + 12 \times J 2255 & and 50 \leq Clientage < 60 ; \\ 100 \times K 2250 + 92 \times K 2251 + 85 \times K 2252 & if ClientGender = M \\ + 50 \times K 2253 + 43 \times K 2254 + 12 \times K 2255 & and Clientage \geq 60 ; \\ 100 \times L 2250 + 92 \times L 2251 + 85 \times L 2252 & if ClientGender = F \\ + 50 \times L 2253 + 43 \times L 2254 + 12 \times L 2255 & and Clientage \geq 60 ,\end{matrix}$$

where C-L combined with numbers 2250-2257 are references to a general population distribution information database with respect to the smoking levels of the general population. Examples of general population information can be found in FIG. 9.

If D599=NO, then S_{smk(AG)}=NULL. Accordingly, the smoking health subscore Sₛₘₖ can be compared with the score S_{smk(AG)} of the general population in the group corresponding in age and gender to determine whether the health subscore is better than, equal to, or worse than others in the same age and gender category. A qualitative scale can be used to indicate whether the client's smoking subscore Sₛₘₖ is excellent, very good, good, fair, or poor. In some embodiments, the subscores for each rating may be provided in a range such as, for example: Excellent: 86-100; Very good: 74-85; Good: 62-73; Fair: 50-61; and Poor: 0-50. It should be appreciated that any other score may be utilized.

Drinking

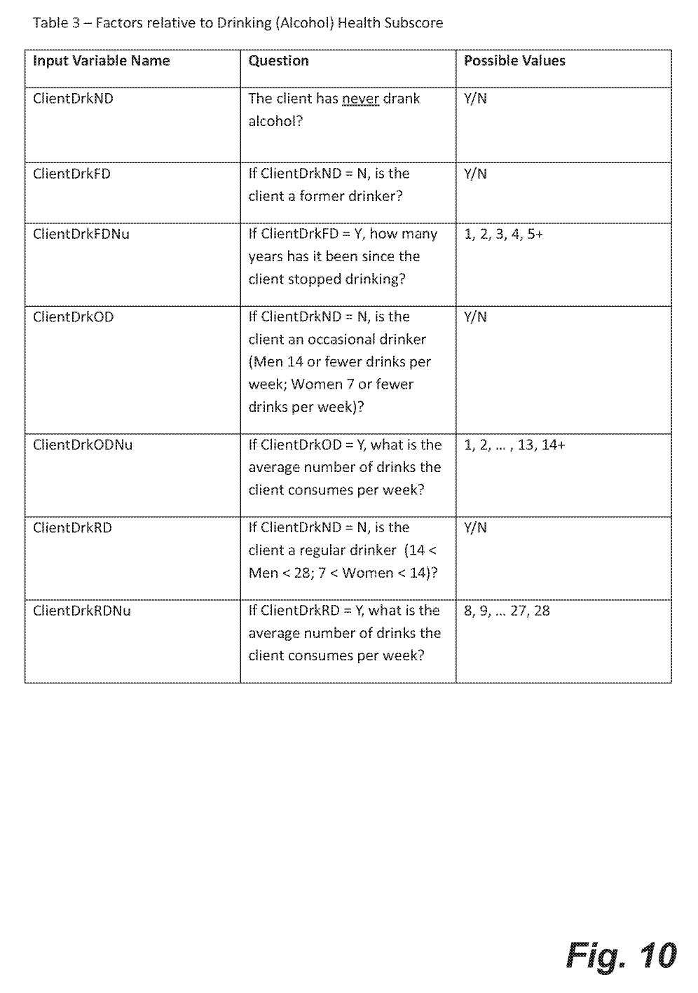

As another example, a drinking Health Subscore S_{drk} can be generated to the individual or group's wellness with respect to drinking habits, based upon how the individual or group ranks compared with the general population information. The drinking Health Subscore may be generated using age (Clientage), gender (ClientGender), a drinking contribution indicator (D600), which is ayes/no value that determines whether the drinking subscore contributes to the calculation of the client's overall wellness score, as well as the factors shown in FIG. 10. Additionally, distribution data of the general population is provided for each of the following drinking levels for various age brackets and genders: Regular Drinker, Occasional Drinker, Former Drinker, Never Drink.

The drinking subscore S_{drk} is given by the following formula:

$${S}_{drk} = \{ \begin{matrix}100 & if ClientDrkND = Y \\ 85 + ( ClientDrkFDNu - 1 ) \times \frac{100 - 85}{4 - 0} & \begin{matrix}if ClientDrkND = N and \\ ClientDrkFD = Y\end{matrix} \\ 95 - ( ClientDrkODNu - 1 ) \times \frac{95 - 50}{14 - 0} & \begin{matrix}if ClientDrkND = N and \\ ClientDrkOD = Y and \\ ClientGender is NOT F\end{matrix} \\ 50 - ( ClientDrkODNu - 8 ) \times \frac{50 - 0}{21 - 8} & \begin{matrix}if ClientDrkND = N and \\ ClientDrkOD = Y and \\ ClientGender = F and \\ ClientDrkODNu > 7\end{matrix} \\ 90 - ( ClientDrkODNu - 1 ) \times \frac{90 - 50}{7 - 0} & \begin{matrix}if ClientDrkND = N and \\ ClientDrkOD = Y and \\ ClientGender = F and \\ ClientDrkODNu <= 7\end{matrix} \\ 95 - ( ClientDrkRDNu - 1 ) \times \frac{95 - 50}{14 - 0} & \begin{matrix}if ClientDrkND = N and \\ ClientDrkRD = Y and \\ ClientGender is NOT F and \\ ClientDrkODNu < 15\end{matrix} \\ 50 - ( ClientDrkRDNu - 15 ) \times \frac{50 - 0}{28 - 15} & \begin{matrix}if ClientDrkND = N and \\ ClientDrkRD = Y and \\ ClientGender is NOT F and \\ ClientDrkRDNu >= 15\end{matrix} \\ 0 & \begin{matrix}if ClientDrkND = N \\ ClientDrkRD = Y and \\ ClientGender = F and \\ ClientDrkRDNu > 14\end{matrix} \\ 50 - ( ClientDrkRDNu - 8 ) \times \frac{50 - 0}{21 - 8} & \begin{matrix}if ClientDrkND = N \\ ClientDrkRD = Y and \\ ClientGender = F and \\ ClientDrkRDNu <= 14\end{matrix}\end{matrix}$$

If the drinking contribution indicator D600=NO, then S_{drk}=NULL.

If D600=YES, the formula of S_{drk(AG)} is given by:

$${S}_{drk ( AG )} = \{ \begin{matrix}\begin{matrix}69 \times C 2228 + 95 \times C 2229 + \\ 93 \times C 2230 + 100 \times C 2231\end{matrix} & \begin{matrix}if ClientGender = M and \\ 20 \leq Clientage < 30 ;\end{matrix} \\ \begin{matrix}69 \times E 2228 + 95 \times E 2229 + \\ 93 \times E 2230 + 100 \times E 2231\end{matrix} & \begin{matrix}if ClientGender = M and \\ 30 \leq Clientage < 40 ;\end{matrix} \\ \begin{matrix}69 \times G 2228 + 95 \times G 2229 + \\ 93 \times G 2230 + 100 \times G 2231\end{matrix} & \begin{matrix}if ClientGender = M and \\ 40 \leq Clientage < 50 ;\end{matrix} \\ \begin{matrix}69 \times I 2228 + 95 \times I 2229 + \\ 93 \times I 2230 + 100 \times I 2231\end{matrix} & \begin{matrix}if ClientGender = M and \\ 50 \leq Clientage < 60 ;\end{matrix} \\ \begin{matrix}69 \times K 2228 + 95 \times K 2229 + \\ 93 \times K 2230 + 100 \times K 2231\end{matrix} & \begin{matrix}if ClientGender = M and \\ \leq Clientage \geq 60 ;\end{matrix} \\ \begin{matrix}69 \times D 2228 + 95 \times D 2229 + \\ 93 \times D 2230 + 100 \times D 2231\end{matrix} & \begin{matrix}if ClientGender = F and \\ 20 \leq Clientage < 30 ;\end{matrix} \\ \begin{matrix}69 \times F 2228 + 95 \times F 2229 + \\ 93 \times F 2230 + 100 \times F 2231\end{matrix} & \begin{matrix}if ClientGender = F and \\ 30 \leq Clientage < 40 ;\end{matrix} \\ \begin{matrix}69 \times H 2228 + 95 \times H 2229 + \\ 93 \times H 2230 + 100 \times H 2231\end{matrix} & \begin{matrix}if ClientGender = F and \\ 40 \leq Clientage < 50 ;\end{matrix} \\ \begin{matrix}69 \times J 2228 + 95 \times J 2229 + \\ 93 \times J 2230 + 100 \times J 2231\end{matrix} & \begin{matrix}if ClientGender = F and \\ 50 \leq Clientage < 60 ;\end{matrix} \\ \begin{matrix}69 \times L 2228 + 95 \times L 2229 + \\ 93 \times L 2230 + 100 \times L 2231\end{matrix} & \begin{matrix}if ClientGender = F and \\ \leq Clientage \geq 60 ,\end{matrix}\end{matrix}$$

where C-L combined with numbers 2250-2257 are references to a general population distribution information database with respect to the drinking levels of the general population.

If D600=NO, then S_{drk(AG)}=NULL.

The client's drinking subscore S_{drk} can be compared with the score S_{drk(AG)} of the general population in the client's age and gender category to determine whether the client's subscore is better than, equal to, or worse than others in the same age and gender category. A qualitative scale can be used to indicate whether the client's drinking subscore S_{drk} is excellent, very good, good, fair, or poor. In some embodiments, the subscores for each rating may be provided in a range such as, for example: Excellent: 86-100; Very good: 74-85; Good: 62-73; Fair: 50-61; and Poor: 0-50. It should be appreciated that any other score may be utilized.

Resting Estimated VO2 Max

VO2 Max is an individual's maximal oxygen consumption and can be measured in a variety of ways. Accordingly, as another example, there are a number of VO2 Max Health Subscores that can be generated and used in the calculation of the overall wellness score (as described in more detail below).

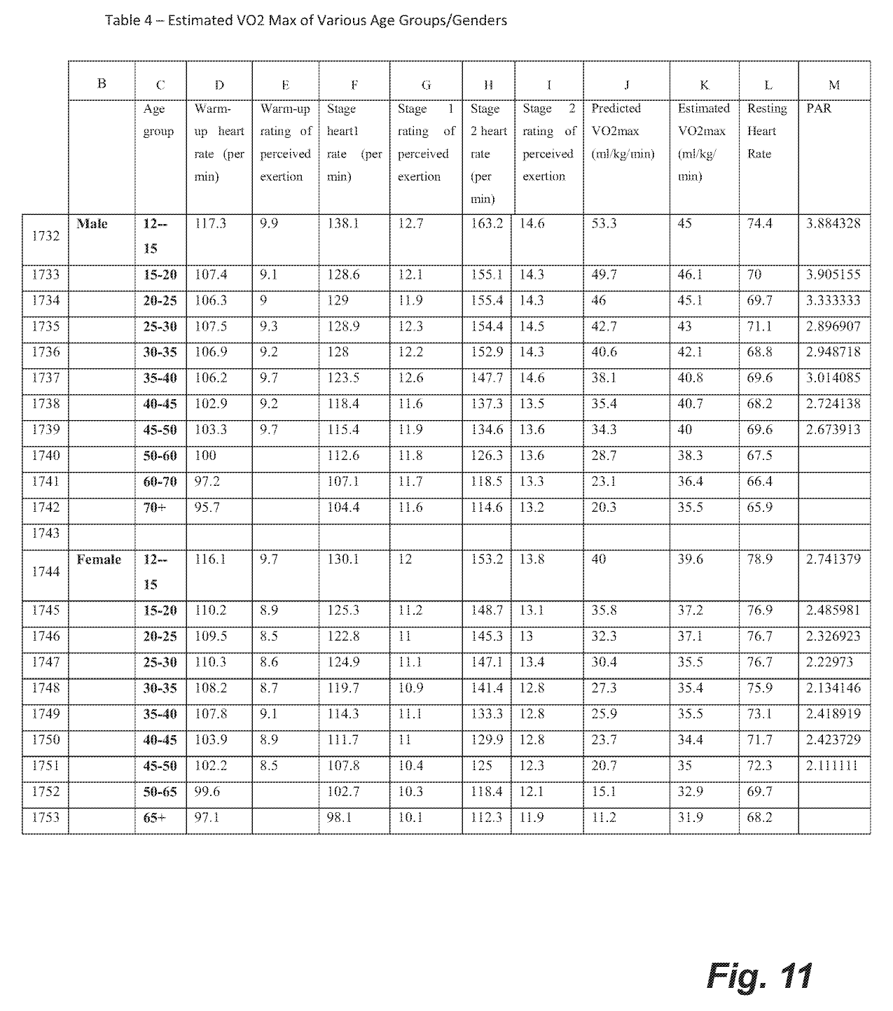

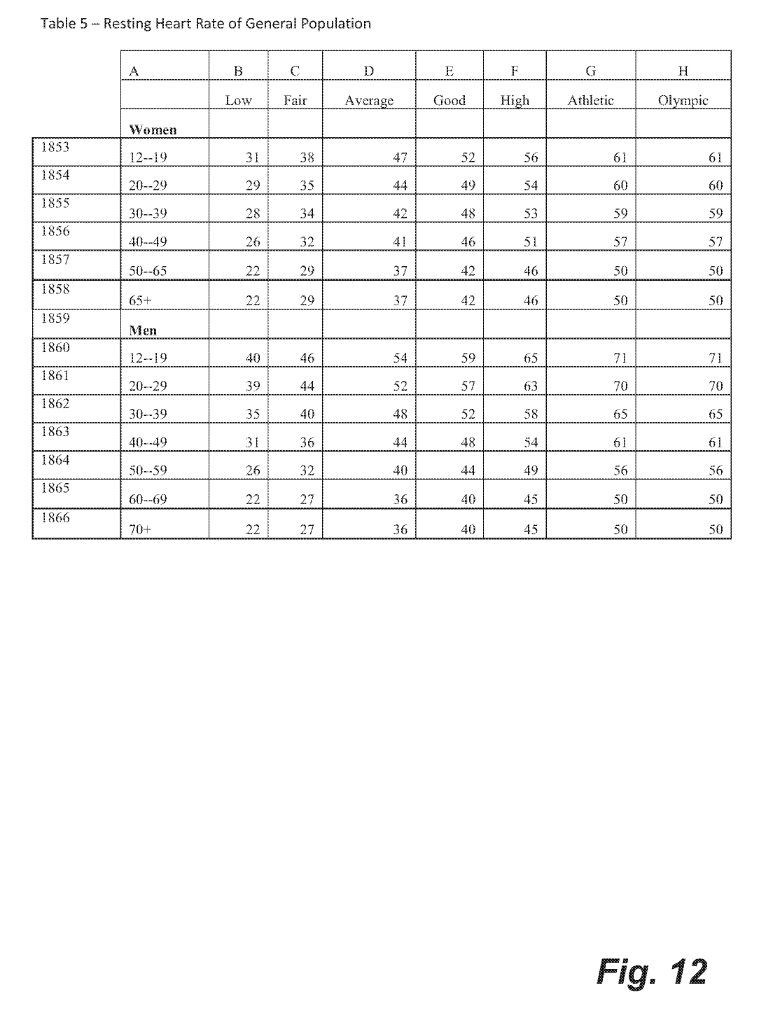

In some embodiments, the VO2 Max subscore Sᵥᵣ may be based upon an estimation of the VO2max based on resting heart rate. The inputs for generating the VO2 max subscore based on resting heart rate can be client's age (Clientage), gender (ClientGender), resting heart rate (HR20Second), which may be taken over a predetermined period of time such as, for example, over an interval or seconds to minutes, or preferably over a period of 20 seconds, and a resting estimated VO2 max contribution indicator (D601), which is a yes/no value that determines whether the resting VO2 max subscore contributes to the calculation of the overall wellness score. Additionally, general population distribution data of the resting heart rate and VO2 max norms of the general population is provided for various age brackets and genders, which can be tabulated as shown in FIG. 11. The population distribution data of resting heart rate and VO2 max norms can be tabulated in a database (see, for example, FIG. 12). As would be understood, the present database may comprise a software database operative for fast and convenient access. In some embodiments, population data for Canada is provided. Having regard to FIG. 12, seven columns are provided as representation of seven possible levels of VO2max: Low, Fair, Average, Good, High, Athletic, Olympic. The upper six rows are six age levels of the female group (12-19, 20-29, 30-39, 40-49 50-65, and 65+). The lower seven rows are seven age levels of the male group: 12-19, 20-29, 30-39, 40 49, 50-59, 60-69, and 70+. HR20Second, which represents the client's resting heart rate, can be obtained by the client's device or manually entered by the client.

The resting estimated VO2max subscore Sᵥᵣ can be estimated by the following formula:

$${S}_{vr} = F ( VO 2 Resting ) = \{ \begin{matrix}f ( VO 2 Resting , B 1854 , H 1854 ) & \begin{matrix}if 20 \leq Clientage < 30 and \\ ClientGender = F ;\end{matrix} \\ f ( VO 2 Resting , B 1855 , H 1855 ) & \begin{matrix}if 30 \leq Clientage < 40 and \\ ClientGender = F ;\end{matrix} \\ f ( VO 2 Resting , B 1856 , H 1856 ) & \begin{matrix}if 40 \leq Clientage < 50 and \\ ClientGender = F ;\end{matrix} \\ f ( VO 2 Resting , B 1857 , H 1857 ) & \begin{matrix}if 50 \leq Clientage < 65 and \\ ClientGender = F ;\end{matrix} \\ f ( VO 2 Resting , B 1858 , H 1858 ) & \begin{matrix}if Clientage \geq 65 and \\ ClientGender = F ;\end{matrix} \\ f ( VO 2 Resting , B 1854 , H 1854 ) & \begin{matrix}if 20 \leq Clientage < 30 and \\ ClientGender = M ;\end{matrix} \\ f ( VO 2 Resting , B 1855 , H 1855 ) & \begin{matrix}if 30 \leq Clientage < 40 and \\ ClientGender = M ;\end{matrix} \\ f ( VO 2 Resting , B 1856 , H 1856 ) & \begin{matrix}if 40 \leq Clientage < 50 and \\ ClientGender = M ;\end{matrix} \\ f ( VO 2 Resting , B 1857 , H 1857 ) & \begin{matrix}if 50 \leq Clientage < 60 and \\ ClientGender = M ;\end{matrix} \\ f ( VO 2 Resting , B 1858 , H 1858 ) & \begin{matrix}if 60 \leq Clientage < 70 and \\ ClientGender = M ;\end{matrix} \\ f ( VO 2 Resting , B 1859 , H 1859 ) & \begin{matrix}if Clientage \geq 70 and \\ ClientGender = M ,\end{matrix}\end{matrix}$$

where F( ) denotes Sᵥᵣ as a function of VO2 Resting, B&H combined with numbers 1854-1859refer to the cells of the population distribution table for VO2 Max shown in FIG. 12, and the VO2Resting is calculated by:

$$VO 2 Resting = 5.1 \times \frac{220 - Clientage}{HR 20 Second}$$

The function f( , , , ) can then be defined by the following formula:

$$f ( x , a , b ) = \{ \begin{matrix}\frac{( x - 0 ) \times ( SC 50 P - B 0 )}{a - 6} & if x < a ; \\ SC 50 P + \frac{( x - a ) \times ( SC 100 P - SC 50 P )}{b - a} & if a \leq x < b ; \\ 100 & if x \geq b .\end{matrix}$$

where SC100P, SC50P, and S0 are 100, 40, and 0, respectively.

If the resting estimated VO2 max contribution indicator D601=NO, then S_{vr(AG)}=NULL. If D601=YES, S_{vr(AG)} is given by:

$${S}_{vr ( AG )} = F ( VO 2 RestingAgeGen )$$

$$where$$

$$VO 2 RestingAgeGen = 5.1 \times \frac{220 - Clientage}{HR 20 SecondAGen}$$

$$and$$

$$VO 2 RestingAgeGen = \{ \begin{matrix}74.4 & if ClientGender = M and Clientage < 15 ; \\ 70 & if ClientGender = M and 15 \leq Clientage < 20 ; \\ 69.7 & if ClientGender = M and 20 \leq Clientage < 25 ; \\ 71.1 & if ClientGender = M and 25 \leq Clientage < 30 ; \\ 68.8 & if ClientGender = M and 30 \leq Clientage < 35 ; \\ 69.6 & if ClientGender = M and 35 \leq Clientage < 40 ; \\ 68.2 & if ClientGender = M and 40 \leq Clientage < 45 ; \\ 69.6 & if ClientGender = M and 45 \leq Clientage < 50 ; \\ 67.5 & if ClientGender = M and 50 \leq Clientage < 60 ; \\ 66.4 & if ClientGender = M and 60 \leq Clientage < 70 ; \\ 65.9 & if ClientGender = M and Clientage \geq 70 ; \\ 78.9 & if ClientGender = F and Clientage < 15 ; \\ 76.9 & if ClientGender = F and 15 \leq Clientage < 20 ; \\ 76.7 & if ClientGender = F and 20 \leq Clientage < 25 ; \\ 76.7 & if ClientGender = F and 25 \leq Clientage < 30 ; \\ 75.9 & if ClientGender = F and 30 \leq Clientage < 35 ; \\ 73.1 & if ClientGender = F and 35 \leq Clientage < 40 ; \\ 71.7 & if ClientGender = F and 40 \leq Clientage < 45 ; \\ 72.3 & if ClientGender = F and 45 \leq Clientage < 50 ; \\ 69.7 & if ClientGender = F and 50 \leq Clientage < 65 ; \\ 68.2 & if ClientGender = F and Clientage \geq 65.\end{matrix}$$

Treadmill Test Estimated VO2 Max

In some other embodiments, a VO2 Max health subscore Sᵥₜ may be generated to indicate the individual or group's wellness with respect to an estimation of the client's VO2 Max based on the client's heart rates at the end of two stages of exercise: stage 1 and stage 2, where stage 1 and stage 2 represent two different intensities of exercise, and where stage 2 is more intense than stage 1. Both stages may be customized for each individual based on their age, gender and resting heart rate. The inputs for generating the treadmill test estimate VO2max subscore may be age (Clientage), gender (ClientGender), the heart rates at the end of stage 1 and stage 2 exercise, and a treadmill test estimated VO2max contribution indicator (IVO2T), which is a yes/no value that determines whether the treadmill VO2 max subscore Sᵥₜ contributes to the calculation of the client's overall wellness score. Additionally, population data of VO2 max norms, predicted VO2max in stage 1 and stage 2 exercise, and population data of estimated VO2 max are also used. This data can be tabulated as in FIG. 11 showing VO2 Max of General Population.

Contribution indicator IVO2T is determined by:

$$IVO 2 T = \{ \begin{matrix}YES & \begin{matrix}if D 602 = Yes and B 602 = Estim . \\ VO 2 Max ( Treadmill ) ;\end{matrix} \\ NO & otherwise ,\end{matrix}$$

where D602 is the indicator of whether any one of the treadmill test estimated VO2max and model based estimated VO2max is taken into the calculation of overall score, and B602 is the indicator of which one of the two VO2max is chosen.

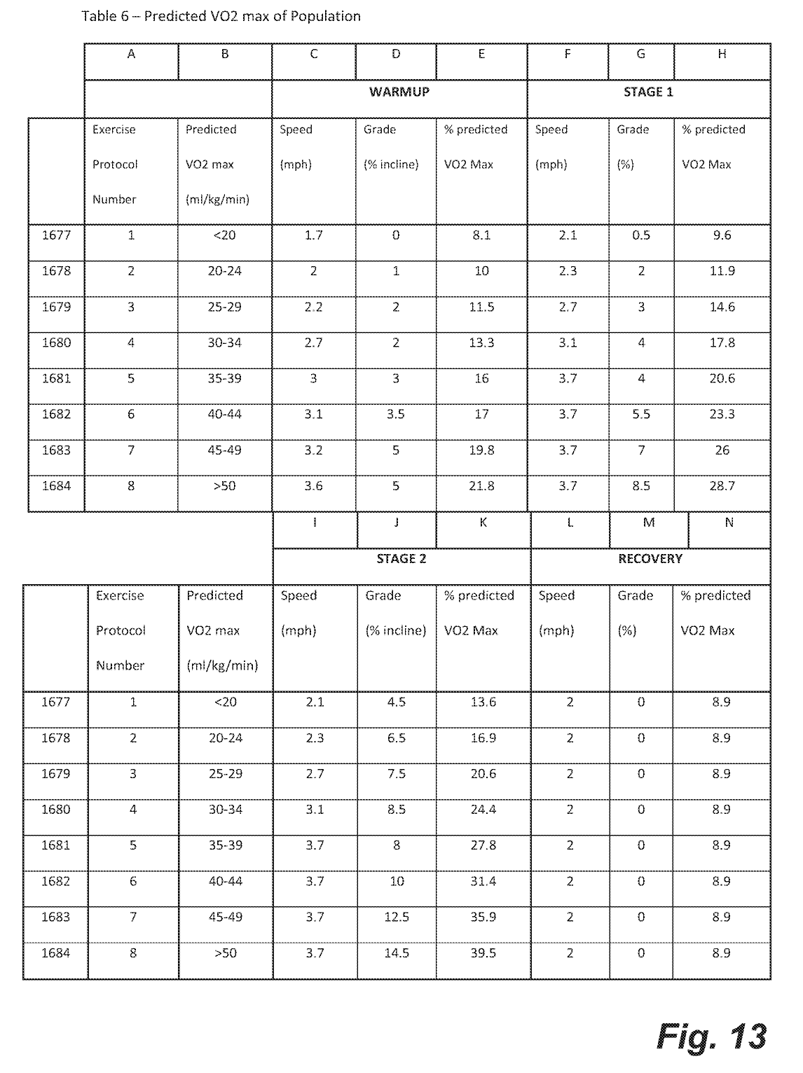

A population data of predicted VO2max of stage 1 and stage 2 can be tabulated in a database for fast and convenient access (e.g. such as an Excel™ spreadsheet). In one embodiment, general population distribution data for Canada may be obtained from any appropriate sources including, for example, the “National Youth Fitness Survey Treadmill Examination Manual”, Appendix C, and tabulated as provided in FIG. 13. The client's heart rates at the end of stage 1 and stage 2 exercise are denoted as HRs1Tread and HRs12Tread, respectively. The Canadian population data of estimated VO2 max can be tabulated as in FIG. 11.

The variables VO2 Tread and VO2 TreadAgeGen are used to calculate the treadmill estimated VO2 max subscore Sᵥₜ. The following information is required to calculated VO2 Tread:

$$x 1 ( submax VO 2 at end of Stage 1 ) = \{ \begin{matrix}H 1677 & if PredVO 2 max < 20 ; \\ H 1678 & if 20 \leq PredVO 2 max < 25 ; \\ H 1679 & if 25 \leq PredVO 2 max < 30 ; \\ H 1680 & if 30 \leq PredVO 2 max < 35 ; \\ H 1681 & if 35 \leq PredVO 2 max < 40 ; \\ H 1682 & if 40 \leq PredVO 2 max < 45 ; \\ H 1683 & if 45 \leq PredVO 2 max < 50 ; \\ H 1684 & if PredVO 2 max \geq 50.\end{matrix} \\ x 2 ( submax Vo 2 at end of Stage 2 ) = \{ \begin{matrix}K 1677 & if PredVO 2 max < 20 ; \\ K 1678 & if 20 \leq PredVO 2 max < 25 ; \\ K 1679 & if 25 \leq PredVO 2 max < 30 ; \\ K 1680 & if 30 \leq PredVO 2 max < 35 ; \\ K 1681 & if 35 \leq PredVO 2 max < 40 ; \\ K 1682 & if 40 \leq PredVO 2 max < 45 ; \\ K 1683 & if 45 \leq PredVO 2 max < 50 ; \\ K 1684 & if PredVO 2 max \geq 50.\end{matrix}$$

VO2 Tread is given by:

$$VO 2 Tread = ( 220 - Clientage - \frac{HRs 1 Tread + HRs 2 Tread}{2} ) \times ( \frac{x 2 - x 1}{HRs 2 Tread - HRs 1 Tread} ) + \frac{x 2 + x 1}{2}$$

VO2TreadAgeGen is given by:

$$VO 2 TreadAgeGen = \{ \begin{matrix}45 & if ClientGender = M and Clientage < 15 ; \\ 46.1 & if ClientGender = M and 15 \leq Clientage < 20 ; \\ 45.1 & if ClientGender = M and 20 \leq Clientage < 25 ; \\ 43 & if ClientGender = M and 25 \leq Clientage < 30 ; \\ 42.1 & if ClientGender = M and 30 \leq Clientage < 35 ; \\ 40.8 & if ClientGender = M and 35 \leq Clientage < 40 ; \\ 40.7 & if ClientGender = M and 40 \leq Clientage < 45 ; \\ 40 & if ClientGender = M and 45 \leq Clientage < 50 ; \\ 38.3 & if ClientGender = M and 50 \leq Clientage < 60 ; \\ 36.4 & if ClientGender = M and 60 \leq Clientage < 70 ; \\ 35.5 & if ClientGender = M and Clientage \geq 70 ; \\ 65.9 & if ClientGender = F and Clientage < 15 ; \\ 76.9 & if ClientGender = F and 15 \leq Clientage < 20 ; \\ 76.7 & if ClientGender = F and 20 \leq Clientage < 25 ; \\ 76.7 & if ClientGender = F and 25 \leq Clientage < 30 ; \\ 75.9 & if ClientGender = F and 30 \leq Clientage < 35 ; \\ 73.1 & if ClientGender = F and 35 \leq Clientage < 40 ; \\ 71.7 & if ClientGender = F and 40 \leq Clientage < 45 ; \\ 72.3 & if ClientGender = F and 45 \leq Clientage < 50 ; \\ 69.7 & if ClientGender = F and 50 \leq Clientage < 65 ; \\ 68.2 & if ClientGender = F and Clientage \geq 65.\end{matrix}$$

The data above being the estimated VO2 max for various age brackets and genders found in column K, rows 1732-1753 of FIG. 11, above.

The treadmill estimated VO2 max subscore is given by:

$${S}_{vt} = \{ \begin{matrix}F ( VO 2 Tread ) & if IVO 2 T = YES ; \\ NULL & if IVO 2 T = NO .\end{matrix}$$

where the function F( ) is the function used above for calculating the subscore of resting estimated VO2 max.

The formula of S_{vt(AG)} is given by:

$${S}_{vt ( AG )} = \{ \begin{matrix}F ( VO 2 TreadAgeGen ) & if IVO 2 T = YES ; \\ NULL & if IVO 2 T = NO .\end{matrix}$$

Model Estimated VO2 Max

In yet other embodiments, a VO2 Max Health Subscore Sᵥₘ may generated to indicate the individual or group's wellness with respect to an estimation of the client's VO2 Max based on the age (Clientage), gender (ClientGender), BMI (ClientBMI), Physical Activity Rate (PARScore), the client's resting heart rate (HR20Second), and the model estimated VO2 max contribution indicator IVO2M, which is a yes/no value that determines whether the model estimated VO2 max subscore Sᵥₘ contributes to the calculation of the client's overall wellness score.

As above, population data and the individual's data (if available) of heart rate and perceived exertion rating of 3 stages of exercise may also used (warm-up, stage 1, stage 2) to calculate the subscore, as well as population estimates of parameters in the linear model of estimating VO2 max, and population data of estimated VO2 max.

Contribution indicator IVO2M is determined by:

$$IVO 2 M = \{ \begin{matrix}YES & \begin{matrix}if D 602 = Yes and B 602 = Estim . \\ VO 2 Max ( Model ) ;\end{matrix} \\ NO & otherwise ,\end{matrix}$$

where D602, as described in the treadmill estimated VO2 max section above, is the indicator of whether any one of the treadmill test estimated VO2 max and model based estimated VO2 max is taken into the calculation of the overall score, and B602 is the indicator of which one of the two VO2 max is chosen.

A physical activity rate PARscore may be obtained through, for example, questions similar to the following: Would you say that you avoid walking or exertion? PARScore=0; You walk for pleasure and routinely use stairs? PARScore =1; You participate in regularly modest physical activity for: 10 to 60 minutes per week? PARScore=2; More than 60 minutes per week? PARScore=3; You participate regularly in heavy physical activity for: Less than 30 minutes per week? PARScore=4; 30 to 60 minutes per week? PARScore=5; 1 to 3 hours per week? PARScore=6; More than 3 hours per week? PARScore =7.

If the incoming wellness information show heart rates of the 3-stage exercise test (warm-up, stage 1, stage 2) and perceived exertion rating of the 2-stage exercise test(stage 1, stage 2), then such information may also be taken into account. Otherwise, such incoming wellness information is estimated based on the population data of heart rate and perceived exertion rating.

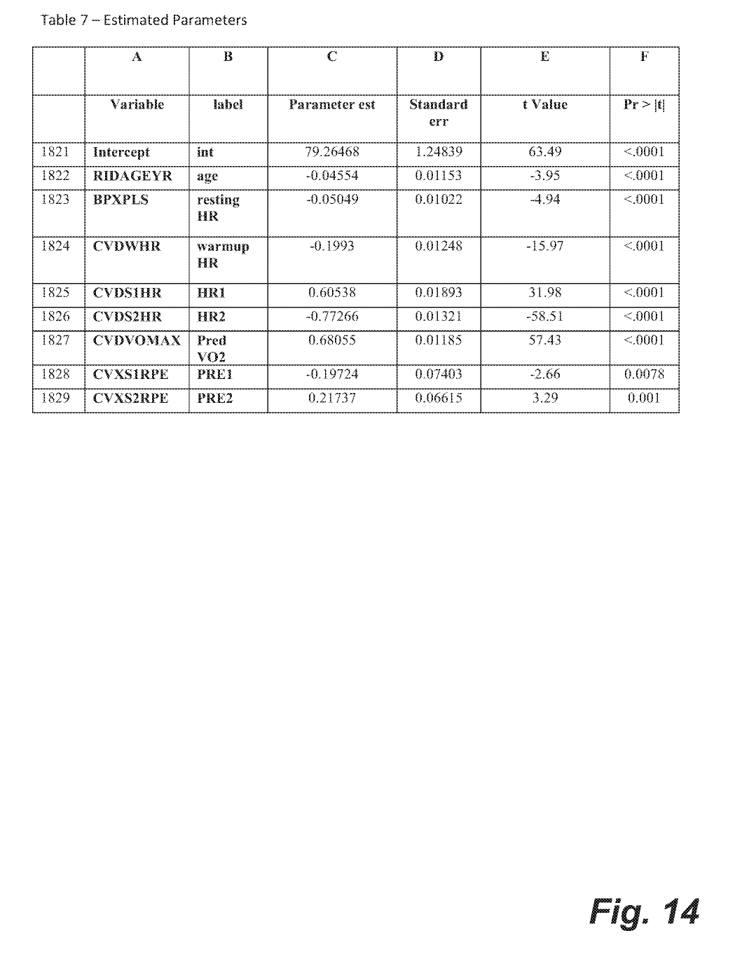

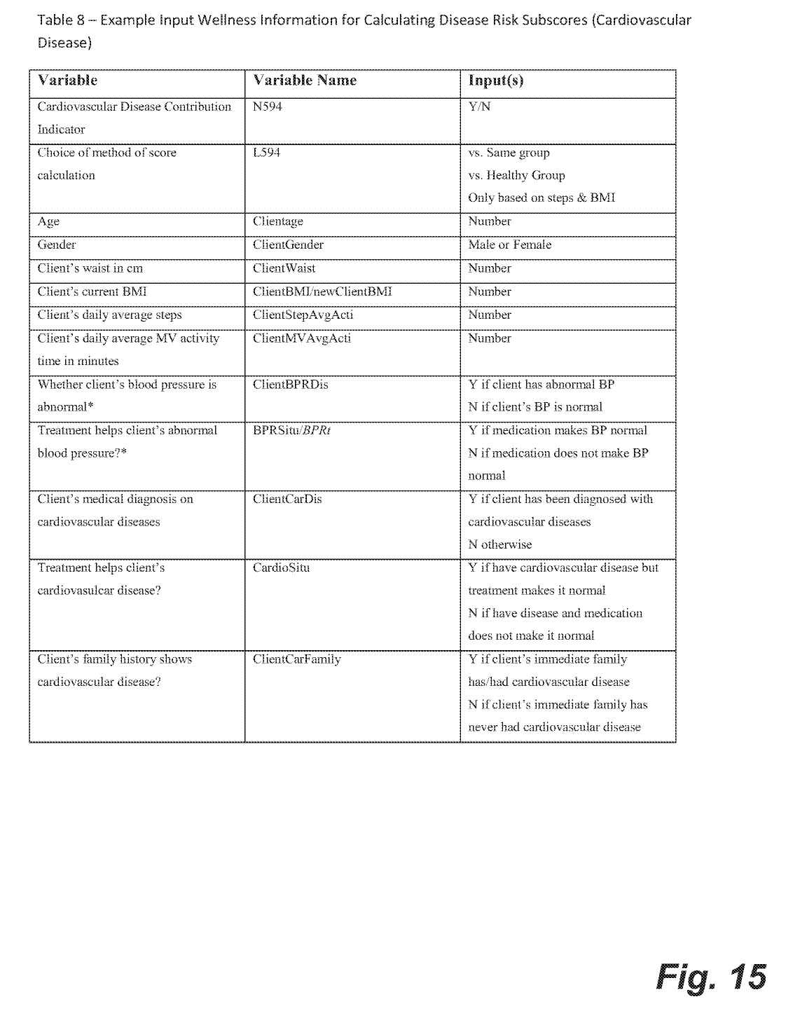

In some embodiments, the population data is located at columns D-I and rows 1732-1753 of the VO2 Max of General Population shown in FIG. 11. The columns D, F, H represent heart rates (per minute) in the three stages of exercise. Columns E, G, I represent the rating of perceived exertion in the three stages. The upper 11 rows (1732-1742) are 11 age groups of male: 12-14, 15-19, 20-24, 25-29, 30- 34, 35-39, 40-44, 45-49, 50-59, 60-69, and 70+. The lower 10 rows are 10 age groups of female: 12-14, 15-19, 20-24, 25-29, 30-34, 35-39, 40-44, 45-49, 50-65, and 65+. A linear model can be used to estimate the client's VO2 max. The estimates of parameters among the population can be tabulated in a database for convenient manipulation and tabulated as shown in FIG. 14, wherein data cell C1821 contains the intercept estimate. Cells C1822-1829 are coefficient estimates associated with age, resting heart rate, warm up heart rate, stage 1 heart rage, stage 2 heart rate, predicted VO2 max, stage 1 perceived rating, and stage 2 perceived rating.

General population data of estimated VO2 max can also be tabulated, as shown in FIG. 11, at column K, rows 1732-1753. The client's heart rate in the 3 stages of exercise (warm up, stage 1, stage 2), denoted as HRw, HR1, and HR2, respectively, and perceived exertion rating in the 2 stages (stage 1, stage 2), denoted as PR1 and PR2, respectively, is required in order to calculate VO2 Model1. If the client has provided actual values for HRw, HR1, HR2, PR1, and PR2, then those values can be used. Otherwise, these values can be estimated by referring to the VO2 Max of General Population (FIG. 11). HRw values for various age brackets and genders are found in column D, HR1 in column F, PR1 in column G, HR2 in column H, and PR2 in column I. The VO2 Model1 can be calculated by:

VO2Modeli=C1821+C1824×HRw+C1825×HR1+C1828×PR1+C1826×HR2+C1829×PR2+C1827×PredVO2max+C1822×Clientage+3×C1823×HE20Second

where C1821-C1827 refers to the cells of FIG. 14. The VO2 ModellAgeGen is the same as VO2 TreadAgeGen. The model estimated VO2 max subscore Sᵥₘ can then be calculated by:

$${S}_{vm} = \{ \begin{matrix}F ( VO 2 Model 1 ) & if IVO 2 M = YES ; \\ NULL & if IVO 2 M = NO .\end{matrix}$$

where the function F( ) is the function used above for calculating the subscore of resting and treadmill estimated VO2 max.

The formula of S_{vm(AG)} is given by:

$${S}_{vm ( AG )} = \{ \begin{matrix}F ( VO 2 Model 1 AgeGen ) & if IVO 2 M = YES ; \\ NULL & if IVO 2 M = NO .\end{matrix}$$

Disease Risk

Disease Risk digital biomarker subscores can be generated to determine (estimate or predict) an individual or group's risk of developing certain diseases. In some embodiments, Disease Risk Health Subscores may be calculated based on incoming wellness information such as, without limitation, demographic information, Health Behaviours Subscores, family history, and other factors, as compared to corresponding data from the general population. In some embodiments, disease risk S_{DR} may, for example, be generated by calculating an average of the subscores generated for at least five different disease risk metrics including, without limitation, cardiovascular disease (S_{cardio}), diabetes (S_{diabet}), arthritis (Sₐᵣₜₕᵣᵢ), lung disease (S_{lung}), and lower back pain (S_{lbpain}). The disease risk subscore of the general population for any given age bracket and gender (S_{DR(AG)}) is the average of S_{cardio(AG)}, (S_{diabet(AG)}, S_{arthri(AG)}, S_{lung(AG)}, and S_{lbpain(AG)}. By way of example, embodiments showing methods of generating a cardiovascular disease subscore S_{cardio} are described, however it would be understood that similar methods may be used to determine health subscores for other disease risks.

Cardiovascular Disease

Accordingly, by way of example, a cardiovascular disease subscore can be generated based upon, at least, some or all of the incoming wellness information shown in FIG. 1. Additionally, general population information relating to, at least, steps, MV activity time, BMI, and waist can be used as a baseline with which to compare the individual or group. As would be known, normal blood pressure is typically defined as diastolic <90 and systolic <140. Logistic models, requiring various intercepts and coefficients used to predict the risk of cardiovascular disease, can be used to calculate the individual's cardiovascular disease risk CAvgRisk. A curve function can then be applied to CAvgRisk to obtain the cardiovascular disease subscore S_{cardio}.

First, ClientBPR must be determined, which is a function of ClientBPRDis and BPRSitu:

$$ClientBPR = \{ \begin{matrix}Y & if ClientBPRDis = Y and BPRt = N \\ N & otherwise .\end{matrix}$$

Then, ClientCardio must also be determined:

$$ClientCardio = \\ \{ \begin{matrix}Y & if ClientCarDis = Y and CardioSitu = \\ & “ Have disease but medication don ’ t make it normal ” \\ N & if ClientCarDis = N or \{ ClientCarDis = Y and CardioSitu = \\ & “ Have disease but medication makes it normal ” \} \\ FALSE & if ClientCarDis = Y and CardioSitu = NA\end{matrix}$$

The client's risk of cardiovascular disease CAvgRisk can be obtained by:

CAvgRisk=1/6(RCar1+RCar2+RCar3+RCar4+RCar5+RCar6)

where the RCar1, RCar2, RCar3, RCar4, Rcar5, Rcar6 are the risks calculated from six models with the following six groups of variables/factors, respectively:

1. ClientStepAvgActi&newClientBMI&ClientCarFamily

2. ClientMVAvgActi&ClientBMI&ClientCarFamily

3. ClientStepAvgActi&ClientBPR&ClientGender

4. newClientBMI&ClientBPR&ClientGender

5. ClientMVAvgActi&ClientBPR&ClientGender

6. ClientWaist&ClientGender,

The following are the formulae to calculate risk using the above models.

1. The risk RCar1 estimated based on ClientStepAvgActi, newClientBMI, ClientCarFamily is:

$$\begin{matrix}RCar 1 = CSBF ( ClientStepAvgActi , newClientBMI , ClientCarFamily ) \\ = \{ \begin{matrix}logistic ( {g}_{Y 1} ) & if ClientCarFamily = Y ; \\ logistic ( {g}_{N 1} ) & if ClientCarFamily = N ,\end{matrix}\end{matrix}$$

where CSBF( , , ) denotes RCar1 as a function of ClientStepAvgActi, newClientBMI, ClientCarFamily, the logistic( ) is the logistic function:

$$logistic ( x ) = \frac{exp ( x )}{1 + exp ( x )} ,$$

and

g_{Y1}=SBF1CIntO+SBF1CStO×ClientStepAvgActi+SBF1CBmO×newClientBMI+SBF1CStBmO×ClientStepAvgActi×newClientBMI:

g_{N1}=SBF2CIntO+SBF2CSO×ClientStepAvgActi+SBF2CBmO×newClientBMI+SBF2CStBmO×ClientStepAvgActi×newClientBMI:

2. The risk RCar2 estimated based on ClientMVAvgActi, ClientBMI, ClientCarFamily is:

$$\begin{matrix}RCar 2 = CMBF ( ClientMVAvgActi , ClientBMI , ClientCarFamily ) \\ = \{ \begin{matrix}logistic ( {g}_{Y 2} ) & if ClientCarFamily = Y ; \\ logistic ( {g}_{N 2} ) & if ClientCarFamily = N ,\end{matrix}\end{matrix}$$

where CSBF( , , ) denotes RCar2 as a function of ClientMVAvgActi, ClientBMI, ClientCarFamily, ClientCarFamily, and:

g_{Y2}=MBF1CIntO+MBF1CStO×ClientMVAvgActi+MBF1CBmO×ClientBMI+MBF1CStBmO×ClientMVAvgActi×ClientBMI:

g_{N2}=MBF2CIntO+MBF2CStO×ClientMVAvgActi+MBF2CBmO×ClientBMI+MBF2CStBmO×ClientMVAvgActi×ClientBMI:

3. The risk RCar3 estimated based on ClientStepAvgActi, ClientBPR and ClientGender is:

$$\begin{matrix}RCar 3 = CSP ( ClientStepAvgActi , ClientBPR , ClientGender ) \\ = \{ \begin{matrix}logistic ( {g}_{OY 3} ) & if ClientGender = NA and ClientBPR = Y ; \\ logistic ( {g}_{MY 3} ) & if ClientGender = M and ClientBPR = Y ; \\ logistic ( {g}_{FY 3} ) & if ClientGender = F and ClientBPR = Y ; \\ logistic ( {g}_{ON 3} ) & if ClientGender = NA and ClientBPR = N ; \\ logistic ( {g}_{MN 3} ) & if ClientGender = M and ClientBPR = N ; \\ logistic ( {g}_{FN 3} ) & if ClientGender = F and ClientBPR = N ,\end{matrix}\end{matrix}$$

where CSP( , , ) denotes RCar3 as function of ClientStepAvgActi, ClientBPR, ClientGender, and

g_{OY3}=BpCYStIntO+BpCYSO×ClientStepAvgActi;

g_{MY3}=BpCYStIntM+BpCYStM×ClientStepAvgActi;

g_{FY3}=BpCYStIntF+BpCYStF×ClientStepAvgActi;

g_{ON3}=BpCNStIntO+BpCNSO×ClientStepAvgActi;

g_{MN3}=BpCNStIntM+BpCNStM×ClientStepAvgActi;

g_{FN3}=BpCNStIntF+BpCNStF×ClientStepAvgActi;

4. The risk RCar4 estimated based on newClientBMI, ClientBPR and ClientGender is:

$$\begin{matrix}RCar 4 = CBP ( newClientBMI , ClientBPR , ClientGender ) \\ = \{ \begin{matrix}logistic ( {g}_{OY 4} ) & if ClientGender = NA and ClientBPR = Y ; \\ logistic ( {g}_{MY 4} ) & if ClientGender = M and ClientBPR = Y ; \\ logistic ( {g}_{FY 4} ) & if ClientGender = F and ClientBPR = Y ; \\ logistic ( {g}_{ON 4} ) & if ClientGender = NA and ClientBPR = N ; \\ logistic ( {g}_{MN 4} ) & if ClientGender = M and ClientBPR = N ; \\ logistic ( {g}_{FN 4} ) & if ClientGender = F and ClientBPR = N ,\end{matrix}\end{matrix}$$

where CBP( , , ) denotes RCarA as a function of newClientBMI, ClientBPR, ClientGender, and

g_{OY4}=BCYBmIntO+BpCYBmO×newClientBMI;

g_{MY4}=BpCYbMIntM+BpCYBmM×newClientBMI;

g_{FY4}=BpCYBmIntF+BpCYBmF×newClientBMI;

g_{ON4}=BpBmIntO+BpCNBmO×newClientBMI;

g_{MN4}=BpCNBmIntM+BpCNBmM×newClientBMI;

g_{FN4}=BpCNBmIntF+BpCNBmF×newClientBMI;

5. The risk RCar5 estimated based on ClientMVAvgActi, ClientBPR and ClientGender is:

$$\begin{matrix}RCar 5 = CMP ( ClientMVAvgActi , ClientBPR , ClientGender ) \\ = \{ \begin{matrix}logistic ( {g}_{OY 5} ) & if ClientGender = NA and ClientBPR = Y ; \\ logistic ( {g}_{MY 5} ) & if ClientGender = M and ClientBPR = Y ; \\ logistic ( {g}_{FY 5} ) & if ClientGender = F and ClientBPR = Y ; \\ logistic ( {g}_{ON 5} ) & if ClientGender = NA and ClientBPR = N ; \\ logistic ( {g}_{MN 5} ) & if ClientGender = M and ClientBPR = N ; \\ logistic ( {g}_{FN 5} ) & if ClientGender = F and ClientBPR = N ,\end{matrix}\end{matrix}$$

where CMP( , , ) denotes RCar5 as a function of ClientMVAvgActi, ClientBPR, ClientGender, and

g_{OY5}=BpCYMvIntO+BpCYMvO×ClientStepAvgActi;

g_{MY5}=BpCYMvIntM+BpCYMvM×ClientStepAvgActi;

g_{FY5}=BpCYMvIntF+BpCYMvF×ClientStepAvgActi;

g_{ON5}=BpCNMvIntO+BpCNMvO×ClientStepAvgActi;

g_{MN5}=BpCNMvIntM+BpCNMvM×ClientStepAvgActi;

g_{FN5}=BpCNMvIntF+BpCNMvF×ClientStepAvgActi;

6. The risk RCar6 estimated based on ClientWaist and ClientGender is:

$$\begin{matrix}RCar 6 = CW ( ClientWaist , ClientGender ) \\ = \{ \begin{matrix}logistic ( {g}_{O 6} ) & if ClientGender = NA ; \\ logistic ( {g}_{M 6} ) & if ClientGender = M ; \\ logistic ( {g}_{F 6} ) & if ClientGender = F ,\end{matrix}\end{matrix}$$

where CW( , , ) denotes RCar6 as a function of ClientWaist, ClientGender, and

g_{O6}=WCIntO+WCWcO×ClientWaist

g_{M6}=WCIntM+WCWcM×ClientWaist

g_{F6}=WCIntF+WCWcF×ClientWaist.

7. The formula of CAvgRiskSB is given by:

$$\begin{matrix}CAvgRiskSB = CSB ( ClientStepAvgActi , ClientBMI , ClientGender ) \\ = \{ \begin{matrix}logistic ( {g}_{O 7} ) & if ClientGender = NA ; \\ logistic ( {g}_{M 7} ) & if ClientGender = M ; \\ logistic ( {g}_{F 7} ) & if ClientGender = F ,\end{matrix}\end{matrix}$$

where CSB( , , ) denotes CAvgRiskSB as a function of ClientMVAvgActi, ClientBMI+ClientGender, and

g_{O7}=SBCIntO+SBCStO×ClientStepAvgActi+SBCBmO×newClientBMI+SBCStBmO×ClientStepAvgActi×newClientBMI:

g_{M7}=SBCIntM+SBCStM×ClientStepAvgActi+SBCBmM×newClientBMI+SBCStBmM×ClientStepAvgActi×newClientBMI:

g_{F7}=SBCIntF+SBCStF×ClientStepAvgActi+SBCBmF×newClientBMI+SBCStBmF×ClientStepAvgActi×newClientBMI.

The formulae for calculating the cardiovascular disease subscores S_{cardio} and S_{cardio(AG)} are given by:

$${S}_{cardio} = \\ \{ \begin{matrix}NULL & if N 594 = NO ; \\ FWellScoreCardio & if N 594 = YES and L 594 = \\ & “ Cardio ( compare to same group ) ” ; \\ FWellScoreCardioHel & if N 594 = YES and L 594 = \\ & “ Cardio ( compare to Healthy group ) ” ; \\ FWellScoreCardioSB & if N 594 = YES and L 594 = \\ & “ Cardio JUST Based on Steps \& BMI ” .\end{matrix} \\ {S}_{cardio ( AG )} = \\ \{ \begin{matrix}NULL & if N 594 = NO ; \\ FWellScoreCardioAGen & if N 594 = YES and L 594 = \\ & “ Cardio ( compare to same group ) ” ; \\ FWellScoreCardioHelAGen & if N 594 = YES and L 594 = \\ & “ Cardio ( compare to Healthy group ) ” ; \\ FWellScoreCardioAGenSB & if N 594 = YES and L 594 = \\ & “ Cardio JUST Based on Steps \& BMI ” .\end{matrix}$$

The formula of FWellScoreCardio is given by:

$$FWellScoreCardio = \{ \begin{matrix}NULL & if ClientCardio = Y or \\ & ClientCardio = FALSE ; \\ {y}_{0} & if ClientCardio = N and \\ & CAvgRisk < {x}_{c 0} ; \\ {f}_{c} ( CAvgRisk ; {SC}_{cardio} ) & if ClientCardio = N and \\ & {x}_{c 0} \leq CAvgRisk \geq {x}_{c 5} ; \\ {y}_{5} & if ClientCardio = N and \\ & CAvgRisk > {x}_{c 5} ,\end{matrix}$$

where SC_{cardio}={(x_{c0}, y₀), (x_{c1},y1), (x_{c2}, y2), (x_{c3}, y3), (x_{c4}, y4), (x_{c5}, y₅)} and

x_{c0}=CSBMP100;

x_{c1}=CSBMP80;

x_{c2}=CSBMP70;

x_{c3}=CSBMP50;

x_{c4}=CSBMP20;

x_{c5}=CSBMP0;

y₀=SCExcellent;

y₁=SCVgood;

y₂=SCGood;

y₃=SCFair;

y₄=SCPoor;

y₅=SCO

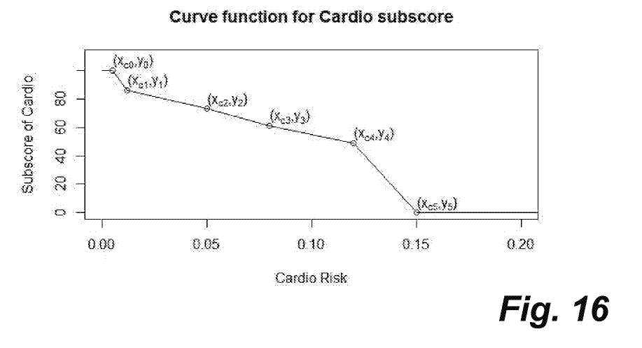

FIG. 16 shows the pattern of the curve function to be applied to the client's average risk of cardiovascular diseases CAvgRisk to obtain the cardiovascular diseases subscore where the (x_{c0}, y₀) and (x_{c5}, y₅), are (0.005, 100) and (0.15,0), respectively. The y₁, y₂, y₃, y₄ are fixed to be 86, 73, 61, 49, respectively. The x_{c1}, x_{c2}, x_{c3}, x_{c4} are calculated according to the population data and the client's age and gender. To do so, in an embodiment, four levels of numeric deciles (20%, 50%, 70%, and 80%) for each of ClientStepAvgActi, ClientMVAvgActi, ClientBMI and Client Waist with the given gender and age of the client. The deciles are ranked in the following “goodness order”:

Quartiles in goodness order

| Variables | Poor | Fair | Good | Verygood |
|---|---|---|---|---|
| ClientStepAvgActi | st₁ | st₂ | st₃ | st₄ |
| ClientBMI | bmi₁ | bmi₂ | bmi₂ | bmi₁ |
| ClientWaist | wai₁ | wai₃ | wai₂ | wai₁ |
| ClientMVAvgActi | mv₁ | mv₂ | mv₂ | mv₄ |

where the deciles of ClientStepAvgActi, ClientMVAvgActi, ClientBMI and ClientWaist are denoted as st, mv, bmi and wai, respectively. Their subscripts 1,2,3 and 4 are representing 20%, 50%, 70% and 80%, respectively.

For each of the models, four risks for cardiovascular diseases are calculated, ranging from poor, fair, good, and very good by applying the same calculation as was used in calculating RCar1, RCar2, RCar3, RCar4, RCar5, and RCar6 to those deciles, that is, all numeric variables can be replaced with corresponding deciles. The categorical variables remain the same.

1. The model based on ClientStepAvgActi, ClientBMI, and ClientCarFamily is:

R_{car1,poor}=CSBF(st₁, bmi₄, ClientCarFamily)

R_{car1,fair}=CSBF(st₂, bmi₃, ClientCarFamily)

R_{car1,good}=CSBF(st₃, bmi₂, ClientCarFamily)

R_{car1,excellent}=CSBF(st₄, bmi₁, ClientCarFamily)

2. The model based on ClientMVAvgActi, ClientBMI, and ClientGender is:

R_{car2,poor}=CMBF(mv₁, bm₄, ClientCarFamily)

R_{car2,fair}=CMBF(mv₂, bm₃, ClientCarFamily)

R_{car2,good}=CMBF(mv₃, bm₂, ClientCarFamily)

R_{car2,excellent}=CMBF(mv₄, bm₁, ClientCarFamily)

3. The model based on ClientStepAvgActi, ClientBPR, and ClientGender is:

R_{car3,poor}=CSP(st₁, ClientBPR, ClientGender)

R_{car3,fair}=CSP(st₂, ClientBPR, ClientGender)

R_{car3,good}=CSP(st₃, ClientBPR, ClientGender)

R_{car3,excellent}=CSP(st₄, ClientBPR, ClientGender)

4. The model based on ClientBMI, ClientBPR, and ClientGender is:

R_{car4,poor}=CBP(bmi₄, ClientBPR, ClientGender)

R_{car4,fair}=CBP(bmi₃, ClientBPR, ClientGender)

R_{car4,good}=CBP(bmi₂, ClientBPR, ClientGender)

R_{car4,excellent}=CBP(bmi₁, ClientBPR, ClientGender)

5. The model based on ClientMVAvgActi and ClientBPR and ClientGender is:

R_{car5,poor}=CMP(mv₁, ClientBPR, ClientGender)

R_{car5,fair}=CMP(mv₂, ClientBPR, ClientGender)

R_{car5,good}=CMP(mv₃, ClientBPR, ClientGender)

R_{car5,excellent}=CMP(mv₄, ClientBPR, ClientGender)

6. The model based on ClientWaist and ClientGender is:

R_{car6,poor}=CW(wai₄, ClientGender)

R_{car6,fair}=CW(wai₃, ClientGender)

R_{car6,good}=CW(wai₂, ClientGender)

R_{car6,excellent}=CW(wai₁, ClientBPR, ClientGender)

After the risks have been calculated, they can be averaged to obtain x_{c1}, x_{c2}, x_{c3}, x_{c4}:

$${x}_{c 1} = \frac{1}{6} {\sum }_{i = 1}^{6} {R}_{cari , excellent} ;$$

$${x}_{c 2} = \frac{1}{6} {\sum }_{i = 1}^{6} {R}_{cari , good} ;$$

$${x}_{c 3} = \frac{1}{6} {\sum }_{i = 1}^{6} {R}_{cari , fair} ;$$

$${x}_{c 4} = \frac{1}{6} {\sum }_{i = 1}^{6} {R}_{cari , poor}$$

7. To calculate FWellScoreCardioSB and FWellScoreCardioAGenSB, the following estimated deciles of cardio risks based on steps and BMI must be calculated:

R_{car7,poor}=CSB(st₁, bmi₄, ClientGender)

R_{car7,fair}=CSB(st₂, bmi₃, ClientGender)

R_{car7,good}=CSB(st₃, bmi₂, ClientGender)

R_{car7,excellent}=CSB(st₄, bmi₁, ClientGender)

Let f₂( , , , ) denote the CAvgRisk as a function of ClientStepAvgActi, ClientMVAvgActi, ClientBMI, and ClientWaist. That is:

CAvgRisk=f₂(ClientStepAvgActi, AvgMVGenAgeActi, ClientcBMI, ClientWaist)

Then the formula of CAvgRiskGenAge is:

CAvgRiskGenAge=f₂(AvgStepGenAgeActi, AvgMVGenAgeActi, ClientBMIGenAge, AvgWaistGenAge)

where AvgStepGenAgeActi (the average daily steps taken of the general population, separated into various age brackets and genders), ClientMVGenAge (the average daily minutes of MV), ClientBMIGenAge (the average BMI) and AvgWaistGenAge (the average waist size) are given by:

$$AvgStepGenAgeActi = \{ \begin{matrix}9224 & if ClientGender = NA and 20 \leq Clientage < 30 ; \\ 8830 & if ClientGender = NA and 30 \leq Clientage < 40 ; \\ 8941 & if ClientGender = NA and 40 \leq Clientage < 50 ; \\ 8264 & if ClientGender = NA and 50 \leq Clientage < 60 ; \\ 7368 & if ClientGender = NA and 60 \leq Clientage < 70 ; \\ 6237 & if ClientGender = NA and Clientage \geq 70 ; \\ 9848 & if ClientGender = M and 20 \leq Clientage < 30 ; \\ 9422 & if ClientGender = M and 30 \leq Clientage < 40 ; \\ 9837 & if ClientGender = M and 40 \leq Clientage < 50 ; \\ 8687 & if ClientGender = M and 50 \leq Clientage < 60 ; \\ 7878 & if ClientGender = M and 60 \leq Clientage < 70 ; \\ 6906 & if ClientGender = M and Clientage \geq 70 ; \\ 8534 & if ClientGender = F and 20 \leq Clientage < 30 ; \\ 8280 & if ClientGender = F and 30 \leq Clientage < 40 ; \\ 8010 & if ClientGender = F and 40 \leq Clientage < 50 ; \\ 7867 & if ClientGender = F and 50 \leq Clientage < 60 ; \\ 6880 & if ClientGender = F and 60 \leq Clientage < 70 ; \\ 5677 & if ClientGender = F and Clientage \geq 70.\end{matrix}$$

which are the mean average daily step counts for each age and gender bracket.

$$AvgMVGenAgeActi = \{ \begin{matrix}27.261345 & if ClientGender = NA and 20 \leq Clientage < 30 ; \\ 22.877719 & if ClientGender = NA and 30 \leq Clientage < 40 ; \\ 21.183897 & if ClientGender = NA and 40 \leq Clientage < 50 ; \\ 18.057031 & if ClientGender = NA and 50 \leq Clientage < 60 ; \\ 13.165338 & if ClientGender = NA and 60 \leq Clientage < 70 ; \\ 9.948715 & if ClientGender = NA and Clientage \geq 70 ; \\ 29.981944 & if ClientGender = M and 20 \leq Clientage < 30 ; \\ 25.991409 & if ClientGender = M and 30 \leq Clientage < 40 ; \\ 24.419647 & if ClientGender = M and 40 \leq Clientage < 50 ; \\ 18.855232 & if ClientGender = M and 50 \leq Clientage < 60 ; \\ 13.874513 & if ClientGender = M and 60 \leq Clientage < 70 ; \\ 11.686853 & if ClientGender = M and Clientage \geq 70 ; \\ 24.308956 & if ClientGender = F and 20 \leq Clientage < 30 ; \\ 20.014397 & if ClientGender = F and 30 \leq Clientage < 40 ; \\ 17.935525 & if ClientGender = F and 40 \leq Clientage < 50 ; \\ 17.30886 & if ClientGender = F and 50 \leq Clientage < 60 ; \\ 12.49993 & if ClientGender = F and 60 \leq Clientage < 70 ; \\ 8.529676 & if ClientGender = F and Clientage \geq 70.\end{matrix}$$

which are the mean average daily minutes of MV for each age and gender bracket.

$$ClientBMIGenAge = \{ \begin{matrix}26 & if ClientGender = NA and 20 \leq Clientage < 30 ; \\ 28 & if ClientGender = NA and 30 \leq Clientage < 40 ; \\ 28 & if ClientGender = NA and 40 \leq Clientage < 50 ; \\ 28 & if ClientGender = NA and 50 \leq Clientage < 60 ; \\ 28 & if ClientGender = NA and 60 \leq Clientage < 70 ; \\ 28 & if ClientGender = NA and Clientage \geq 70 ; \\ 25 & if ClientGender = M and 20 \leq Clientage < 30 ; \\ 27 & if ClientGender = M and 30 \leq Clientage < 40 ; \\ 28 & if ClientGender = M and 40 \leq Clientage < 50 ; \\ 29 & if ClientGender = M and 50 \leq Clientage < 60 ; \\ 28 & if ClientGender = M and 60 \leq Clientage < 70 ; \\ 28 & if ClientGender = M and Clientage \geq 70 ; \\ 28 & if ClientGender = F and 20 \leq Clientage < 30 ; \\ 29 & if ClientGender = F and 30 \leq Clientage < 40 ; \\ 29.23 & if ClientGender = F and 40 \leq Clientage < 50 ; \\ 27 & if ClientGender = F and 50 \leq Clientage < 60 ; \\ 28 & if ClientGender = F and 60 \leq Clientage < 70 ; \\ 27 & if ClientGender = F and Clientage \geq 70\end{matrix} .$$

which are the mean average BMI for each age and gender bracket.

$$AvgWaistGenAge = \{ \begin{matrix}85.53 & if ClientGender = NA and 20 \leq Clientage < 30 ; \\ 89.95 & if ClientGender = NA and 30 \leq Clientage < 40 ; \\ 92.88 & if ClientGender = NA and 40 \leq Clientage < 50 ; \\ 95.34 & if ClientGender = NA and 50 \leq Clientage < 60 ; \\ 97.38 & if ClientGender = NA and 60 \leq Clientage < 70 ; \\ 96.39 & if ClientGender = NA and Clientage \geq 70 ; \\ 87.24 & if ClientGender = M and 20 \leq Clientage < 30 ; \\ 94 & if ClientGender = M and 30 \leq Clientage < 40 ; \\ 96.85 & if ClientGender = M and 40 \leq Clientage < 50 ; \\ 101.26 & if ClientGender = M and 50 \leq Clientage < 60 ; \\ 102.6 & if ClientGender = M and 60 \leq Clientage < 70 ; \\ 101.57 & if ClientGender = M and Clientage \geq 70 ; \\ 83.61 & if ClientGender = F and 20 \leq Clientage < 30 ; \\ 85.98 & if ClientGender = F and 30 \leq Clientage < 40 ; \\ 88.79 & if ClientGender = F and 40 \leq Clientage < 50 ; \\ 89.79 & if ClientGender = F and 50 \leq Clientage < 60 ; \\ 92.45 & if ClientGender = F and 60 \leq Clientage < 70 ; \\ 92.05 & if ClientGender = F and Clientage \geq 70\end{matrix} .$$

which are the mean average waist sizes for each age and gender bracket.

The formula for FWellScoreCardioAGen is given by:

$$FWellScoreCardioAGen = \{ \begin{matrix}NULL & \begin{matrix}if ClientCardio = Y \\ or ClientCardio = FALSE ;\end{matrix} \\ {𝓎}_{0} & \begin{matrix}if ClientCardio = N \\ and CAvgRisk < {x}_{c 0} ;\end{matrix} \\ {f}_{c} ( CAvgRiskGenAge ; {SC}_{cardio} ) & \begin{matrix}if ClientCardio = N \\ and {x}_{c 0} \leq CAvgRisk \geq {x}_{c 5} ;\end{matrix} \\ {𝓎}_{5} & \begin{matrix}if ClientCardio = N \\ and CAvgRisk > {x}_{c 5}\end{matrix}\end{matrix} ,$$

The FellWellScoreCardioSB and FWellScoreCardioAGenSB is obtained by:

FWellScoreCardioSB=f_{c}(CAvgRiskSB; SC_{cardio,SB});

FWellScoreCardioAGenSB=f_{c}(RCarStBMIGenAge; SC_{cardio,SB}),

where SC_{cardio,SB}={(x_{csb0}, y₀), (x_{csb1}, y₁), (x_{csb2}, y₂), (x_{cbs3}, y₃), (x_{csb4}, y₄), (x_{csb5}, y₅)} and

x_{csb0}=CarStBm100;

x_{csb1}=CarStBm80;

x_{csb2}=CarStBm70;

x_{csb3}=CarStBm50;

x_{csb4}=CarStBm20;

x_{csb5}=CarStBm0;

y₀, y₁, y₂, y₃, y₄, y₅ are obtained as explained in the calculation of FWellScoreCardio. The x_{csb0} and x_{csb5} are set to be 0.005 and 0.24, respectively. X_{csb1}, x_{csb2}, x_{csb3}, x_{csb4} are calculated by the following formulae:

x_{csb1}=R_{car7,excellent};

x_{csb2}=R_{car7,good};

x_{csb3}=R_{car7,fair};

x_{csb4}=R_{car7,poor};

The RCarStBMIGenAge is given by:

RCarStBHIGenAge=CSB(AvgStepGenAgeActi, ClientBMIGenAge, ClientGender)

The subscores compared to healthy people in the population is calculated by:

$$FWellScoreCardioHel = \{ \begin{matrix}NULL & \begin{matrix}if ClientCardio = Y \\ or ClientCardio = FALSE ;\end{matrix} \\ {𝓎}_{0} & \begin{matrix}if ClientCardio = N \\ and CAvgRisk < {x}_{c 0} ;\end{matrix} \\ \begin{matrix}{f}_{c} ( CAvgRisk ; {SC}_{cardio , H} ) \\ \end{matrix} & \begin{matrix}if ClientCardio = N \\ and {x}_{c 0} \leq CAvgRisk \geq {x}_{c 5} ;\end{matrix} \\ {𝓎}_{5} & \begin{matrix}if ClientCardio = N \\ and CAvgRisk > {x}_{c 5}\end{matrix}\end{matrix} , \\ FWellScoreCardioHelAGen = \{ \begin{matrix}NULL & \begin{matrix}if ClientCardio = Y \\ or ClientCardio = FALSE ;\end{matrix} \\ {𝓎}_{0} & \begin{matrix}if ClientCardio = N \\ and CAvgRisk < {x}_{c 0} ;\end{matrix} \\ {f}_{c} ( CAvgRiskGenAge ; {SC}_{cardio , H} ) & \begin{matrix}if ClientCardio = N \\ and {x}_{c 0} \leq CAvgRisk \geq {x}_{c 5} ;\end{matrix} \\ \begin{matrix}{𝓎}_{5} \\ \end{matrix} & \begin{matrix}if ClientCardio = N \\ and CAvgRisk > {x}_{c 5}\end{matrix}\end{matrix} ,$$

where SC_{cardio,H}=|{(x_{ch0}, y₀), (x_{ch1}, y₁), (x_{ch2}, y₂), (x_{ch3}, y₃), (x_{ch4}, y₄), (x_{ch5}, y₅)}, x_{ch0}=0.005, x_{ch5}=0.15 and x_{ch1}, c_{ch2}, x_{ch3}, x_{ch4} are calculated in the same way as x_{c1}, c_{c2}, x_{c3}, x_{c4}, were calculated, but with fixed values for ClientBPR and ClientCarFamily such that clientBPR=N; ClientCarFamily=N.

Diabetes

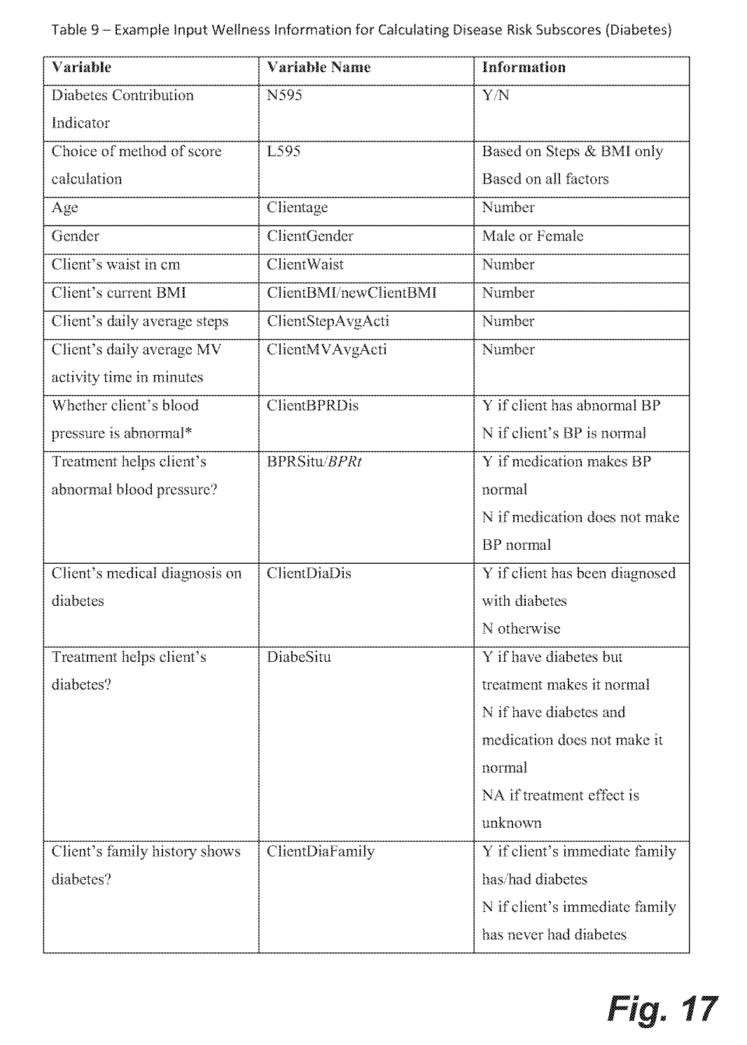

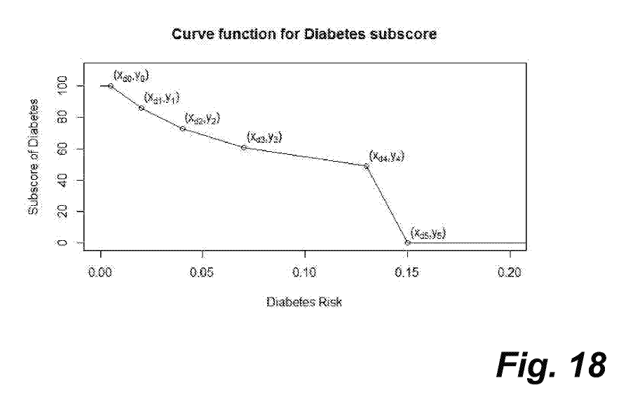

As above, other disease risk Health Subscores, such as diabetes, may be determined according to embodiments herein. Briefly, a digital biomarker for diabetes risk may be generated using at least some or all of the input information shown in FIG. 17. Additionally, population data regarding steps, MV activity time, BMI, and waist can be used as a baseline with which to compare the client. As with the cardiovascular disease subscore, logistic models and curve functions can be used to calculate the client's diabetes risk DAvgRisk. A curve function can then be applied to DAvgRisk to obtain the diabetes subscore S_{diabet}, using various logistic models requiring predetermined intercepts and coefficients. As above, the formulae for calculating the diabetes subscores S_{diabet} and S_{diabet(AG)} are given by:

$${S}_{diabet} = \{ \begin{matrix}NULL & if N 595 = NO ; \\ FWellScoreDiabeSB & if N 595 = YES and \\ & L 595 = “ Diabetes Based on \\ & JUST Steps \& BMI ” ; \\ FWellScoreDiabe & if N 595 = YES and \\ & L 595 = “ Diabetes Based on All Factors ”\end{matrix} , \\ {S}_{diabet ( AG )} = \{ \begin{matrix}NULL & if N 595 = NO ; \\ FWellScoreDiabeSBAGen & \begin{matrix}if N 595 = YES and \\ L 595 = “ Diabetes Based on \\ JUST Steps \& BMI ” ;\end{matrix} \\ FWellScoreDiabeAGen & \begin{matrix}if N 595 = YES and \\ L 595 = “ Diabetes Based on \\ All Factors ”\end{matrix}\end{matrix} .$$

where FWellScoreDiabe=f_{c}(DAvgRisk; SD), where SD={(x_{d0}, y₀), (x_{d1}, y₁), (x_{d2}, y₂), (x_{d3}, y₃), (x_{d4}, y₄), (x_{d5}, y₅)},
x_{d0}=DSBMP100;
x_{d1}=DSBMP80;
x_{d2}=DSBMP70;
x_{d3}=DSBMP50;
x_{d4}=DSBMP20;
x_{d5}=DSBMP0;

where the (x_{d0}, y₀) and (x_{d5}, y₅) are (0.015, 100) and (0.153, 0), respectively. The y₁, y₂, y₃, y₄, are fixed to be 86, 73, 61, and 49, respectively. The x_{d1}, x_{d2}, x_{d3}, x_{d4} are calculated according to the population data and the client's age and gender, as was done for x_{c1}, c_{c2}, x_{c3}, x_{c4} in the cardiovascular disease section above. A plot showing the pattern of the curve function to be applied to the client's average risk of diabetes DAvgRisk to obtain the diabetes subscore is shown in FIG. 18. For each one of the models, four risks for diabetes are calculated ranging from poor, fair, good, and very good by applying the same calculation as used to calculate RDia1, RDia2, RDia3, and RDia4 to those deciles. As with cardiovascular risk above, all numeric variables can be replaced with corresponding deciles. The categorical variables remain the same.

Arthritis

As above, other disease risk Health Subscores, such as arthritis, may be determined according to embodiments herein. Briefly, a digital biomarker of arthritis risk may be generated using at least some or all of the incoming wellness information including, without limitation, age, gender, waist in cm, current BMI, daily average steps, daily average MV activity in minutes, medical diagnosis on arthritis, treatment that helps arthritis, etc. Additionally, population data regarding steps, MV activity time, BMI, and waist can be used as a baseline with which to compare the client. As with the other disease subscores, logistic models can be used to calculate the client's arthritis risk AAvgRisk. Logistic models requiring various predetermined intercepts and coefficients are used. A curve function can then be applied to AAvgRisk to obtain the arthritis subscore Sarthn. The formulae for calculating the arthritis subscores Sₐᵣₜₕᵣᵢ and S_{arthri(AG)} are given by:

$${S}_{arthri} = \{ \begin{matrix}NULL & if N 596 = NO ; \\ {f}_{c} ( AAvgRisk ; SA ) & if N 596 = YES\end{matrix} , \\ {S}_{arthri ( AG )} = \{ \begin{matrix}NULL & if N 596 = NO ; \\ {f}_{c} ( AAvgRiskAgeGen ; SA ) & if N 596 = YES\end{matrix} ,$$

where SA={(xₐ₀, y₀), (xₐ₁, y₁), (xₐ₂, y₂), (xₐ₃, y₃), (xₐ₄, y₄), (xₐ₅, y₅)}.

xₐ₀=ASBMP100;

xₐ₁=ASBMP80;

xₐ₂=ASBMP70;

xₐ₃=ASBMP50;

xₐ₄=ASBMP20;

xₐ₅=ASBMP0;

where the (xₐ₀, y₀) and (xₐ₅, y₅) are (0.015, 100) and (0.4, 0) respectively. The y₁, y₂, y₃, y₄are fixed to be 86, 73, 61, 49 respectively. The xₐ₁, xₐ₂, xₐ₃, xₐ₄ are calculated according to the population data and the client's age and gender, as was done for x_{c1}, c_{c2}, x_{c3}, x_{c4} in the cardiovascular disease section above. For each one of the models, four risks of arthritis are calculated ranging from poor, fair, good, and very good by applying the same calculation as in calculating RArt1, RArt2, RArt3 to those deciles. As with cardiovascular risk and diabetes risk above, all numeric variables can be replaced with corresponding deciles. The categorical variables remain the same.

Lung Disease

As above, other disease risk Health Subscores, such as lung disease, may be determined according to embodiments herein. Briefly, a digital biomarker of lung disease risk may be generated using at least some or all of the incoming wellness information including, without limitation, age, gender, waist in cm, current BMI, daily average steps, daily average MV activity in minutes, medical diagnosis on lung disease, treatment that helps lung disease, etc. Additionally, population data regarding steps, MV activity time, BMI, and waist can be used as a baseline with which to compare the client. As above, logistic models and curve functions can be used to calculate the client's lung disease risk LAvgRisk. A curve function can then be applied to LAvgRisk to obtain the lung disease subscore S_{lung}, using various logistic models requiring predetermined intercepts and coefficients. The risk of lung disease LAvgRisk can be obtained by:

LAvgRisk=1/3(RLun1+RLun2+RLun3)

where the RLun1, RLun2, RLun3 are the risks calculated from three models with a plurality of

variables/factors. The formulae for calculating the lung disease subscores S_{lung} and S_{lung(AG)} are given by:

$${S}_{lung} = \{ \begin{matrix}NULL & if N 597 = NO ; \\ {f}_{c} ( LAvgRisk ; SL ) & if N 597 = YES\end{matrix} , \\ {S}_{lung ( AG )} = \{ \begin{matrix}NULL & if N 597 = NO ; \\ {f}_{c} ( LAvgRiskAgeGen ; SL ) & if N 597 = YES\end{matrix} ,$$

where SL={(xₗ₀, y₀), (xₗ₁, y₁), (xₗ₂, y₂), (xₗ₃, y₃), (xₗ₄, y₄), (xₗ₅, y₅)}. And

xₗ₀=LSBMP100;

xₗ₁=LSBMP80;

xₗ₂=LSBMP70;

xₗ₃=LSBMP50;

xₗ₄=LSBMP20;

xₗ₅=LSBMP0;

where the (xₗ₀,y₀) and (xₗ₅, y₅) are (0.015, 100) and (0.18, 0), respectively. The y₁, y₂, y₃, y₄are fixed to be 86, 73, 61, 49 respectively. The xₗ₁, xₗ₂, xₗ₃, xₗ₄ are calculated according to the population data and the client's age and gender, as was done for x_{c1}, c_{c2}, x_{c3}, x_{c4} in the cardiovascular disease section above. For each one of the models, four risks of arthritis are calculated ranging from poor, fair, good, and very good by applying the same calculation as in calculating Rlun1, Rlun2, Rlun3 to those deciles. As with cardiovascular risk, diabetes risk, and arthritis risk above, all numeric variables can be replaced with corresponding deciles. The categorical variables may remain the same.

Body Pain

As above, other disease risk health subscores, such as body pain, back pain (e.g., lower back pain), may be determined according to embodiments herein. Briefly, lower back pain risk health subscores may be generated using at least some or all of input information including, without limitation, age, gender, waist in cm, current BMI, daily average steps, daily average MV activity in minutes, medical diagnosis on lower back pain, treatment that helps lower back pain, etc. Additionally, population data regarding steps, MV activity time, BMI, and waist can be used as a baseline with which to compare the client. As above, population data regarding steps, MV activity time, BMI, and waist can be used as a baseline with which to compare the client. As with the other disease risk subscores, logistic models and curve functions can be used to calculate the client's lower back pain risk BAvgRisk. A curve function can then be applied to BAvgRisk to obtain the arthritis subscore Sibpam, using various logistic models requiring predetermined intercepts and coefficients. The risk of lower back pain BAvgRisk can be obtained by:

BAvgRisk=1/3(RLbp1+RLbp2+RLbp3)

where the RLbp1, RLbp2, RLbp3 are the risks calculated from the logistic models with at least three groups of variables/factors. The formulae for calculating the lower back pain subscores S_{lbpain} and S_{lbpain(AG)} are given by:

$${S}_{lbpain} = \{ \begin{matrix}NULL & if N 598 = NO ; \\ {f}_{c} ( BAvgRisk ; SB ) & if N 598 = YES\end{matrix} , \\ {S}_{lbpain ( AG )} = \{ \begin{matrix}NULL & if N 598 = NO ; \\ {f}_{c} ( BAvgRiskAgeGen ; SB ) & if N 598 = YES\end{matrix} ,$$

where SB={(x_{b0}, y₀), (x_{b1}, y₁), (x_{b2}, y₂), (x_{b3}, y₃), (x_{b4}, y₄), (x_{b5}, y₅)}. And

x_{b0}=BSBMP100;

x_{b1}=BSBMP80;

x_{b2}=BSBMP70;

x_{b3}=BSBMP50;

x_{b4}=BSBMP20;

x_{b5}=BSBMP0;

where the (x_{b0},y₀) and (x_{b5}, y₅) are (0.015, 100) and (0.18, 0), respectively. The y₁, y₂, y₃, y₄are fixed to be 86, 73, 61, 49 respectively. The x_{lb1}, x_{lb2}, x_{lb3}, x_{lb4} are calculated according to the population data and the client's age and gender, as was done for x_{c1}, c_{c2}, x_{c3}, x_{c4} in the cardiovascular disease section above. For each one of the models, four risks of arthritis are calculated ranging from poor, fair, good, and very good by applying the same calculation as in calculating RLbp1, RLbp2, RLbp3 to those deciles. As with cardiovascular risk and diabetes risk above, all numeric variables can be replaced with corresponding deciles. The categorical variables remain the same.

Mental Health (or “VivaMind Score”)

According to further embodiments herein, the present systems and methods may also provide Health Subscore indicative of the individual or group's mental health (referred to as a “VivaMind Score”; S_{VM}). Herein, a VivaMind Health Subscore may be generated using incoming wellness information relating to different mental health metrics including, without limitation, stress level (Sₛₜₛ), level of happiness (Sₗₕ), depression (S_{dep}), and model based happiness analysis (Sₕₐ), as compared against the general population. VivaMind subscores relating to the general population for any given age bracket and gender (S_{VM(AG)}) may comprise the average of S_{sts(AG)}, S_{lh(AG)}, S_{dep(AG)}, and S_{ha(AG)}. By way of example, the presents methods of calculating subscores stress level (Sₛₜₛ), level of happiness (Sₗₕ), depression (S_{dep}), and model based happiness analysis (Sₕₐ) are described below.

Stress

A stress subscore Sₛₜₛ may be generated based on the inputs of a stress contribution indicator (D610), which is a yes/no value that determines whether the stress subscore contributes to the calculation of the client's overall wellness score, and the client's rating of his/her stress level (StressLevel). The possible answers for StressLevel are: “not at all stressful”, “not very stressful”, “a bit stressful”, “quite a bit stressful”, and “extremely stressful”.

The stress subscore Sₛₜₛ is given by:

$${S}_{sts} = \{ \begin{matrix}NULL & if D 610 = NO ; \\ 100 & \begin{matrix}if D 610 = YES and \\ StressLevel = NOT AT ALL STRESSFUL ;\end{matrix} \\ 80 & \begin{matrix}if D 610 = YES and \\ StressLevel = NOT VERY STRESSFUL ;\end{matrix} \\ 65 & \begin{matrix}if D 610 = YES and \\ StressLevel = A BIT STRESSFUL ;\end{matrix} \\ 50 & \begin{matrix}if D 610 = YES and \\ StressLevel = QUITE A BIT STRESSFUL ;\end{matrix} \\ 0 & \begin{matrix}if D 610 = YES and \\ StressLevel = EXTREMELY STRESSFUL\end{matrix}\end{matrix} ;$$

The subscore S_{sts(AG)} is calculated based on contribution indicator (D610), the client's age (Clientage), and population distribution among the five levels of stress in various age categories. Such data can be tabulated and stored, such as in an Excel™ spreadsheet as shown, for example, in FIG. 19.

If D610=YES, the formula of S_{sts(AG)} is

$${S}_{sts ( AG )} = \{ \begin{matrix}\begin{matrix}100 \times C 2276 + 85 \times C 2277 + \\ 65 \times C 2278 + 45 \times C 2279\end{matrix} & if Clientage < 30 ; \\ \begin{matrix}100 \times D 2276 + 85 \times D 2277 + \\ 65 \times D 2278 + 45 \times D 2279\end{matrix} & if 30 \leq Clientage < 40 ; \\ \begin{matrix}100 \times E 2276 + 85 \times E 2277 + \\ 65 \times E 2278 + 45 \times E 2279\end{matrix} & if 40 \leq Clientage < 50 ; \\ \begin{matrix}100 \times F 2276 + 85 \times F 2277 + \\ 65 \times F 2278 + 45 \times F 2279\end{matrix} & if 50 \leq Clientage < 60 ; \\ \begin{matrix}100 \times G 2276 + 85 \times G 2277 + \\ 65 \times G 2278 + 45 \times G 2279\end{matrix} & if Clientage \geq 60\end{matrix} .$$

where C-G combined with numbers 2276-2279 refer to the cells of FIG. 19, containing percentages of the population who belong to each of the five levels of stress, divided into five age intervals (20-29, 30-39, 40-49, 50-59, and 60+). If D610=NO, then S_{sts(AG)}=NULL.

Happiness Level

A happiness subscore Sₗₕ may be generated based on the inputs of a happiness contribution indicator (D611), which is ayes/no value that determines whether the hapiness subscore contributes to the calculation of the client's overall wellness score, and the client's rating of his/her happiness level (HappinessLevel). The possible answers for HappinessLevel are: “Happy and interested in life”, “Somewhat happy”, “Somewhat unhappy”, “Unhappy with little interest in life”, and “So unhappy that life is not worthwhile”.

The happiness subscore Sₗₕ is given by:

$${S}_{th} = \{ \begin{matrix}NULL & if D 611 = NO ; \\ 100 & \begin{matrix}if D 611 = YES and \\ HappinessLevel = HAPPY AND INTERESTED IN LIFE ;\end{matrix} \\ 80 & \begin{matrix}if D 611 = YES and \\ HappinessLevel = SOMEWHAT HAPPY ;\end{matrix} \\ 65 & \begin{matrix}if D 611 = YES and \\ HappinessLevel = SOMEWHAT UNHAPPY ;\end{matrix} \\ 50 & \begin{matrix}if D 611 = YES and \\ HappinessLevel = UNHAPPY WITH LITTLE INTEREST \\ IN LIFE ;\end{matrix} \\ 0 & \begin{matrix}if D 611 = YES and \\ HappinessLevel = SO UNHAPPY THAT LIFE IS NOT \\ WORTHWHILE\end{matrix}\end{matrix} .$$

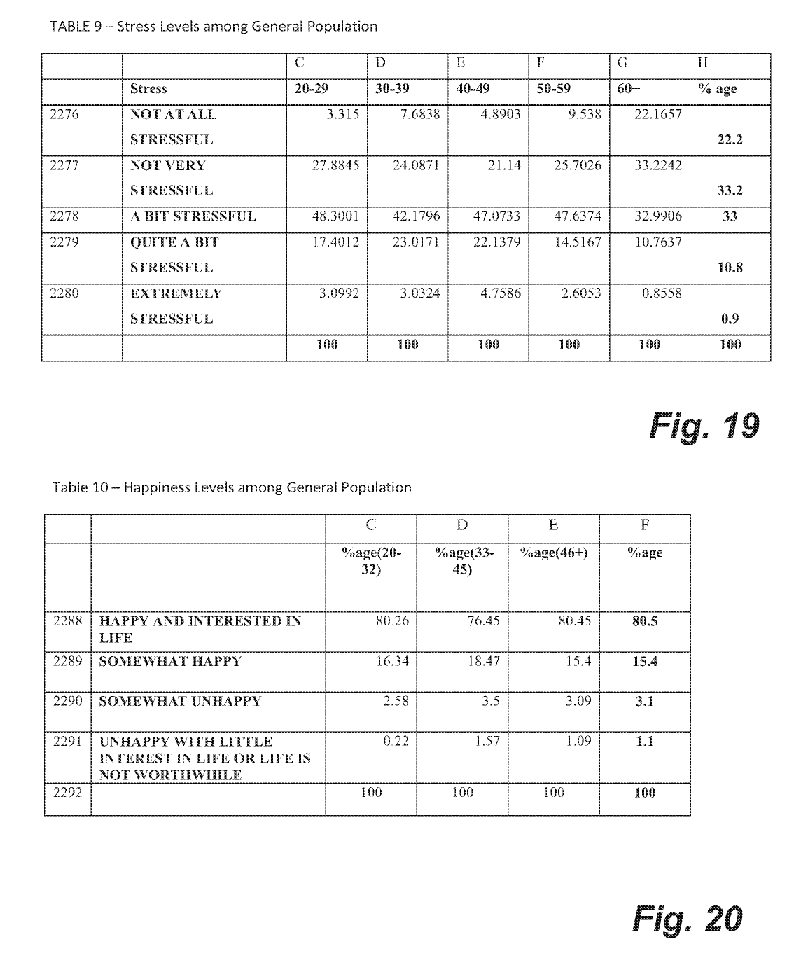

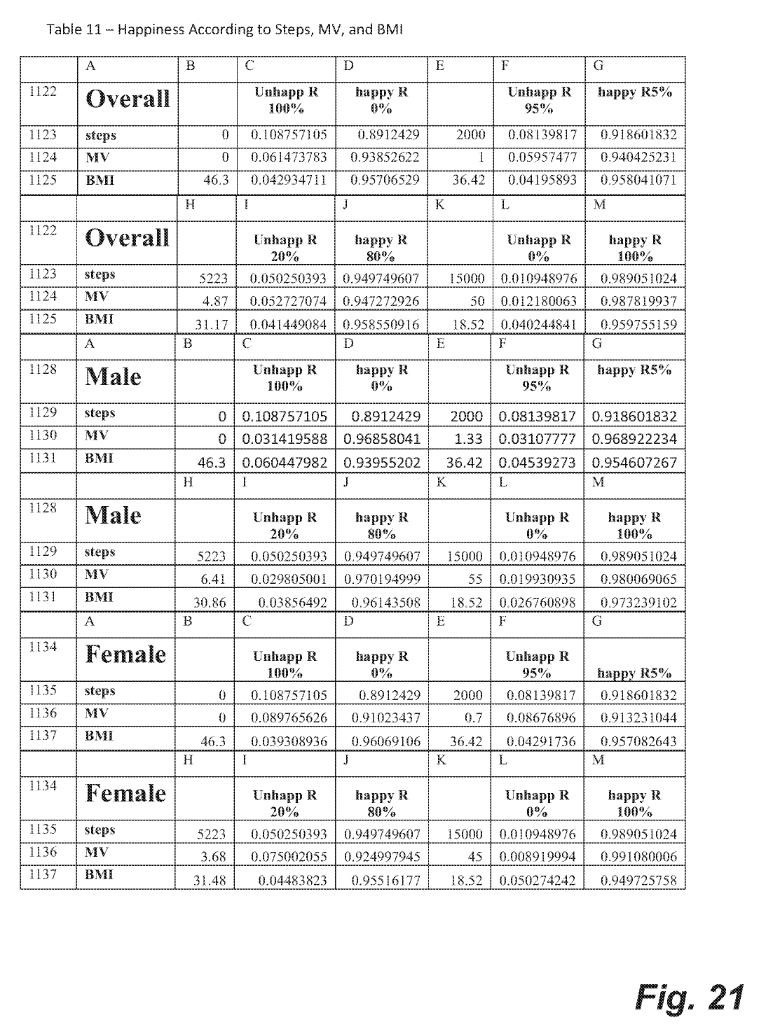

The subscore S_{lh(AG)} is calculated based on contribution indicator (D611), the client's age (Clientage), and population distribution among the top four happiness levels (with “Unhappy with little interest in life” and “So unhappy that life is not worthwhile” levels being combined) in various age categories. Such data can be tabulated and stored, such as in an Excel™ spreadsheet as shown, for example, in FIG. 20.

If D611= YES, the formula of S_{lh(AG)} is

$${S}_{th ( AG )} = \{ \begin{matrix}\begin{matrix}100 \times C 2288 + 75 \times \\ C 2289 + 50 \times C 2290\end{matrix} & if 20 \leq Clientage < 33 ; \\ \begin{matrix}100 \times D 2288 + 75 \times \\ D 2289 + 50 \times D 2290\end{matrix} & if 33 \leq Clientage < 46 ; \\ \begin{matrix}100 \times E 2288 + 75 \times \\ E 2289 + 50 \times E 2290\end{matrix} & \begin{matrix}if Clientage \geq 46 \\ \end{matrix}\end{matrix} ;$$

where C-E combined with numbers 2288-2290 refer to the cells of FIG. 20, containing percentages of the top four levels of happiness for the above three age intervals (20-32, 33-34, and 36+). If D611=NO, then S_{lh(AG)}=NULL.

Depression

As above, a depression subscore S_{dep} may be generated based upon at least, one or more inputs including age, gender, current BMI, daily average steps, medical diagnosis on depression, treatment that helps depression, etc. As with disease risk subscores above, logistic models and curve functions can be used to calculate the client's depression risk DepAvgRisk. A curve function can then be applied to DepAvgRisk to obtain the depression subscore S_{dep}, utilizing various logistics models requiring predetermined intercepts and coefficients. In some embodiments, the risk of depression can be calculated. In other embodiments, the formulae for calculating the depression subscores S_{dep} and S_{dep(AG)} are given by:

$${S}_{dep} = \{ \begin{matrix}NULL & if D 613 = NO ; \\ {f}_{c} ( DepAvgRisk ; S Dep ) & if D 613 = YES\end{matrix} , \\ {S}_{dep ( AG )} = \{ \begin{matrix}NULL & if D 613 = NO ; \\ {f}_{c} ( DepAvgRiskAgeGen ; S Dep ) & if D 613 = YES\end{matrix} ,$$

where SDep={(x_{dep0}, y₀), (x_{dep1},y₁), (x_{dep2}, y₂), (x_{dep3}, y₃), (x_{dep4}, y₄), (x_{dep5}, y₅)}, and

x_{dep0}=DepSBM100;

x_{dep1}=DepSBM80;

x_{dep2}=DepSBM70;

x_{dep3}=DepSBM50;

x_{dep4}=DepSBM20;

x_{dep5}=DepSBM0;

where the (x_{dep0},y₀) and (x_{dep5}, y₅) are (0.015, 100) and (0.18, 0), respectively. The y₁, y₂, y₃, y₄are fixed to be 86, 73, 61, 49 respectively. The x_{dep1}, x_{dep2}, x_{dep3}, x_{dep4} are calculated according to the population data and the client's age and gender, as was done in the disease risk analysis described herein. For each of the models, at least four risks for depression can be calculated, ranging from poor, fair, good, and very good by applying the same calculation as was used in calculating DepAvgRisk to those deciles, that is, all numeric variables can be replaced with corresponding deciles. The categorical variables remain the same.

Model Based Happiness

As above, a model based happiness subscore S_{ha(AG)} may be generated based upon at least, one or more inputs including gender, current BMI, daily average steps, daily average MV activity in minutes, etc. As with depression and the disease risk subscores above, logistic models and various parameters/constants can be used to calculate the client's risk of unhappiness utilizing various logistic models requiring predetermined intercepts and coefficients. The risk of unhappiness can be calculated from the client's BMI UnHBMI, risk of unhappiness calculated from client's MV UnHMv, and risk of unhappiness calculated from client's step count UnHSt. The formulae for calculating the model based happiness subscores Sₕₐ and S_{ha(AG)} are given by:

$${S}_{happ} = \{ \begin{matrix}NULL & if D 612 = NO ; \\ ( HapStScour + HapMvScour ) / 2 & if D 612 = YES \\ & \begin{matrix}and HapBmiScour = \\ Low BMI ;\end{matrix} \\ \begin{matrix}( HapStScour + HapMvScour + \\ HapBmiScour )\end{matrix} / 3 & otherwise\end{matrix} . \\ {S}_{ha ( AG )} = \{ \begin{matrix}NULL & if D 612 = NO ; \\ \frac{\begin{matrix}HapStScourGenAge + HapMvScourGenAge + \\ HapBmiScourGenAge\end{matrix}}{3} & if D 612 = YES\end{matrix} .$$

To calculate the subscores, three sub-subscores HapStScout, HapMvScour, and HapBmiScourt must be calculated:

$$HapBmiScour = \{ \begin{matrix}Low BMI & if ClientBMI < 18.5 \\ 70 + ( 100 - 70 ) \times \frac{1 - UnHBMI - HapBMI 80}{HapBMI 100 - HapBMI 80} & \begin{matrix}if 18.5 \leq ClientBMI \leq 31.17 \\ and ClientGender = NA\end{matrix} \\ 50 + ( 69 - 50 ) \times \frac{1 - UnHBMI - HapBMI 5}{HapBMI 80 - HapBMI 5} & \begin{matrix}if 31.17 < ClientBMI \leq 36.42 \\ and ClientGender = NA\end{matrix} \\ ( 49 - 0 ) \times \frac{1 - UnHBMI - HapBMI 0}{HapBMI 5 - HapBMI 0} & \begin{matrix}if 36.42 < ClientBMI \leq 46.3 \\ and ClientGender = NA\end{matrix} \\ 0 & \begin{matrix}if ClientBMI > 46.3 \\ and ClientGender = NA\end{matrix} \\ 70 + ( 100 - 70 ) \times \frac{1 - UnHBMI - HapBMI 80 M}{HapBMI 100 M - HapBMI 80 M} & \begin{matrix}if 18.5 \leq ClientBMI \leq 30.86 \\ and ClientGender = M\end{matrix} \\ 50 + ( 69 - 50 ) \times \frac{1 - UnHBMI - HapBMI 5 M}{HapBMI 80 M - HapBMI 5 M} & \begin{matrix}if 30.86 < ClientBMI \leq 36.42 \\ and ClientGender = M\end{matrix} \\ ( 49 - 0 ) \times \frac{1 - UnHBMI - HapBMI 0 M}{HapBMI 5 M - HapBMI 0 M} & \begin{matrix}if 36.42 < ClientBMI \leq 46.3 \\ and ClientGender = M\end{matrix} \\ 0 & \begin{matrix}if ClientBMI > 46.3 \\ and ClientGender = M\end{matrix} \\ 70 + ( 100 - 70 ) \times \frac{1 - UnHBMI - HapBMI 80 F}{HapBMI 100 F - HapBMI 80 F} & \begin{matrix}if 18.5 \leq ClientBMI \leq 31.48 \\ and ClientGender = F\end{matrix} \\ 50 + ( 69 - 50 ) \times \frac{1 - UnHBMI - HapBMI 5 F}{HapBMI 80 F - HapBMI 5 F} & \begin{matrix}if 31.48 < ClientBMI \leq 36.42 \\ and ClientGender = F\end{matrix} \\ ( 49 - 0 ) \times \frac{1 - UnHBMI - HapBMI 0 F}{HapBMI 5 F - HapBMI 0 F} & \begin{matrix}if 36.42 < ClientBMI \leq 46.3 \\ and ClientGender = F\end{matrix} \\ 0 & \begin{matrix}if ClientBMI > 46.3 \\ and ClientGender = F\end{matrix}\end{matrix}$$

Let HSB( , ) denote HapBmiScour as a mathematical function of ClientBMI and ClientGender, that is:

$$HapBmiScour = HSB ( ClientBMI , ClientGender )$$

$$Then$$

$$HapBmiScourGenAge = HSB ( ClientBMIGenAge , ClientGender )$$

$$HapStScour = \{ \begin{matrix}100 & \begin{matrix}if ClientStepAvgActi > \\ 15000\end{matrix} \\ 70 + ( 100 - 70 ) \times \frac{1 - UnHSt - HapSt 80}{HapSt 100 - HapSt 80} & \begin{matrix}if 5223 \leq \\ ClientStepAvgActi \leq 15000\end{matrix} \\ 50 + ( 69 - 50 ) \times \frac{1 - UnHSt - HapSt 5}{HapSt 80 - HapSt 5} & \begin{matrix}if 2000 \leq \\ ClientStepAvgActi < 5223\end{matrix} \\ ( 49 - 0 ) \times \frac{1 - UnHSt - HapSt 0}{HapSt 5 - HapSt 0} & \begin{matrix}if ClientStepAvgActi < \\ 2000\end{matrix}\end{matrix}$$

Let HSS( , ) denote HapStScour as a mathematical function of ClientStepAvgActi and ClientGender. That is:

HapStScour=HSS(ClientStepAvgActi, ClientGender)

Then

$$HapStScourGenAge = HSS ( AvgStepGenAgeActi , ClientGender )$$

$$HapMvScour = \{ \begin{matrix}100 & \begin{matrix}if ClientMV > 50 \\ and ClientGender = NA\end{matrix} \\ 70 + ( 100 - 70 ) \times \frac{1 - UnHMv - HapMv 80}{HapBMv 100 - HapBMv 80} & \begin{matrix}if 4.87 \leq ClientMV \leq 50 \\ and ClientGender = NA\end{matrix} \\ 50 + ( 69 - 50 ) \times \frac{1 - UnHMv - HapMv 5}{HapBMv 80 - HapBMv 5} & \begin{matrix}if 1 \leq ClientMV < 4.87 \\ and ClientGender = NA\end{matrix} \\ ( 49 - 0 ) \times \frac{1 - UnHMv - HapMv 0}{HapBMv 5 - HapBMv 0} & \begin{matrix}if ClientMV < 1 \\ and ClientGender = NA\end{matrix} \\ \begin{matrix}100 \\ \end{matrix} & \begin{matrix}if ClientMV > 55 \\ and ClientGender = M\end{matrix} \\ 70 + ( 100 - 70 ) \times \frac{1 - UnHMv - HapMv 80 M}{HapBMv 100 M - HapBMv 80 M} & \begin{matrix}if 6.41 \leq ClientMV \leq 55 \\ and ClientGender = M\end{matrix} \\ 50 + ( 69 - 50 ) \times \frac{1 - UnHMv - HapMv 5 M}{HapBMv 80 M - HapBMv 5 M} & \begin{matrix}if 1.33 \leq ClientMV < 6.41 \\ and ClientGender = M\end{matrix} \\ ( 49 - 0 ) \times \frac{1 - UnHMv - HapMv 0 M}{HapBMv 5 M - HapBMv 0 M} & \begin{matrix}if ClientMV < 1.33 \\ and ClientGender = M\end{matrix} \\ \begin{matrix}100 \\ \end{matrix} & \begin{matrix}if ClientMV > 45 \\ and ClientGender = F\end{matrix} \\ 70 + ( 100 - 70 ) \times \frac{1 - UnHMv - HapMv 80 F}{HapBMv 100 F - HapBMv 80 F} & \begin{matrix}if 3.68 \leq ClientMV \leq 45 \\ and ClientGender = F\end{matrix} \\ 50 + ( 69 - 50 ) \times \frac{1 - UnHMv - HapMv 5 F}{HapBMv 80 F - HapBMv 5 F} & \begin{matrix}if 0.7 \leq ClientMV < 3.68 \\ and ClientGender = F\end{matrix} \\ ( 49 - 0 ) \times \frac{1 - UnHMv - HapMv 0 F}{HapBMv 5 F - HapBMv 0 F} & \begin{matrix}if ClientMV < 0.7 \\ and ClientGender = F\end{matrix}\end{matrix}$$

where ClientMV=max(0, ClientMVAvgActi). Let HSM( , ) denote HapMvScour as a mathematical function of ClientMV and ClientGender. That is:

HapMvScour=HSM(ClientMV, ClientGender).

Then

HapMvScourGenAge=HSM(AvgMVGenAgeActi, ClientGender).

The other constants involved are listed as follows:
HapSt0[D1123]=1−C1123
HapSt5[G1123]=1−F1123
HapSt80[J1123]=1−I1123
HapSt100[M1123]=1−L1123
HapSt0M [D1129]=1−C1129
HapSt5M[G1129]=1−F1129
HapSt80M[J1129]=1−I1129
HapSt100M[M1129]=1−L1129
HapSt0F[D1135]=1−C1135
HapSt5F[G1135]=1−F1135
HapSt80F[J1135]=1−I1135
HapSt100F[M1135]=1−L1135
HapMv0[D1124]=1−C1124
HapMv5[G1124]=1−F1124
HapMv80[J1124]=1−I1124
HapMv100[M1124]=1−L1124
HapMv0M [D1130]=1−C1130
HapMv5M[G1130]=1−F1130
HapMv80M[J1130]=1−I1130
HapMv100M[M1130]=1−L1130
HapMv0F[D1136]=1−C1136
HapMv5F[G1136]=1−F1136
HapMv80F[J1136]=1−I1136
HapMv100F[M1136]=1−L1136
HapBMI0[D1125]=1−C1125
HapBMI5[G1125]=1−F1125
HapMBI80[J1125]=1−I1125
HapBMI100[M1125]=1−L1125
HapBMI0M [D1131]=1−C1131
HapBMI5M[G1131]=1−F1131
HapBMI80M[J1131]=1−I1131
HapBMI100M[M1131]=1−L1131
HapBMI0F[D1137]=1−C1137
HapBMI5F[G1137]=1−F1137
HapBMI80F[J1137]=1−I1137
HapBMI100F[M1137]=1−L1137
   where A-M combined with numbers 1122-1131 are references to cells in a spreadsheet containing data in respect to happiness levels of the general population given various values of average daily steps, average daily MV, and BMI, as tabulated in FIG. 21. The data may be separated into happiness levels for the male, female, and overall population.

### Overall Wellness

As above, the present computer-implemented system may further comprise the processing of one or more of the at least one digital biomarker subscores to generate at least one overall wellness scores, or “VivaMe Scores”. According to embodiments herein, the VivaMe Score, denoted as S for convenience, may be generated using the weighted average of some or all of the Health Behavior, Disease Risk, and Viva-Mind Health Subscores, although any other appropriate means of calculating the overall may be used. For example,

S=0.4×S_{HB}+0.4×S_{DR}+0.2×S_{VM}.

As above, the foregoing overall wellness score can be compared to general population information such as, for example, individuals or groups of individuals that are similar in age, gender, etc. Accordingly, S_{(AG)} may be generated as:

S_{(AG)}=0.4×S_{HB(AG)}+0.4×S_{DR(AG)}+0.2×S_{VM(AG)}

where the VivaMe score may be obtained by taking the average value of one or more Health Subscores, as:

S_{HB}=Round(Average(Sₛₜₚ, Sₘᵥ, Sₛₗₚ, S_{wei}, S_{bmi}, S_{wst}, Sₛₘₖ, S_{drk}, Sᵥᵣ, Sᵥₜ, Sᵥₘ),1).

The average score of the general population information having the same age, gender, etc., may be compared as:

S_{HB(AG)}=Round(Average(S_{stp(AG)}, S_{mv(AG)}, S_{slp(AG)}, S_{wei(AG)}, S_{bmi(AG)}, S_{wst(AG)}, S_{smk(AG)}, S_{drk(AG)}, S_{vr(AG)}, S_{vt(AG)}, S_{vm(AG)}),1).

As would be understood, the function “Average” as described herein need not require the presences of every component. In other words, the present systems may automatically ignore components that cannot be implemented in numeric calculation, or it may automatically ignore scores/subscores because they have not been chosen to contribute to the overall wellness information.

### Mortality Rates

In addition to the foregoing, the present computer-implemented systems may be operative to generate, based upon one or more of the Health Subscores, mortality rates associated with said one or more Health Subscores. For example, mortality rates associated with the individual or group's age, cardiovascular disease, diabetes, etc., may be determined. The foregoing will now be described having regard to the following examples.

Mortality Rate from Age

As an example, the overall probability of dying for someone in the client's age range, the overall life expectancy at the client's age, and the mortality rate in the client's age range are calculated after obtaining the client's age (Clientage), client's gender (ClientGender), population data of life expectancy in various age ranges, and population data of probabilities of dying in various age ranges. As with all the other population data, the population data regarding life expectancy and probabilities of dying can be tabulated and stored on the general population database. The probability of dying may be given according to Agerange1:

$$Agerange 1 = \{ \begin{matrix}0 - 1 & if Clientage \leq 1 ; \\ 2 - 5 & if 1 < Clientage \leq 5 ; \\ 6 - 10 & if 5 < Clientage \leq 10 ; \\ 11 - 15 & if 10 < Clientage \leq 15 ; \\ 16 - 20 & if 15 < Clientage \leq 20 ; \\ 21 - 25 & if 20 < Clientage \leq 25 ; \\ 26 - 30 & if 25 < Clientage \leq 30 ; \\ 31 - 35 & if 30 < Clientage \leq 35 ; \\ 36 - 40 & if 35 < Clientage \leq 40 ; \\ 41 - 45 & if 40 < Clientage \leq 45 ; \\ 46 - 50 & if 45 < Clientage \leq 50 ; \\ 51 - 55 & if 50 < Clientage \leq 55 ; \\ 56 - 60 & if 55 < Clientage \leq 60 ; \\ 61 - 65 & if 60 < Clientage \leq 65 ; \\ 66 - 70 & if 65 < Clientage \leq 70 ; \\ 71 - 75 & if 70 < Clientage \leq 75 ; \\ 76 - 80 & if 75 < Clientage \leq 80 ; \\ 81 - 85 & if 80 < Clientage \leq 85 ; \\ 85 - 90 & if 85 < Clientage \leq 90 ; \\ 91 - 95 & if 90 < Clientage \leq 95 ; \\ 96 - 100 & if 95 < Clientage \leq 100 ; \\ > 100 & if Clientage > 100\end{matrix} .$$

The cumulative probability of dying (E375) is:

$$E 345 = \{ \begin{matrix}0.005958 & if Agerange 1 = 0 - 1 ; \\ 0.001021 & if Agerange 1 = 2 - 5 ; \\ 0.00059 & if Agerange 1 = 6 - 10 ; \\ 0.000705 & if Agerange 1 = 11 - 15 ; \\ 0.002227 & if Agerange 1 = 16 - 20 ; \\ 0.004158 & if Agerange 1 = 21 - 25 ; \\ 0.004869 & if Agerange 1 = 26 - 30 ; \\ 0.005727 & if Agerange 1 = 31 - 35 ; \\ 0.007072 & if Agerange 1 = 36 - 40 ; \\ 0.009949 & if Agerange 1 = 41 - 45 ; \\ 0.015604 & if Agerange 1 = 46 - 50 ; \\ 0.024272 & if Agerange 1 = 51 - 55 ; \\ 0.035563 & if Agerange 1 = 56 - 60 ; \\ 0.05006 & if Agerange 1 = 61 - 65 ; \\ 0.071576 & if Agerange 1 = 66 - 70 ; \\ 0.109091 & if Agerange 1 = 71 - 75 ; \\ 0.170567 & if Agerange 1 = 76 - 80 ; \\ 0.271135 & if Agerange 1 = 81 - 85 ; \\ 0.425836 & if Agerange 1 = 86 - 90 ; \\ 0.614587 & if Agerange 1 = 91 - 95 ; \\ 0.786379 & if Agerange 1 = 96 - 100 ; \\ 1 & if Agerange 1 = > 100\end{matrix} .$$

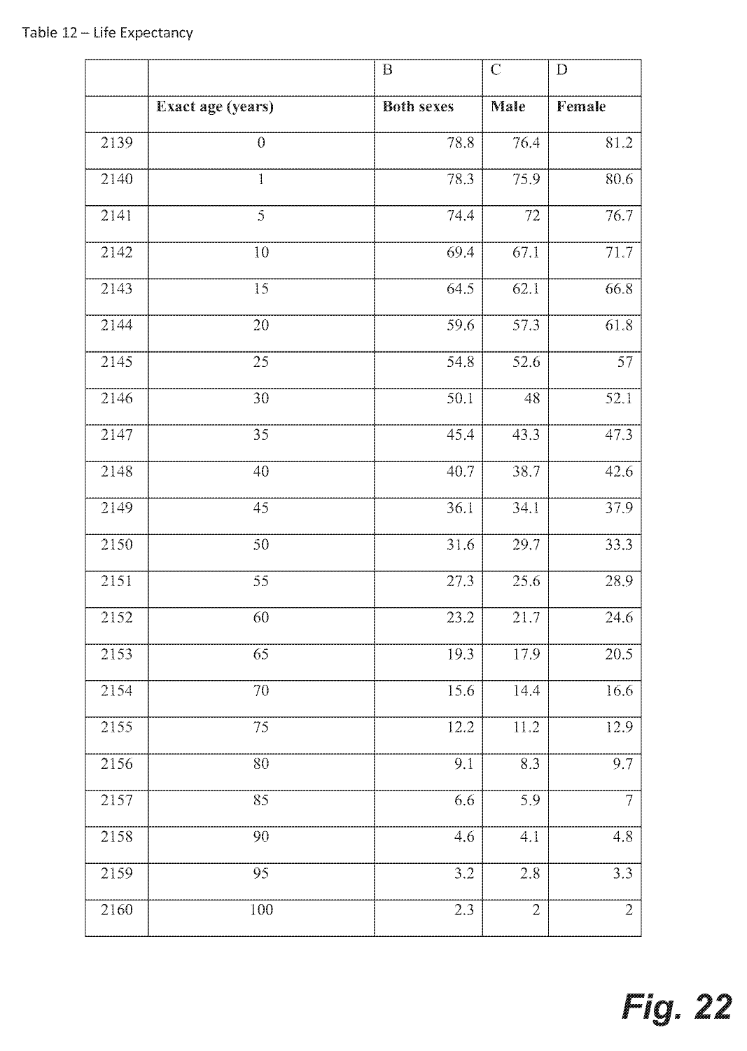

The life expectancy (E376) for males is calculated below:

$$E 376 = \{ \begin{matrix}C 2139 & if Clientage = 0 ; \\ C 2140 & if 0 < Clientage \leq 1 ; \\ \begin{matrix}C 2140 - ( C 2140 - C 2141 ) \times \\ ( Clientage - 1 ) / 4\end{matrix} & if 1 < Clientage \leq 5 ; \\ \begin{matrix}C 2141 - ( C 2141 - C 2142 ) \times \\ ( Clientage - 5 ) / 5\end{matrix} & if 5 < Clientage \leq 10 ; \\ \begin{matrix}C 2142 - ( C 2142 - C 2143 ) \times \\ ( Clientage - 10 ) / 5\end{matrix} & if 10 < Clientage \leq 15 ; \\ \begin{matrix}C 2143 - ( C 2143 - C 2144 ) \times \\ ( Clientage - 15 ) / 5\end{matrix} & if 15 < Clientage \leq 20 ; \\ \begin{matrix}C 2144 - ( C 2144 - C 2145 ) \times \\ ( Clientage - 20 ) / 5\end{matrix} & if 20 < Clientage \leq 25 ; \\ \begin{matrix}C 2145 - ( C 2145 - C 2146 ) \times \\ ( Clientage - 25 ) / 5\end{matrix} & if 25 < Clientage \leq 30 ; \\ \begin{matrix}C 2146 - ( C 2146 - C 2147 ) \times \\ ( Clientage - 30 ) / 5\end{matrix} & if 30 < Clientage \leq 35 ; \\ \begin{matrix}C 2147 - ( C 2147 - C 2148 ) \times \\ ( Clientage - 35 ) / 5\end{matrix} & if 35 < Clientage \leq 40 ; \\ \begin{matrix}C 2148 - ( C 2148 - C 2149 ) \times \\ ( Clientage - 40 ) / 5\end{matrix} & if 40 < Clientage \leq 45 ; \\ \begin{matrix}C 2149 - ( C 2149 - C 2150 ) \times \\ ( Clientage - 45 ) / 5\end{matrix} & if 45 < Clientage \leq 50 ; \\ \begin{matrix}C 2150 - ( C 2150 - C 2151 ) \times \\ ( Clientage - 50 ) / 5\end{matrix} & if 50 < Clientage \leq 55 ; \\ \begin{matrix}C 2151 - ( C 2151 - C 2152 ) \times \\ ( Clientage - 55 ) / 5\end{matrix} & if 55 < Clientage \leq 60 ; \\ \begin{matrix}C 2152 - ( C 2152 - C 2153 ) \times \\ ( Clientage - 60 ) / 5\end{matrix} & if 60 < Clientage \leq 65 ; \\ \begin{matrix}C 2153 - ( C 2153 - C 2154 ) \times \\ ( Clientage - 65 ) / 5\end{matrix} & if 65 < Clientage \leq 70 ; \\ \begin{matrix}C 2154 - ( C 2154 - C 2155 ) \times \\ ( Clientage - 70 ) / 5\end{matrix} & if 70 < Clientage \leq 75 ; \\ \begin{matrix}C 2155 - ( C 2155 - C 2156 ) \times \\ ( Clientage - 75 ) / 5\end{matrix} & if 75 < Clientage \leq 80 ; \\ \begin{matrix}C 2156 - ( C 2156 - C 2157 ) \times \\ ( Clientage - 80 ) / 5\end{matrix} & if 80 < Clientage \leq 85 ; \\ \begin{matrix}C 2157 - ( C 2157 - C 2158 ) \times \\ ( Clientage - 85 ) / 5\end{matrix} & if 85 < Clientage \leq 90 ; \\ \begin{matrix}C 2158 - ( C 2158 - C 2159 ) \times \\ ( Clientage - 90 ) / 5\end{matrix} & if 90 < Clientage \leq 95 ; \\ \begin{matrix}C 2159 - ( C 2159 - C 2160 ) \times \\ ( Clientage - 95 ) / 5\end{matrix} & if 95 < Clientage \leq 100 ; \\ C 2160 & if Clientage > 100\end{matrix} .$$

where C2139-C2160 refer to the cells of FIG. 22, which contains example data regarding the life expectancy of the general population at different ages. As above, general population data may be continuously and automatically collected from a variety of sources including, without limitation, the Canadian National Vital Statistics Reports, Vol 64 No, 2, Feb. 16, 2016. To calculate life expectancy for females, the same calculations as above are performed with references to column “C” replaced by column “D”.

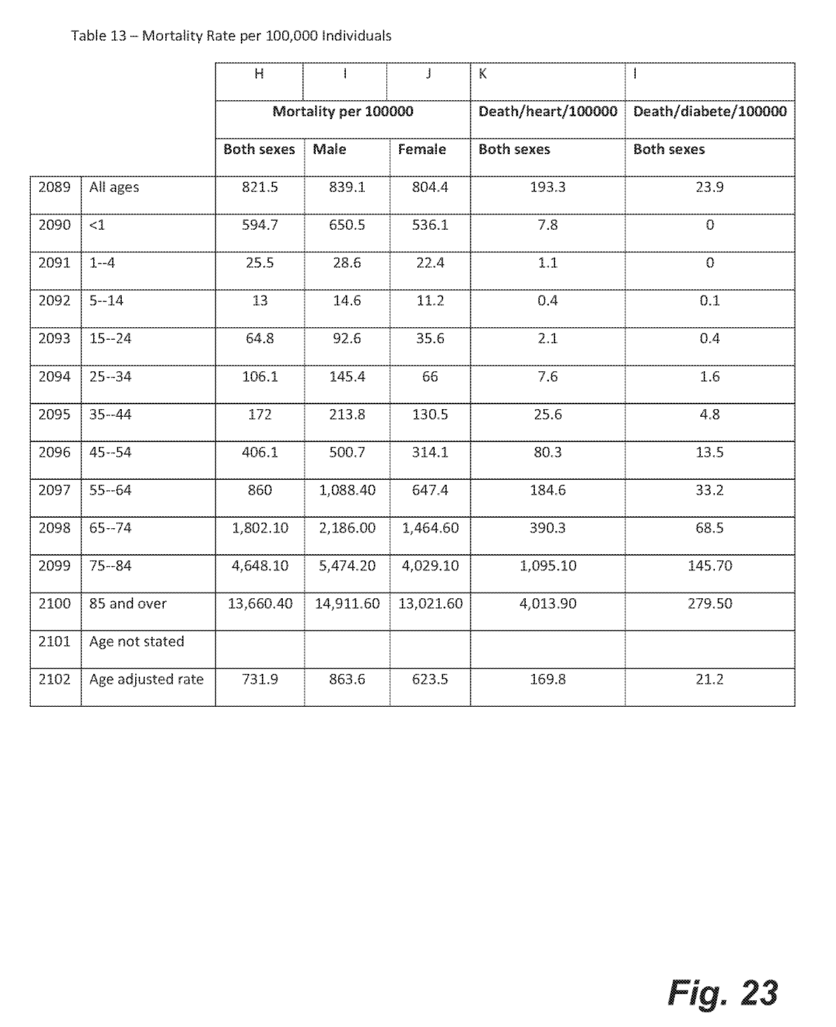

The overall mortality rate per 100,000 individuals (E379) is:

$$E 379 = \{ \begin{matrix}I 2090 if Agerange 2 = 0 - 1 and ClientGender = M ; \\ I 2091 if Agerange 2 = 2 - 4 and ClientGender = M ; \\ I 2092 if Agerange 2 = 5 - 1 \; 4 and ClientGender = M ; \\ I 209 \; 3 if Agerange 2 = 15 - 24 and ClientGender = M ; \\ I 2094 if Agerange 2 = 25 - 34 and ClientGender = M ; \\ I 2095 if Agerange 2 = 35 - 44 and ClientGender = M ; \\ I 2096 if Agerange 2 = 45 - 54 and ClientGender = M ; \\ I 2097 if Agerange 2 = 55 - 64 and ClientGender = M ; \\ I 2098 if Agerange 2 = 65 - 74 and ClientGender = M ; \\ I 2099 if Agerange 2 = 75 - 84 and ClientGender = M ; \\ I 2100 if Agerange 2 = >= 85 and ClientGender = M ; \\ \begin{matrix}J 2090 if Agerange 2 = 0 - 1 and ClientGender = F ; \\ J 2091 if Agerange 2 = 2 - 4 and ClientGender = F ; \\ J 2092 if Agerange 2 = 5 - 1 \; 4 and ClientGender = F ; \\ J 209 \; 3 if Agerange 2 = 15 - 24 and ClientGender = F ; \\ J 2094 if Agerange 2 = 25 - 34 and ClientGender = F ; \\ J 2095 if Agerange 2 = 35 - 44 and ClientGender = F ; \\ J 2096 if Agerange 2 = 45 - 54 and ClientGender = F ; \\ J 2097 if Agerange 2 = 55 - 64 and ClientGender = F ; \\ J 2098 if Agerange 2 = 65 - 74 and ClientGender = F ; \\ J 2099 if Agerange 2 = 75 - 84 and ClientGender = F ; \\ J 2100 if Agerange 2 = >= 85 and ClientGender = F\end{matrix}\end{matrix} .$$

where I2090-I2100 and J2090-J2100 refer to the cells of FIG. 23, which contains data regarding the mortality rate of the general population per 100,000 individuals, as obtained from the Canadian National Vital Statistics Reports, Vol 64 No, 2, Feb. 16, 2016.

Agerange2 can be specified as follows:

$$Agerange 2 = \{ \begin{matrix}0 - 1 & if Clientage \leq 1 ; \\ 2 - 4 & if 1 < Clientage \leq 4 ; \\ 5 - 14 & if 4 < Clientage \leq 14 ; \\ 15 - 24 & if 14 < Clientage \leq 24 ; \\ 25 - 34 & if 24 < Clientage \leq 34 ; \\ 35 - 44 & if 34 < Clientage \leq 44 ; \\ 45 - 54 & if 44 < Clientage \leq 54 ; \\ 55 - 64 & if 54 < Clientage \leq 64 ; \\ 65 - 74 & if 64 < Clientage \leq 74 ; \\ 75 - 84 & if 74 < Clientage \leq 84 ; \\ >= 85 & if Clientage \geq 85\end{matrix} .$$

Mortality Rate Due to Cardiovascular Disease

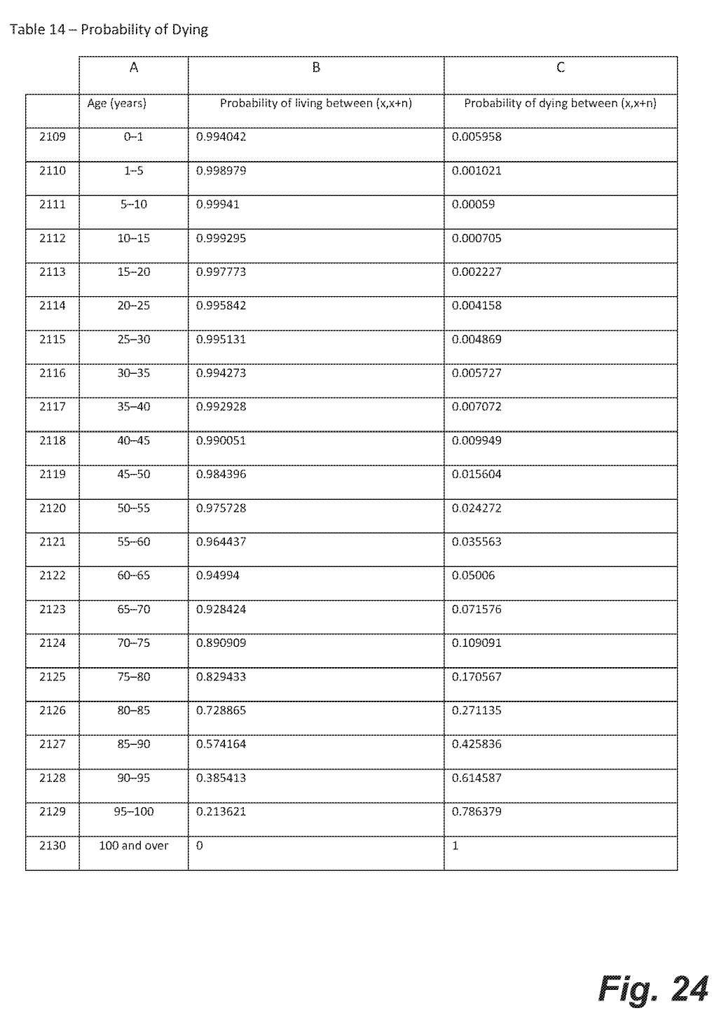

As another example, certain risks associated with the mortality of cardiovascular diseases can be generated based on the client's age (Clientage), client's gender (ClientGender), client's BMI (ClientBMI), client's daily average steps (ClientStepAvgActi), client's medical diagnosis on cardiovascular diseases (ClientCarDis), and the effect of treatment on the client's cardiovascular disease (CardioSitu), wherein general population distribution data regarding average daily steps, BMI, life expectancy, probabilities of dying, and mortality rates are also considered. Logistic models can be used to predict mortality due to cardiovascular disease using the above incoming wellness information, and the results can be tabulated and stored as, for example, shown in FIGS. 22 and 23, showing life expectancy and mortality per 100,000 individuals, respectively, as well as FIG. 24 showing the probabilities of dying for various age ranges. Using such general population information, mortality rate statistics can be calculated such as, without limitation, the following: Mortality rate per 100,000 individuals (mortHD) for people with heart diseases in the client's age range (Agerange2); Mortality rate due to heart disease based on average daily steps for client (E384); Mortality rate due to heart disease based on average daily steps for client and client's gender (F384); Mortality rate due to heart disease based on average daily steps for client and client's age and gender (G384); Mortality rate due to heart disease based on client's daily steps and BMI (E385); Mortality rate due to heart disease based on daily steps, BMI and client's gender (F385); Mortality rate due to heart disease based on daily steps, BMI and client's age and gender (G385). First, the AvgSteps, AvgStepGender, AvgStepGenAge, ClientBMIGender, and ClientBMIGenAge are calculated.

$$AvgSteps = ClientStepAvgActi$$

$$AvgStepGender = \{ \begin{matrix}9070 + Adjust & if ClientGender = M ; \\ 7779 + Adjust & if ClientGender = F ; \\ 8419 + Adjust & if ClientGender = NA\end{matrix} ,$$

where the above are the mean step counts for each gender overall.

$$AvgStepGenAge = \{ \begin{matrix}9224 + Adjust if ClientGender = NA and Clientage < 30 ; \\ 8830 + Adjust if ClientGender = NA and 30 \leq Clientage < 40 ; \\ 8941 + Adjust if ClientGender = NA and 40 \leq Clientage < 50 ; \\ 8264 + Adjust if ClientGender = NA and 50 \leq Clientage < 60 ; \\ 7368 + Adjust if ClientGender = NA and 60 \leq Clientage < 70 ; \\ 6237 + Adjust if ClientGender = NA and Clientage \geq 70 ; \\ 9848 + Adjust if ClientGender = M and Clientage < 30 ; \\ 9422 + Adjust if ClientGender = M and 30 \leq Clientage < 40 ; \\ 9837 + Adjust if ClientGender = M and 40 \leq Clientage < 50 ; \\ 8687 + Adjust if ClientGender = M and 50 \leq Clientage < 60 ; \\ 7878 + Adjust if ClientGender = M and 60 \leq Clientage < 70 ; \\ 6906 + Adjust if ClientGender = M and Clientage \geq 70 ; \\ 8534 + Adjust if ClientGender = F and Clientage < 30 ; \\ 8280 + Adjust if ClientGender = F and 30 \leq Clientage < 40 ; \\ 8010 + Adjust if ClientGender = F and 40 \leq Clientage < 50 ; \\ 7867 + Adjust if ClientGender = F and 50 \leq Clientage < 60 ; \\ 6880 + Adjust if ClientGender = F and 60 \leq Clientage < 70 ; \\ 8677 + Adjust if ClientGender = F and Clientage \geq 70\end{matrix} ;$$

where the above are mean step counts for each age bracket and gender.

$$ClientBMIGender = \{ \begin{matrix}28 & if ClientGender = M ; \\ 28 & if ClientGender = F ; \\ 28 & if ClientGender = NA\end{matrix} ,$$

where the above are the mean BMI values for each gender overall.

$$ClientBMIGenAge = \{ \begin{matrix}26 & if ClientGender = NA and Clientage < 30 ; \\ 28 & if ClientGender = NA and 30 \leq Clientage < 40 ; \\ 28 & if ClientGender = NA and 40 \leq Clientage < 50 ; \\ 28 & if ClientGender = NA and 50 \leq Clientage < 60 ; \\ 28 & if ClientGender = NA and 60 \leq Clientage < 70 ; \\ 28 & if ClientGender = NA and Clientage \geq 70 ; \\ 28 & if ClientGender = M and Clientage < 30 ; \\ 27 & if ClientGender = M and 30 \leq Clientage < 40 ; \\ 28 & if ClientGender = M and 40 \leq Clientage < 50 ; \\ 29 & if ClientGender = M and 50 \leq Clientage < 60 ; \\ 28 & if ClientGender = M and 60 \leq Clientage < 70 ; \\ 28 & if ClientGender = M and Clientage \geq 70 ; \\ 28 & if ClientGender = F and Clientage < 30 ; \\ 29 & if ClientGender = F and 30 \leq Clientage < 40 ; \\ 29.23 & if ClientGender = F and 40 \leq Clientage < 50 ; \\ 27 & if ClientGender = F and 50 \leq Clientage < 60 ; \\ 28 & if ClientGender = F and 60 \leq Clientage < 70 ; \\ 27 & if ClientGender = F and Clientage \geq 70\end{matrix} ;$$

where the above are the mean BMI values for each age bracket and gender.

The mortality rate statistics above can then be calculated as, for example:

1. The mortality rate (mortHD) for people with heart disease is given by:

$$mortHD = \{ \begin{matrix}K 2090 if Agerange 2 = 0 - 1 ; \\ K 2091 if Agerange 2 = 2 - 4 ; \\ K 2092 if Agerange 2 = 5 - 1 \; 4 ; \\ K 209 \; 3 if Agerange 2 = 15 - 24 ; \\ K 2094 if Agerange 2 = 25 - 34 ; \\ K 2095 if Agerange 2 = 35 - 44 ; \\ K 2096 if Agerange 2 = 45 - 54 ; \\ K 2097 if Agerange 2 = 55 - 64 ; \\ K 2098 if Agerange 2 = 65 - 74 \\ K 2099 if Agerange 2 = 75 - 84 ; \\ K 2100 if Agerange 2 = >= 85\end{matrix} .$$

where K2090-K2100 refer to the cells of FIG. 23.

2. The mortality rate (E384) due to heart diseases based on average daily steps of the client is given by:

$$E 384 = MCS ( AvgSteps , mortClientCardio , ClientGender ) = \{ \begin{matrix}FALSE & if mortClientCardio = FALSE ; \\ mortHD & if mortClientCardio = Y \\ \begin{matrix}mortHD \times logistic \\ ( CSIntM + CSStM \times AvgSteps )\end{matrix} & \begin{matrix}if mortClientCardio = N \\ and ClientGender = M ;\end{matrix} \\ \begin{matrix}mortHD \times logistic \\ ( CSIntF + CSStF \times AvgSteps )\end{matrix} & \begin{matrix}if mortClientCardio = N \\ and ClientGender = F\end{matrix}\end{matrix} .$$

where MCS( , , ) denotes E384 as a function of AvgSteps, mortClientCardio, and ClientGender.

3. Similarly, the mortality rate (F384) due to heart diseases based on average daily steps for the client's gender is given by:

F384=MCS(AvgStepGender, mortClientCardio, ClientGender)

4. The mortality rate (G384) due to heart diseases based on the average daily steps for the client's gender and age is given by:

G384=MCS(AvgStepGenAge, mortClientCardio, ClientGender)

5. The mortality rate (E385) due to heart diseases based on the average daily steps and BMI of the client is given by:

$$E 385 = MCSB ( AvgSteps , ClientBMI , mortClientCardio , ClientGender ) = \\ \{ \begin{matrix}FALSE & if mortClientCardio = FALSE ; \\ mortHD & if mortClientCardio = Y \\ \begin{matrix}\begin{matrix}mortHD \times logistic ( CSBIntM + \\ CSBStM \times AvgSteps + CSBbmiM \times \end{matrix} \\ ClientBMI + CSBStbmiM \times \\ AvgSteps \times ClientBMI )\end{matrix} & \begin{matrix}if mortClientCardio = N \\ and ClientGender = M ; \\ \\ \end{matrix} \\ \begin{matrix}\begin{matrix}mortHD \times logistic ( CSBIntF + \\ CSBStF \times AvgSteps + CSBbmiF \times \end{matrix} \\ ClientBMI + CSBStbmiF \times \\ AvgSteps \times ClientBMI )\end{matrix} & \begin{matrix}if mortClientCardio = N \\ and ClientGender = F \\ \\ \end{matrix}\end{matrix} .$$

where MCSB( , , , ) denotes E385 as a function of AvgSteps, ClientBMI, mortClientCardio, and ClientGender.

6. Similarly, the mortality rate (F385) due to heart diseases based on average daily steps and BMI for the client's gender is given by:

F385=MCSB(AvgStepGender, ClientBMIGender, mortClientCardio, ClientGender)

7. The mortality rate (G385) due to heart diseases based on average daily steps and BMI for the client's gender and age is given by:

G385=MCSB(AvgStepGenAge, ClientBMIGenAge, mortClientCardio, ClientGender)

Mortality Rates of Diabetes

As another example, certain risks associated with mortality due to diabetes can be calculated based on the client's age (Clientage), client's gender (ClientGender), client's BMI (ClientBMI), client's daily average steps (ClientStepAvgActi), client's medical diagnosis on abnormal blood pressure (ClientBPRDis), the effect of treatment on the client's abnormal blood pressure (BPRSitu), client's medical diagnosis on diabetes (ClientDiaDis), the effect of treatment on the client's diabetes (DiabeSitu), and client's family history of diabetes (ClientDiaFamily), whereby population distribution data regarding daily average steps, BMI, waist size, life expectancy, probabilities of dying, and mortality rates are also provided. Using the above data, without limitation, one ore more mortality rate statistics can be calculated including: Mortality rate per 100,000 individuals (mortDia) for people with diabetes in the client's age range (Agerange4) Mortality rate due to diabetes based on average daily steps, BMI, MV, waist size, ClientBPR, and ClientDiaFamiliy for client (E439); Mortality rate due to diabetes based on average daily steps, BMI, MV, waist size, ClientBPR, and ClientDiaFamiliy, and client gender (F439); Mortality rate due to diabetes based on average daily steps, BMI, MV, waist size, ClientBPR, and ClientDiaFamiliy, and client age and gender (G439). First, the AvgMVGenActi, AvgMVGenAgeActi, AvgWaistGen, and AvgWaistGenAge are calculated.

$$AvgMVGenActi = \{ \begin{matrix}22.261982 & if ClintGender = M ; \\ 17.692627 & if ClientGender = F ; \\ 19.933881 & if ClientGender = NA\end{matrix} ,$$

where the above are the mean MV values for each gender overall.

$$AvgMVGenAgeActi = \{ \begin{matrix}27.261345 & if ClientGender = NA and Clientage < 30 ; \\ 22.877719 & if ClientGender = NA and 30 \leq Clientage < 40 ; \\ 21.183897 & if ClientGender = NA and 40 \leq Clientage < 50 ; \\ 18.057031 & if ClientGender = NA and 50 \leq Clientage < 60 ; \\ 13.165338 & if ClientGender = NA and 60 \leq Clientage < 70 ; \\ 9.948715 & if ClientGender = NA and Clientage \geq 70 ; \\ 29.981944 & if ClientGender = M and Clientage < 30 ; \\ 25.991409 & if ClientGender = M and 30 \leq Clientage < 40 ; \\ 24.419647 & if ClientGender = M and 40 \leq Clientage < 50 ; \\ 18.855232 & if ClientGender = M and 50 \leq Clientage < 60 ; \\ 13.874513 & if ClientGender = M and 60 \leq Clientage < 70 ; \\ 11.686853 & if ClientGender = M and Clientage \geq 70 ; \\ 24.308956 & if ClientGender = F and Clientage < 30 ; \\ 20.014397 & if ClientGender = F and 30 \leq Clientage < 40 ; \\ 17.935525 & if ClientGender = F and 40 \leq Clientage < 50 ; \\ 17.30886 & if ClientGender = F and 50 \leq Clientage < 60 ; \\ 12.49993 & if ClientGender = F and 60 \leq Clientage < 70 ; \\ 8.529676 & if ClientGender = F and Clientage \geq 70\end{matrix} .$$

where the above are mean MV values for each age bracket and gender.

$$AvgWaistGen = \{ \begin{matrix}96.43 & if ClientGender = M ; \\ 88.36 & if ClientGender = F ; \\ 92.38 & if ClientGender = NA\end{matrix} ,$$

where the above are mean values for waist size for each gender overall.

$$AvgWaistGenAge = \{ \begin{matrix}85.53 & if ClientGender = NA and Clientage < 30 ; \\ 89.95 & if ClientGender = NA and 30 \leq Clientage < 40 ; \\ 92.88 & if ClientGender = NA and 40 \leq Clientage < 50 ; \\ 95.34 & if ClientGender = NA and 50 \leq Clientage < 60 ; \\ 97.38 & if ClientGender = NA and 60 \leq Clientage < 70 ; \\ 96.39 & if ClientGender = NA and Clientage \geq 70 ; \\ 87.24 & if ClientGender = M and Clientage < 30 ; \\ 94 & if ClientGender = M and 30 \leq Clientage < 40 ; \\ 96.85 & if ClientGender = M and 40 \leq Clientage < 50 ; \\ 101.26 & if ClientGender = M and 50 \leq Clientage < 60 ; \\ 102.6 & if ClientGender = M and 60 \leq Clientage < 70 ; \\ 101.57 & if ClientGender = M and Clientage \geq 70 ; \\ 83.61 & if ClientGender = F and Clientage < 30 ; \\ 85.98 & if ClientGender = F and 30 \leq Clientage < 40 ; \\ 88.76 & if ClientGender = F and 40 \leq Clientage < 50 ; \\ 89.79 & if ClientGender = F and 50 \leq Clientage < 60 ; \\ 92.45 & if ClientGender = F and 60 \leq Clientage < 70 ; \\ 92.05 & if ClientGender = F and Clientage \geq 70\end{matrix} ;$$

where the above are mean values for waist size for each age bracket and gender.

The mortality rate statistics above can then be calculated:

1. The mortality rate (mortDia) for people with diabetes is given by:

$$mortDia = \{ \begin{matrix}L 2090 if Agerange 2 = 0 - 1 ; \\ L 2091 if Agerange 2 = 2 - 4 ; \\ L 2092 if Agerange 2 = 5 - 14 ; \\ L 2093 if Agerange 2 = 15 - 24 ; \\ L 2094 if Agerange 2 = 25 - 34 ; \\ L 2095 if Agerange 2 = 35 - 44 ; \\ L 2096 if Agerange 2 = 45 - 54 ; \\ L 2097 if Agerange 2 = 55 - 64 ; \\ L 2098 if Agerange 2 = 65 - 74 ; \\ L 2099 if Agerange 2 = 75 - 84 ; \\ L 2100 if Agerange 2 = >= 85\end{matrix} .$$

where L2090-L2100 refer to the cells of FIG. 23.

2. The mortality rate (E439) due to diabetes based on average daily steps, BMI, MV, waist size, blood pressure situation (BPRSitu) and family history of diabetes (ClientDiaFamily) is given by:

$$E 439 = \{ \begin{matrix}mortDia & if ClientDiabetes = Y ; \\ mortDia \times DAvgRisk & otherwise\end{matrix} .$$

where DAvgRisk=(RDia1+RDia2+RDia3)/3 and

RDia1=DSBF(ClientStepAvgActi, ClientBMI, ClientDiaFamily, ClientGender);

RDia2=DMBP(ClientMVAvgActi, ClientBMI, ClientBPR, ClientGender);

RDia3=DW(ClientSWaist, ClientGender);

3. Similarly, the mortality rate (F439) due to diabetes based on average daily steps, BMI, MV, waist size, blood pressure situation (BPRSitu), family history of diabetes (ClientDiaFamily), and client's gender is given by:

$$F 439 = \{ \begin{matrix}mortDia & if ClientDiabetes = Y ; \\ mortDia \times DAvgRiskGender & otherwise\end{matrix} .$$

where DAvgRiskGender=(RDiaGen1+RDiaGen2+RDiaGen3)/3 and

RDiaGen1=DSBF(AvgStepGender,ClientBMIGender, ClientDiaFamily, ClientGender);

RDiaGen2=DMBP(AvgMVGenActi, ClientBMIGender, ClientBPR, ClientGender);

RDiaGen3=DW(AvgWaistGen, ClientGender);

4. The mortality rate (G439) due to diabetes based on average daily steps, BMI, MV, waist size, blood pressure situation (BPRSitu), family history of diabetes (ClientDiaFamily), and client's gender is given by:

$$G 439 = \{ \begin{matrix}mortDia & if ClientDiabetes = Y ; \\ mortDia \times DAvgRiskGenAge & otherwise\end{matrix} .$$

### Financial Implications

As above, the present systems may be further utilized to estimate or predict the costs of various diseases and savings that could be associated with various behavioral changes or changes in personal characteristics, such as increased physical activity or decreases in weight, providing the advantage that the costs or financial implications of an individual's or group's overall wellness can be estimated or predicted, and improved. By way of example, a financial HRA can be calculated to provide useful statistics regarding the cost of, without limitation, cardiovascular diseases, diabetes, etc.

Cost of Cardiovascular Diseases

By way of example, certain metrics relating to the cost of cardiovascular diseases can be generated based upon, without limitation, the following incoming wellness information: Age, Gender, Client's current BMI, Client's daily average steps, Client's daily average MV activity time in minutes, Whether client's blood pressure is abnormal, Whether treatment helps client's abnormal blood pressure, Client's medical diagnosis on cardiovascular diseases, Whether treatment helps client's cardiovascular disease, and the client's geo-location (i.e. which Province the Client lives in). As above, general population data regarding steps, MV, BMI, and waist can be used as a baseline with which to compare the client. Additionally, the provincial average annual cost per person on cardiovascular diseases is provided. Certain metrics of cardiovascular disease cost can be calculated, such as: Average annual cost per person on cardiovascular diseases for client with cardiovascular disease (1730); Average annual cost per person on cardiovascular diseases for client (1732); Average annual cost per person on cardiovascular diseases for client's gender group (CostCardioClientGen); and Average annual cost per person on cardiovascular diseases for client's gender/age group (CostCardioClientAGen). The metrics can be calculated as follows:

1. The average annual cost per person on cardiovascular disease for client with cardiovascular diseases 1730 is simply the number reported on the provincial report of the cost of cardiovascular diseases in the province.

$$1730 = \{ \begin{matrix}18513 & if Location = BC ; \\ 18513 & if Location = AB ; \\ 18513 & if Location = SK ; \\ 18513 & if Location = MB ; \\ 18513.4 & if Location = ON ; \\ 18513.4 & if Location = NB ; \\ 18513 & if Location = PE ; \\ 18513.38 & if Location = NS ; \\ 18513.4 & if Location = NL ; \\ 18513.38 & if Location = QC \\ & or Location = Unknown\end{matrix} .$$

2. The average annual cost per person on diabetes for the client 1732 is given by:

$$1732 = \{ \begin{matrix}FALSE & if ClientCardio = FALSE ; \\ 1730 & if ClientCardio = Y ; \\ 1730 \times CAvgRisk & otherwise\end{matrix} .$$

3. The average annual cost per person on diabetes for client's gender group CostCardioClientGen is given by:

$$CostCardioClientGen = \{ \begin{matrix}FALSE & if ClientCardio = FALSE ; \\ 1730 & if ClientCardio = Y ; \\ 1730 \times AvgRickCardioGenHel & otherwise\end{matrix} ,$$

where AvgRickCardioGenHel is calculated by the following formula:

AvgRickCardioGenHel=(CSBF(AvgStepGenActi, ClientBMIGender, ClientCarFamily=N)+CMBF(AvgMVGenActi,ClientBMIGender, ClientCarFaimly=N)+CSP(AvgStepGenActi, ClientBPR=N, ClientGender)+CBP(ClientBMIGender, ClientBPR=N, ClientGender)+CMP(AvgMVGenActi, ClientBPR=N, ClientGender)+CW(AvgWaistGen, ClientGender))/6,

### and AvgStepGenActi=AvgStepGender

4. The average annual cost per person on diabetes for client's gender/age group CostCardioClientAGen is given by:

$$CostCardioClientAGen = \{ \begin{matrix}FALSE & if ClientCardio = FALSE ; \\ 1730 & if ClientCardio = Y ; \\ 1730 \times AvgRickCardioGenAgeHel & otherwise\end{matrix} .$$

where AvgRickCardioGenAgeHel is calculated by the following formula:

AvgRickCardioGenHel=(CSBF(AvgStepGenAgeActi, ClientBMIGenAge, ClientCarFaimly=N)+CMBF(AvgMVGenAgeActi, ClientBMIGenAge, ClientCarFamily=N)+CSP(AvgStepGenAgeActi, ClientBPR=N, ClientGender)+CBP(ClientBMIGenAge, ClientBPR=N, ClientGender)+CMP(AvgMVGenAgeActi, ClientBPR=N, ClientGender)+CW(AvgWaistGenAge, ClientGender))/6,

Cost of Diabetes

As another example, certain metrics relating to the cost of diabetes can be generated based on the following inputs: Age, Gender, Client's current BMI, Client's daily average steps, Client's daily average MV activity time in minutes, Whether client's blood pressure is abnormal, Whether treatment helps client's abnormal blood pressure, Client's medical diagnosis on diabetes, Whether treatment helps client's diabetes, Client's family history shows diabetes, and the geo-location (i.e. the province that Client lives in). As above, population data regarding steps, MV, BMI, and waist can be used as a baseline with which to compare the client. Additionally, the provincial average annual cost per person on diabetes is provided. Certain metrics of diabetes cost can, without limitation, be calculated including: Average annual cost per person on diabetes for client with diabetes (1737); Average annual cost per person on diabetes for client (1739); Average annual cost per person on diabetes for client's gender group (CostDiaClientGen); and Average annual cost per person on diabetes for client's gender/age group (CostDiaClientAGen). Certain metrics can be calculated as follows:

1. The average annual cost per person on diabetes for client with diabetes 1737 is simply the number reported on the provincial report of the cost of diabetes in the province:

$$1737 = \{ \begin{matrix}3717.1 & if Location = BC ; \\ 4746 & if Location = AB ; \\ 5286.5 & if Location = SK ; \\ 4992.1 & if Location = MB ; \\ 3954.05 & if Location = ON ; \\ 4190.17 & if Location = NB ; \\ 4850 & if Location = PE ; \\ 4203.523 & if Location = NS ; \\ 5018.31 & if Location = NL ; \\ 4880 & if Location = QC \\ & or Location = Unknown\end{matrix} .$$

2. The average annual cost per person of diabetes for client 1739 is given by:

$$1739 = \{ \begin{matrix}FALSE & if ClientDiabetes = FALSE ; \\ 1737 & if ClientDiabetes = Y ; \\ 1737 \times DAvgRisk & otherwise\end{matrix} .$$

3. The average annual cost per person of diabetes for client's gender group CostDiaClientGen is given by:

$$CostDiaClientGen = \{ \begin{matrix}FALSE & if ClientDiabetes = FALSE ; \\ 1737 & if ClientDiabetes = Y ; \\ 1737 \times AvgRiskDiabGenHel & otherwise\end{matrix} .$$

where AvgRiskDiabGenHel is calculated by the following formula:

AvgRickDiabGenHel=(DSBF(AvgStepGenActi, ClientBMIGender, ClientDiaFamily=N, ClientGender)+DMBP(AvgMVGenActi, ClientBMIGender, ClientBPR=N, ClientGender)+DW(AvgWaistGen, ClientGender))/3,

4. The average annual cost per person of diabetes for client's gender/age group CostDiaClientAGen is given by:

$$CostDiaClientAGen = \{ \begin{matrix}FALSE & if ClientDiabetes = FALSE ; \\ 1737 & if ClientDiabetes = Y ; \\ 1737 \times AvgRiskDiabGenAgeHel & otherwise\end{matrix} ,$$

where AvgRiskDiabGenAgeHel is calculated by the following formula:

AvgRickDiabGenHel=(DSBF(AvgStepGenAgeActi, ClientBMIGenAge, ClientDiaFamily=N, ClientGender)+DMBP(AvgMVGenAgeActi, ClientBMIGenAge, ClientBPR=N, ClientGender)+DW(AvgWaistGenAge, ClientGender))/3,

The terms and expressions herein are used as terms of description and not as limitation. Although the particular embodiments of the present systems described have been illustrated in the foregoing detailed description, it is to be further understood that the present invention is not to be limited to just the embodiments disclosed, but that they are capable of numerous rearrangements, modifications, and substitutions.

We claim:

1. A computer-implemented method for determining wellness of an individual, the method comprising:
providing a processor, in electronic communication with at least one or more device adapted to receive and transmit specific incoming wellness information about the individual,
providing a general population information database, in electronic communication with the processor, for receiving and transmitting general population information to the processor, and
receiving, at the processor, the specific incoming wellness information about the individual from the at least one or more devices and the general population information from the general population information database, and
processing the specific wellness information and the general population information to generate at least one digital biomarker subscore indicative of the individual's wellness according to the specific wellness information, as compared against the general population information, and
generating output information of the at least one digital biomarker subscore and transmitting the output information to the at least one or more devices.

2. The method of claim 1, wherein the specific wellness information comprises physical, behavioral, emotional, social, demographic and/or environmental information about the individual.

3. The method of claim 1, wherein the specific wellness information comprises at least age, gender, height and weight, waist circumference, physical activity, minutes of moderate/vigorous activity, sleep patterns, smoking habits, drug and alcohol consumption, nutrition, family history, pain, stress and happiness levels, resting heart rate, exercise heart rate, heart rate variability, presence of pre-existing disease, job type, geo-location, EEG, voice data, breathing data, blood biometrics, body composition (DXA), and aerobic fitness (VO2 max).

4. The method of claim 1, wherein the digital biomarker subscores may be indicative of health behaviors, chronic disease risk, mental health or mortality.

5. The method of claim 5, wherein the health behaviors may comprise information about, at least, steps taken per day, moderate to vigorous activity levels, sleep patterns, body mass index, waist circumference, smoking habits, drinking habits, nutritional habits, and aerobic fitness.

6. The method of claim 5, wherein the disease risk may comprise information about, at least, cardiovascular disease, diabetes, arthritis, lung disease, and pain.

7. The method of claim 5, wherein the mental health subscore may provide information about, at least, stress levels, happiness levels, depression, and model-based happiness.

8. The method of claim 5, wherein the mortality subscore may be determined utilizing information comprising age, risk of cardiovascular disease, and risk of diabetes.

9. The method of claim 1, wherein the digital biomarker subscores may be generated in an interactive manner, wherein the individual may predict or estimate how changes to one or more of the digital biomarker subscores changes their wellness.

10. The method of claim 1, wherein the digital biomarker subscores may be generated in an interactive manner, wherein the individual may observe the digital biomarker subscores of other individuals or groups of individuals for interaction therewith.

11. The method of claim 1, wherein the method may be utilized to estimate or predict financial implications of the individual's wellness.

12. The method of claim 1, wherein the wellness information may be utilized to create and optimize health-related programs and products, insurance programs and products, and wellness support programs and products.

13. The method of claim 1, wherein the method further comprises the processing of one or more of the at least one digital biomarker subscores against further general population information to generate an overall wellness score for the individual.

14. The method of claim 1, wherein the method may be utilized to determine the wellness of a group of individuals.

15. A computer-implemented system for determining the wellness of an individual, the system comprising:
at least one device adapted to receive and transmit incoming wellness information about the individual,
at least one general population database, operative to receive and transmit incoming wellness information from the at least one device and at least one processor, and
at least one processor, in electronic communication with the at least one device and the general population database, the processor operative to receive the incoming wellness information from the at least one device and the general population information from the database, and to process the information to generate at least one digital biomarker subscore indicative of the individual's wellness according to the specific incoming wellness information as compared against the general population information, and to generate at least one output indicative of the at least one digital biomarker subscore and transmitting the output to the at least one device.

16. The system of claim 15, wherein the incoming wellness information and the general population information are transmitted via wired or wireless signaling.

17. The system of claim 15, wherein the incoming wellness information is received and transmitted by the at least one device automatically, manually, or a combination thereof.

18. The system of claim 15, wherein the incoming wellness information is received and transmitted by the at least one device intermittently, continuously, or a combination thereof.

19. The system of claim 15, wherein the at least one device may comprise, at least, any device having a user interface, cloud computing, or application program interfaces.

20. The system of claim 19, wherein the at least one device may comprise one or more wearable device.
